(19) United States
(12) Patent Application Publication
(10) Pub. No.: US 2024/0380259 A1
(43) Pub. Date: Nov. 14, 2024

(54) ELECTRIC MOTOR

(71) Applicant: Electric Torque Machines, Inc., Minneapolis, MN (US)

(72) Inventors: Thomas F. Janecek, Flagstaff, AZ (US); Tyler K. Williams, Flagstaff, AZ (US)

(21) Appl. No.: 18/692,151

(22) PCT Filed: Sep. 15, 2022
(86) PCT No.: PCT/US22/43636

§ 371 Date: Mar. 14, 2024

Related U.S. Application Data
(60) Provisional application No. 63/290,790, filed on Dec. 17, 2021.
(60) Provisional application No. 63/245,603, filed on Sep. 17, 2021.

(51) Int. Cl. H02K 1/276; H02K 9/22

(52) U.S. Cl. CPC H02K 1/2766; H02K 9/227

(57) ABSTRACT

An electric motor includes a rotor and a stator formed by a plurality of stator phases. The stator phases include coils that extend fully about the motor axis of the motor. The stator phases further includes flux rings disposed on opposite axial sides of the coil and that are joined by flux returns. The stator phases electromagnetically drive rotation of the rotor on a rotational axis.

### CROSS-REFERENCE TO RELATED APPLICATION(S)

This application claims the benefit of U.S. Provisional Application No. 63/245,603 filed Sep. 17, 2021 and entitled “ELECTRIC MOTOR,” and claims the benefit of U.S. Provisional Application No. 63/290,790 filed Dec. 17, 2021 and entitled “ELECTRIC MOTOR,” the disclosures of which are hereby incorporated by reference in their entireties.

### BACKGROUND

The present disclosure relates generally to electric machines. More specifically, the present disclosure relates to transverse flux electric machines.

Electric motors utilize electricity to generate a mechanical output. Some electric motors generate rotational outputs. In alternating current (AC) induction motors, a stator is electrically energized to electromagnetically drive rotation of a rotor about a motor axis. The stator includes laminates and windings. The rotor includes permanent magnets that are acted on by the electromagnetic field induced by current through the stator to cause rotation of the rotor. Such electric motors include coils that extend axially relative to the rotational axis and that extend axially beyond the ends of the rotor to wrap around and form the ends of the coil windings.

### SUMMARY

According to an aspect of the disclosure, an electric motor comprising includes a rotor configured to rotate on a rotational axis to generate a mechanical output, the rotor comprising a rotor body and a magnetic array; a stator spaced radially relative to the rotor and disposed about the rotational axis; and a heat sink. The stator includes a first stator phase including a first pair of flux rings and a first coil, the first coil disposed axially between the first pair of flux rings; and a second stator phase including a second pair of flux rings and a second coil disposed axially between a second pair of flux rings, the second stator phase spaced axially from the first stator phase by an interphase gap. The heat sink extending from an opposite radial side of the first coil from the rotor into the interphase gap and extending towards the first coil from the interphase gap, such that the heat sink is disposed radially between metal of a first flux ring of the first pair of flux rings and the rotor, the heat sink configured to route heat away from the first coil and towards an exterior of the stator.

According to an additional or alternative aspect of the disclosure, an electric motor includes a stator, the stator comprising at least one coil; a rotor comprising a plurality of magnets arrayed around an axis of rotation of the rotor; and a heat sink including a plurality of collectors that routes heat away from the at least one coil toward an exterior surface of the electric motor.

According to another additional or alternative aspect of the disclosure, an electric motor includes a stator, the stator comprising a first phase assembly having a first coil; a rotor comprising a plurality of magnets arrayed around an axis of rotation of the rotor; and a first heat sink configured to route heat away from the first coil toward an exterior surface of the electric motor. The first heat sink includes a support leg extending towards the rotor from a radially opposite side of the first coil from the rotor such that the support leg extends to axially overlap with the first coil; and a free leg extending from the support leg and towards the first coil, the free leg disposed radially between metal of the first phase assembly and the rotor.

According to yet another additional or alternative aspect of the disclosure, an electric motor includes a rotor configured to rotate on a rotational axis to generate a mechanical output, the rotor comprising a rotor body and a magnetic array; a stator spaced radially relative to the rotor and disposed about the rotational axis, the stator comprising a stator phase having a coil disposed between a pair of flux rings; and a heat sink extending from an opposite radial side of the stator from the rotor radially towards the rotor to axially overlap with the coil, and extending towards the coil to radially overlap with a flux ring of the pair of flux rings, the heat sink configured to route heat from an interior of the stator to an exterior of the electric motor.

According to yet another additional or alternative aspect of the disclosure, a heat sink for an electric motor includes a dissipator extending arcuately about an axis between a first circumferential side and a second circumferential side; and a plurality of collectors extending from the dissipator. Each collector of the plurality of collectors includes a support leg projecting radially from the dissipator; and a free leg extending in a first axial direction from the support leg.

According to yet another additional or alternative aspect of the disclosure, an electric motor includes a rotor configured to rotate on a rotational axis to generate a mechanical output, the rotor comprising a rotor body and a magnetic array; a stator spaced radially relative to the rotor and disposed about the rotational axis, the stator comprising a stator phase having a coil disposed between a pair of flux rings; and a heat sink at least partially disposed within the stator, the heat sink axially overlapping with the coil and radially overlapping with a first flux ring of the pair of flux rings.

According to yet another additional or alternative aspect of the disclosure, an electric motor includes a stator, the stator comprising at least one coil; and a rotor. The rotor includes a magnetic array disposed around an axis of rotation of the rotor; and a mandrel supporting the magnetic array, the mandrel comprising a plurality of posts extending away from a main body of the mandrel toward the magnetic array, the plurality of posts arrayed around the mandrel.

According to yet another additional or alternative aspect of the disclosure, a mandrel for supporting a magnetic array of a rotor of an electric motor includes a main body disposed about a rotational axis; a shaft bore extending through the main body along an axis; and a plurality of posts projecting away from the main body and arrayed about the main body.

According to yet another additional or alternative aspect of the disclosure, an electric motor includes a stator, the stator comprising at least one coil; and a rotor spaced radially from the stator by an air gap and configured to rotate on an axis. The rotor includes a mandrel; and a magnetic array disposed around the axis and supported by the mandrel. An appendage extends from one of the mandrel and the concentrator into a receiver formed on the other one of the mandrel and the concentrator to radially retain the concentrator on the mandrel.

According to yet another additional or alternative aspect of the disclosure, an electric motor includes a stator, the stator comprising at least one coil; and a rotor. The rotor includes a mandrel; and a magnetic array supported by the mandrel, the magnetic array including a plurality of magnets arrayed around an axis of rotor of the rotor and a plurality of concentrators interspaced with the plurality of magnets, each of the plurality of concentrators including at least one appendage extending therefrom.

According to yet another additional or alternative aspect of the disclosure, an electric motor includes a stator, the stator comprising at least one coil; and a rotor spaced radially from the stator by an air gap and configured to rotate on an axis. The rotor includes a mandrel; and a magnetic array disposed around the axis and supported by the mandrel, the magnetic array spaced from the mandrel by a radial gap. The magnetic array is radially retained on the mandrel by a retention lock formed by an appendage extending from one of the mandrel and the concentrator to bridge the radial gap.

According to yet another additional or alternative aspect of the disclosure, an electric motor includes a stator, the stator comprising at least one coil; a rotor comprising a magnetic array disposed around an axis of rotation of the rotor, the rotor including at least one phase, each phase of the at least one phase comprising an annular array of magnets and concentrators; and at least one ring mounted on an end of each annular array of magnets and concentrators.

According to yet another additional or alternative aspect of the disclosure, an electric motor includes a stator, the stator comprising at least one coil; and a rotor comprising a magnetic array disposed around an axis of rotation of the rotor, the rotor including at least one phase, each phase of the at least one phase comprising an annular array of magnets and concentrators. The concentrators include a plurality of fingers that are embedded in potting compound.

### BRIEF DESCRIPTION OF THE DRAWINGS

FIG. 1 is an isometric view of a fan system.

FIG. 2 is an isometric cross-sectional view of the motor of FIG. 1.

FIG. 3A is an isometric view of the motor with the housing removed.

FIG. 3B is a partially exploded isometric view of the motor shown in FIG. 3A.

FIGS. 4A and 4B are isometric cross-sectional views of a portion of a stator phase that demonstrate how flux circuits are formed through flux paired spurs of a stator phase.

FIG. 4C shows a detailed view of flux paired spurs of a stator phase interacting with concentrators and permanent magnets of a magnet phase of a rotor.

FIG. 5A is an elevational cross-sectional view showing a magnetic array supported on a mandrel.

FIG. 5B is a first isometric, cross-sectional view showing the magnetic array supported on the mandrel.

FIG. 5C is a second isometric, cross-sectional view showing magnetic array supported on the mandrel.

FIG. 6A is an isometric cross-sectional view of a portion of a rotor.

FIG. 6B is a planar cross-sectional view showing a retention lock between a magnetic array and a mandrel.

FIG. 7A is an elevational view of a concentrator in a pre-assembly state.

FIG. 7B is an elevational view of the concentrator in an assembled state.

FIG. 8 is a cross-sectional view showing another retention lock between a magnetic array and a mandrel.

FIG. 9 is a cross-sectional view showing another retention lock between a magnetic array and a mandrel.

FIG. 10 is a cross-sectional view showing another retention lock between a magnetic array and a mandrel.

FIG. 11 is a cross-sectional view showing another retention lock between a magnetic array and a mandrel.

FIG. 12A is a cross-sectional view showing a hybrid retention lock between a magnetic array and a mandrel.

FIG. 12B is a cross-sectional view taken along line B-B in FIG. 12A.

FIG. 13 is an enlarged cross-sectional view showing an interface between a magnetic array and a mandrel.

FIG. 14 is an isometric view of a mandrel.

FIG. 15A is a partial planar axial end view showing a magnetic array disposed relative to a mandrel.

FIG. 15B is a partial isometric view showing the magnetic array disposed relative to the mandrel.

FIG. 16 is an isometric view of a mandrel.

FIG. 17 is a partial elevational end view showing a magnetic array mounted relative to the mandrel shown in FIG. 16.

FIG. 18A is an axial end view of a heat sink.

FIG. 18B is an isometric view of the heat sink shown in FIG. 18A.

FIG. 19A is a first axial end view showing a heat sink disposed relative to a ring segment of a flux ring.

FIG. 19B is a second axial end view, taken opposite the first axial end view in FIG. 19A, showing the heat sink disposed relative to the ring segment of the flux ring.

FIG. 19C is an isometric view showing the heat sink disposed relative to the ring segment of the flux ring.

FIG. 20 is an isometric view showing a heat sink disposed relative to coils of a stator.

FIG. 21A is a partial isometric cross-sectional view of a motor.

FIG. 21B is a partial elevational cross-sectional view of the motor of FIG. 21A.

FIG. 22 is a partial isometric view of a motor with a motor housing removed.

### DETAILED DESCRIPTION

The present disclosure concerns electric motors. The main type of motor presented herein is a transverse flux motor, which is distinguished from axial or radial flux type electric motors. However, the inventive aspects discussed herein can be applied to various types of motors beyond just transverse flux motors. It is understood that, while the electric machine is generally discussed as being an electric motor, the principles discussed herein are applicable to other electric machines, such as generators.

The electric machines of this disclosure include a rotor rotatable about a rotational axis and a stator configured to drive rotation of the rotor. According to aspects of the disclosure, the stator of the transverse flux electric motor includes stator phases, such as one, two, three, or more, formed from flux rings and a coil disposed axially between opposing flux rings. The flux rings can include spurs that extend radially relative to the rotational axis and towards the rotor. The rotor includes a magnetic array supported by a hub of the rotor. The stator magnetically interacts with the magnetic array to drive rotation of the rotor relative to the stator. The magnetic array is mechanically retained on the hub of the rotor.

Components of the magnetic array are mechanically retained on the hub by a mechanical retention lock between the hub and the magnetic array. The magnetic array is mechanically locked relative to the hub to prevent the components of the magnetic array from delaminating from the hub and expanding radially away from the hub during operation. The retention lock can be formed between flux concentrating components of the magnetic array and the hub.

The rotor can include one or more mandrels that form the hub of the rotor. The mandrels can be formed form metal, such as aluminum, among other material options. The magnetic array extends about the mandrel. Some examples of the rotor can include discrete magnetic arrays that are each mounted to one or more mandrels. The mandrel includes posts that extend from a main body of the mandrel. The posts space the magnetic array from the main body of the mandrel. Spacing the main body of the mandrel from the magnetic array inhibits inductive heating that could otherwise occur within the motor. The posts can retain potting compound therebetween that assists in torque transfer to the mandrel and that inhibits crack propagation in the potting compound.

A cooling assembly can be disposed within the motor to provide cooling to the motor. The cooling assembly is disposed within the stator and extends from proximate coils of the stator to the exterior of the stator. The cooling assembly transfers heat generated by the motor to outside of the stator for dissipation.

Several of the figures of the disclosure show a common axis, which is sometimes referred to as a motor axis. An axis of rotation of the rotor is disposed coaxially with the common axis. The term annular is used herein, which can refer to a ring shape (continuous or broken) about the common axis, which can be coaxial with the common axis. The term radial is used herein which when referring to a direction is any direction away from the common axis, unless otherwise noted. The radial direction can be orthogonal to the common axis. The term axial is used herein which when referring to a direction is any direction along the common axis, unless otherwise noted. The axial direction can be parallel to the common axis. The terms circumferential or circumferentially as used herein means around the common axis, unless otherwise noted.

Components can be considered to radially overlap when those components are disposed at common axial locations along common axis CA. A radial line extending from common axis CA will extend through each of the radially overlapping components. Components can be considered to axially overlap when those components are disposed at common radial and circumferential locations such that an axial line parallel to common axis CA extends through the axially overlapping components. Components can be considered to circumferentially overlap when aligned about common axis CA, such that a circle centered on common axis CA passes through the circumferentially overlapping components.

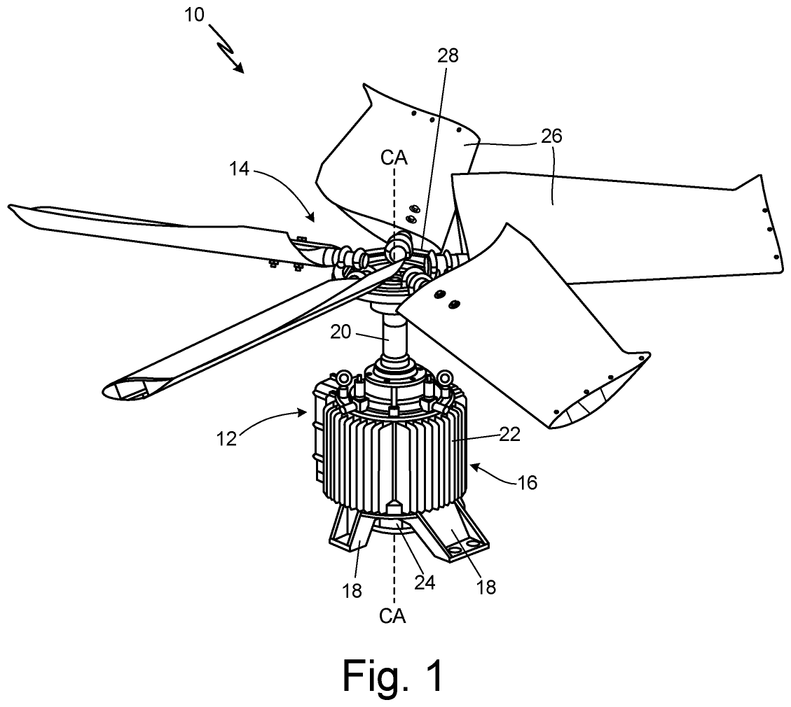

FIG. 1 is an isometric view of fan system 10. Fan system 10 includes motor 12 and blade assembly 14. Motor housing 16, supports 18, and drive shaft 20 of motor 12 are shown. Motor housing 16 includes stator housing 22 and bearing housing 24. Blades 26 and fan hub 28 of blade assembly 14 are shown.

Motor 12 is an electric motor configured to generate a rotating mechanical output. In the example shown, motor 12 is configured to generate the output coaxially with common axis CA. Motor housing 16 encloses other components of motor 12. In the example shown, motor housing 16 includes a first, larger diameter portion and a second, smaller diameter portion. The first portion is formed by stator housing 22 and the second portion is formed by bearing housing 24. Both stator housing 22 and bearing housing 24 enclose rotating components of motor 12. Electric components of motor 12 are disposed, at least partially, within stator housing 22.

Supports 18 extend axially and radially from stator housing 22 and are configured to interface with a support surface. In some examples, supports 18 can rest on the support surface such that stator housing 22 extends vertically above supports 18. Bearing housing 24 is disposed a lower axial end of stator housing 22 opposite blade assembly 14. Bearing housing 24 can thereby be disposed vertically between stator housing 22 and the support surface. In the example shown, bearing housing 24 has a smaller diameter than stator housing 22 and is located vertically below stator housing 22.

Blade assembly 14 is connected to motor 12 to be rotated by motor 12. Drive shaft 20 extends from motor 12 to provide the rotating mechanical output from motor 12 to blade assembly 14 to rotate blades 26 on common axis CA. Fan hub 28 is disposed at an end of drive shaft 20 opposite motor 12. More specifically, fan hub 28 is disposed at a first distal end of drive shaft 20 opposite a second distal end of drive shaft 20 extending into bearing housing 24. Blades 26 extend radially outward from fan hub 28. In the example shown, motor 12 and blade assembly 14 are disposed coaxially on common axis CA such that blades 26, fan hub 28, drive shaft 20, and the rotor of motor 12 rotate coaxially.

In the example shown, fan system 10 is configured such that blade assembly 14 is disposed vertically above motor 12. For example, fan system 10 can be configured for use in a cooling tower. It is understood that, while vertically oriented fans are discussed, fans according to the present disclosure can be oriented in any desired orientation and can be used to move any desired fluid, including gas and/or liquid. Further, while motor 12 is described as driving blade assembly 14, it is understood that any one or more aspects of motor 12 can be implemented in non-fan applications. Motor 12 can be configured for use in any desired electric motor assembly. It is thus understood that, while a fan is one implementation of the motor technologies presented herein, other applications, including non-fan applications, are possible and contemplated as within the scope of the disclosure.

In the example shown, blade assembly 14 is directly mounted to drive shaft 20 to rotate in a 1:1 relationship. Motor 12 thereby drives blade assembly 14 in a 1:1 relationship. The direct drive relationship provides high responsiveness and a large speed range relative to traditional outputs having reduction gearing.

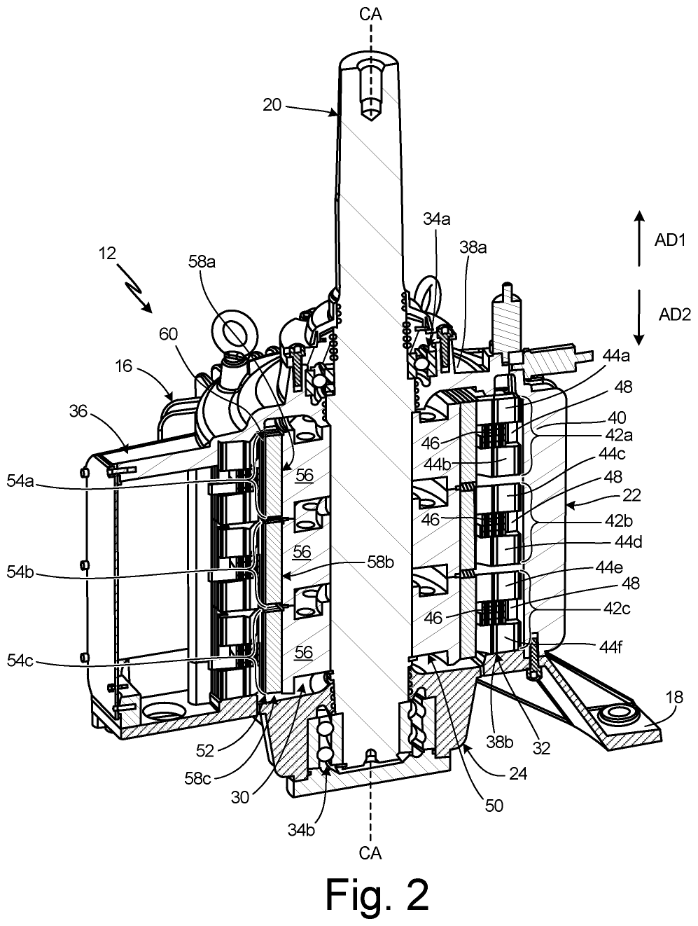

FIG. 2 is an isometric cross-sectional view of motor 12. Motor 12 includes motor housing 16; supports 18; drive shaft 20; rotor 30; stator 32; and bearing assemblies 34a, 34b. Motor housing 16 includes stator housing 22, bearing housing 24, and junction box 36. Stator housing 22 includes stator housing ends 38a, 38b and stator housing body 40. Stator 32 includes stator phases 42a-42c (collectively herein “stator phase 42” or “stator phases 42”). Stator phase 42a includes flux rings 44a, 44b, coil 46a, and flux returns 48a. Stator phase 42b includes flux rings 44c, 44d, coil 46b, and flux returns 48b. Stator phase 42c includes flux rings 44e, 44f, coil 46c, and flux returns 48c. Flux rings 44a-44f are referred to collectively herein as “flux ring 44” or “flux rings 44”. Coils 46a-46c are referred to collectively herein as “coil 46” or “coils 46”. Flux returns 48a-48c are referred to collectively herein as “flux return 48” or “flux returns 48”.

Rotor 30 includes rotor body 50 and magnetic array 52. In the example shown, rotor 30 includes rotor phases 54a-54c (collectively herein “rotor phase 54” or “rotor phases 54”). Rotor phase 54a includes mandrel 56 and magnet phase 58a. Rotor phase 54b includes mandrel 56 and magnet phase 58b. Rotor phase 54c includes mandrel 56 and magnet phase 58c. Magnet phases 58a-58c are referred to collectively herein as “magnet phase 58” or “magnet phases 58”.

Electric and/or magnetic components of motor 12 are disposed within stator housing 22. Stator housing 22 includes stator housing body 40 extending axially between stator housing ends 38a, 38b. Stator housing body 40 can include a cylindrical exterior surface and/or a cylindrical interior surface. Stator housing ends 38a, 38b can include and/or be formed by plates connected to stator housing body 40, such as by fasteners such as bolts, among other options. In the example shown, thermal dissipation fins are formed on stator housing body 40 to facilitate cooling of motor 12.

Stator 32 and rotor 30 are disposed coaxially to generate a rotational mechanical output based on electrical inputs. Stator 32 is disposed coaxially with rotor 30 on the axis of rotation of rotor 30, which is coaxial with the common axis CA. Stator 32 defines a cylindrical interior that rotor 30 is disposed within. Stator 32 is formed by stator phases 42 arrayed along common axis CA. Each stator phase 42 is an annular ring disposed about common axis CA. The various stator phases 42 are spaced axially relative to each other along common axis CA.

Stator 32 includes stator phases 42 that are arrayed along and around the axis of rotation. Each stator phase 42 includes a coil 46 extending circumferentially about the common axis CA. The stator phases 42 include metallic components formed on each axial side of the coil 46 of that stator phase 42. The metallic components can be formed wholly or partially from stacks of laminations. Laminations can be formed from material which is readily susceptible to polarization from the fields generated by coils 46. Such material is typically ferromagnetic. The ferromagnetic materials can be metal such as iron or an alloy of iron, such as steel. More specifically, laminations can be formed from silicon steel, among other options. Ferromagnetic material can be ceramic doped or otherwise embedded with ferromagnetic elements.

Various components of each stator phase 42 can be formed from laminations having different stack orientations. For example, flux rings 44 can be formed from laminate sheets stacked axially and oriented radially. An axial line through the laminate structure of a flux ring 44 extends through multiple sheets, up to all sheets, of the laminate stack. The laminate structure of flux returns 48 is oriented transverse to the laminate structure of flux rings 44. In some examples, the laminate sheets of flux returns 48 are disposed orthogonal to the laminate sheets of flux rings 44. Flux returns 48 can be formed from laminate sheets stacked circumferentially and oriented axially. A tangent line to a circle centered on common axis CA and passing through a portion of a flux return 48 can extend through each sheet of the laminate stack of that flux return 48. An arc extending circumferentially about common axis CA can pass through each sheet of the laminate stack of a flux return 48.

Coils 46 are formed as hoops of electrically conductive metal that extend circumferentially about the common axis CA. The coils 46 are thus coaxial with the common axis CA. Each of the coils 46 is discrete with respect to the other ones of the coils 46. Each coil 46 is a winding of wire, ribbon, etc., typically copper, around the common axis CA. Thus, each coil 46 could be a continuous winding of 20, 30, 40, 50, 100, or less or more loops around the common axis CA. Each coil 46 has two termination wires, representing the ends of the circuit of each coil 46 for running an AC signal through the coil 46, which can electrically connect with a controller.

The coils 46 of the multiple stator phases 42 do not radially overlap or cross over each other. No part of any one of the multiple coils 46 is disposed at the same axial location along the common axis CA as any other one of the coils 46. There is an axial gap between each of the coils 46 of the motor 12. The coils 46 are thus located at separate and distinct axial positions along the common axis CA. Each coil 46 is made as a circular loop with the common axis CA extending through each loop of each coil 46. The coils 46 do not include loops wherein the common axis CA does not extend through such loop. The material of the loops formed by coils 46 does not extend axially but instead extends circumferentially about the common axis CA.

Rotor 30 includes magnetic array 52 oriented towards stator 32. In the example shown, rotor 30 is disposed within stator 32 and magnetic array 52 is disposed on a radially outer side of rotor body 50. Air gap 60 is disposed radially between stator 32 and rotor 30 such that stator 32 and rotor 30 are not in direct contact. More specifically, the air gap 60 is formed radially between a continuous matrix of potting compound of the stator 32 and magnetic array 52. As such, motor 12 can be considered to include an inner rotator. It is understood, however, that in various other examples the rotor 30 is disposed about stator 32 to rotate about stator 32 such that motor 12 can be considered to include an outer rotator. In such examples, magnetic array 52 can be disposed on an inner radial surface of rotor body 50.

Rotor 30 rotates on common axis CA and generates the rotational output. Magnetic array 52 is supported by rotor body 50. In the example shown, magnetic array 52 is formed by multiple discrete magnetic arrays disposed about the common axis CA. The discrete magnetic arrays form the magnetic phases 58 of each rotor phase 54.

Rotor body 50 can also be referred to as a hub of rotor 30. Rotor phases 54 are arrayed along and around the axis of rotation. Each rotor phase 54 is disposed coaxially with the other rotor phases 54. Mandrels 56 of the rotor phases 54 are disposed to rotate on the common axis CA. The magnetic arrays formed by each magnet phase 58 are disposed on and supported by the respective mandrel 56 of that rotor phase 54. The magnetic array of each magnet phase 58 can be formed by interspersed permanent magnets and concentrators, as discussed in more detail below. The rotor phases 54 are connected together to rotate simultaneously on common axis CA. In the example shown, drive shaft 20 is mounted to mandrels 56 to rotate concurrently with rotor phases 54. Torque is transmitted to drive shaft 20 through rotor body 50.

Drive shaft 20 is supported by rotor body 50 to rotate with rotor body 50. Drive shaft 20 extends through each axial stator housing end 38a, 38b of stator housing 22, in the example shown. A first portion of drive shaft 20 extends through stator housing end 38a to be exposed outside of motor housing 16. The portion of drive shaft 20 disposed outside of motor housing 16 can connect to another component of the system to directly provide the rotational output from motor 12 to the component, such as to blade assembly 14, among other options. Drive shaft 20 and rotor 30 rotate in a 1:1 relationship. Drive shaft 20 completes one revolution for every one revolution of rotor 30.

The stator phases 42a-42c respectively overlap with the rotor phases 54a-54c along the axis of rotation/common axis. The stator phases 42 are electromagnetically polarized by coils 46 out of phase with respect to each other, such as 120-degrees electrically out of phase, to electromagnetically interact with the rotor phases 54 to drive rotation of the rotor 30. While three motor phases are shown herein, other embodiments may include a single phase, only two phases, or more than three phases.

Bearing assemblies 34a, 34b are disposed to support rotation of rotor 30. Drive shaft 20 extends through and is supported by bearing assemblies 34a, 34b. Bearing assemblies 34a, 34b can be of any desired configuration for supporting rotation of rotor 30 and axial loads experienced by motor 12. For example, bearing assemblies 34a, 34b can be ball bearings, roller bearings, etc.

A controller can be operably connected to motor 12, electrically and/or communicatively, to control operation of motor 12. For example, the controller can be operably connected to electrical components of stator 32 by the wires extending into junction box 36. The controller can be of any desired configuration for controlling operation of motor 12 and the rotational output of motor 12 (e.g., speed, torque, etc.) and can include control circuitry and memory. The controller is configured to store executable code, implement functionality, and/or process instructions. The controller is configured to perform any of the functions discussed herein, including receiving an output from any sensor referenced herein, detecting any condition or event referenced herein, and controlling operation of any components referenced herein. The controller can be of any suitable configuration for controlling operation, gathering data, processing data, etc. The controller can include hardware, firmware, and/or stored software. The controller can be of any type suitable for operating in accordance with the techniques described herein. It is understood that the controller can be entirely or partially disposed across one or more circuit boards. In some examples, the controller can be implemented as a plurality of discrete circuitry subassemblies.

During operation, power is provided to coils 46. Stator phases 42 generate electromagnetic fields that interact with the magnetic array 52 to drive rotation of rotor 30. The embodiment of the motor 12 shown includes three phases corresponding to the three stator phases 42 and the coils 46 therein in which three sinusoidal AC signals are delivered through the coils 46 120-degrees electrically offset. If there were two stator phases 42 and two coils 46, then the two sinusoidal AC signals would be 180-degrees apart, or 90-degrees apart for sets of four stator phases 42, etc.

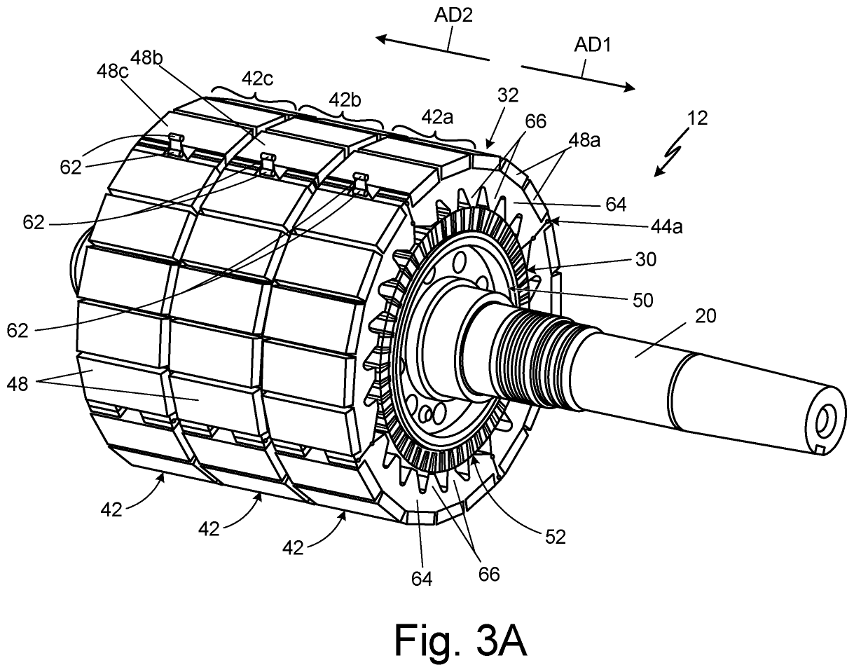

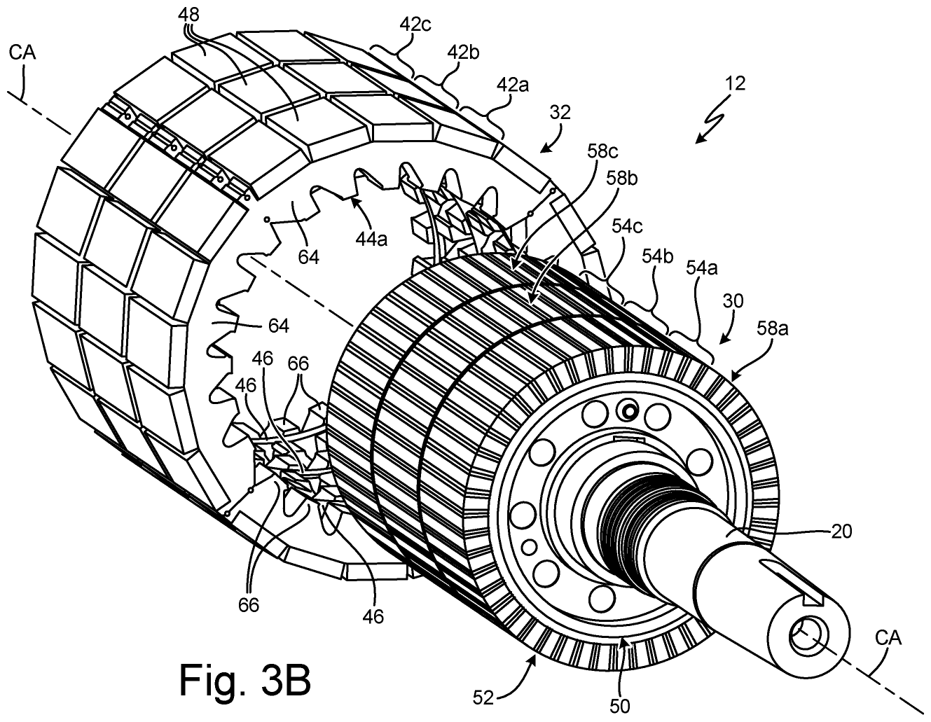

FIG. 3A is an isometric view of motor 12 with the housing removed. FIG. 3B is a partially exploded isometric view of the motor 12 shown in FIG. 3A. FIGS. 3A and 3B will be discussed together. Drive shaft 20 rotor 30, and stator 32 of electric motor 12 are shown. Stator 32 is formed in stator phases 42a-42c. Stator phase 42a includes flux rings 44a, 44b, coil 46a, and flux returns 48a. Stator phase 42b includes flux rings 44c, 44d, coil 46b, and flux returns 48b. Stator phase 42c includes flux rings 44e, 44f, coil 46c, and flux returns 48c. Rotor 30 includes rotor body 50 and magnetic array 52. Rotor 30 is formed in rotor phases 54a-54c. Rotor phase 54a includes mandrel 56 and magnet phase 58a. Rotor phase 54b includes mandrel 56 and magnet phase 58b. Rotor phase 54c includes mandrel 56 and magnet phase 58c.

Stator 32 and rotor 30 are disposed coaxially to generate a rotational mechanical output based on electrical inputs. In the example shown, rotor 30 is disposed within stator 32 such that motor 12 is an inner rotator, though it is understood that other examples of motor 12 are configured as outer rotators having a rotor disposed about the stator. Stator 32 defines a cylindrical interior that rotor 30 is disposed within. Stator 32 is formed by stator phases 42 arrayed along common axis CA. Each stator phase 42 is an annular ring disposed about common axis CA.

The stator phases 42a-42c do not overlap each other along common axis CA. Stator phases 42a-42c do not radially overlap along axis CA, such that a radial line extending from common axis CA passes through at most only one of the stator phases 42 and does not pass through multiple ones of the stator phases 42 at any given location along common axis CA. The electromagnetic components of each stator phase 42 (e.g., flux rings 44, coils 46, flux returns 48) only radially overlap with components of that same stator phase 42 and do not radially overlap with electromagnetic components of another of the stator phases 42. For example, flux returns 48a only support the function of stator phase 42a and not, for example, stator phase 42b or stator phase 42c. The flux rings 44a, 44b of stator phase 42a only support the function of stator phase 42a and not, for example, stator phases 42b, 42c. Each of the stator phases 42a-42c may only contain one coil 46 and two annular flux rings 44 and, in some cases, only two annular laminate pieces forming the flux rings 44.

Each stator phase 42 includes first and second flux rings 44 (e.g., flux rings 44a, 44b of stator phase 42a) disposed on opposite lateral sides of a coil 46 of that stator phase 42. Flux rings 44 can be formed by multiple ring segments 64 that are fixed relative to each other and extend about the common axis CA. The ring segments 64 are each arcuate portions of laminate structure that together form the annular laminate structure of flux ring 44. Spurs 66 are formed on a radial side of each ring segment 64 facing rotor 30.

For each stator phase 42, an annular array of flux returns 48 extends between and electrically connects the opposing flux rings 44. The flux returns 48 are disposed on an opposite radial side of the flux rings 44 from rotor 30 and spurs 66. As shown, the flux returns 48 form the outermost electrically conducting portion of stator 32. In the example shown, flux returns 48 form the outermost laminate structure of the electric motor 12. It is understood that in outer rotator examples the flux returns 48 can form the innermost laminate structure of electric motor 12.

In the example shown, the flux returns 48 extend radially outward from the common axis CA further than the flux rings 44 or other laminate or metal superstructure. In the example shown, stator 32 does not include any laminate or metallic superstructure, though it is understood that not all examples are so limited. Stator 32 does not include a support structure on the side of the flux returns 48 opposite rotor 30. In the example shown, stator 32 does not include a support structure on the outer radial side of flux returns 48. Flux returns 48 can be connected directly to stator housing 22, such as by potting compound, and interface with other laminate portions of stator 32 on only the inner radial side of the flux return 48 and, in some cases, interface with the other laminate portions on one or both circumferential sides of the flux return 48. Flux returns 48 are not disposed radially between laminate structures of stator 32. Flux returns 48 are not disposed radially between laminate structure that is itself directly connected to spurs 124 by laminate or other electrically conductive structure.

For each stator phase 42, coils 46 are disposed axially between the first and second flux rings 44 of the stator phase 42. Wire ends 62 extend from coil 46 at a location radially between the flux returns 48 and rotor 30 to a location radially outside of the flux returns 48 through wire gaps formed between adjacent ones of the ring segments 64. Wire ends 62 are thereby exposed outside of motor 12 and provide locations for electrical connections to be formed with motor 12. The wires ends 62 of the multiple coils 46 of the stator phases 42a-42c are shown as arrayed along the common axis CA and aligned axially along the common axis CA.

Rotor 30 is configured similar to stator 32, in the example shown, in that rotor 30 is formed from multiple rotor phases 54 configured to operate together. Rotor 30 includes multiple rotor phases 54 disposed along common axis CA. Rotor body 50 supports magnetic array 52. As best seen in FIG. 3B, the rotor 30 includes three rotor phases 54a-54c. Each rotor phase 54 corresponds with a single stator phase 42 of stator 32. In the example shown, the rotor phases 54a-54c respectively radially overlap only with the stator phases 42a-42c along the common axis CA. For example, the rotor phase 54a does not radially overlap with the stator phase 42b or stator phase 42c but instead only radially overlaps with and corresponds with stator phase 42a. It is understood that motor 12 can include more or fewer than three rotor phases 54.

Magnetic array 52 is formed by interposed permanent magnets 68 and concentrators 70. In the example shown, magnetic array 52 is formed by magnet phases 58a-58c respectively associated with rotor phases 54a-54c. The electromagnetic components of each magnet phase 58 (e.g., concentrators 70 and permanent magnets 68) only radially overlap with the particular rotor phase 54 of that magnet phase 58 and do not radially overlap with another of the rotor phases 54. For example, permanent magnets 68 of magnet phase 58a only support the function of rotor phase 54a and not, for example, rotor phase 54b, and the permanent magnets 68 of magnet phase 58a do not radially overlap with the rotor phase 54b. It is understood, however, that not all examples are so limited. For example, rotor 30 can include a single rotor phase that has a single magnetic array 52. The concentrators 70 and permanent magnets 68 of the single magnetic array 52 can extend to radially overlap with each of the stator phases 42.

Each rotor phase 54 includes a mandrel 56 connected to the drive shaft 20 and forming a portion of the rotor body 50. In the example shown, each magnet phase 58 is disposed on the outer radial side of an associated mandrel 56. The example shown includes three mandrels 56 for the three rotor phases 54a-54c. Mandrels 56 are disposed such that the mandrels 56 respectively do not radially overlap each other along common axis CA and each mandrel 56 only radially overlaps with one of the magnet phases 58, which is the magnet phase 58 disposed on that mandrel 56. It is understood, however, that not all examples are so limited. For example, rotor 30 can include a single mandrel 56 forming the rotor hub and that supports a single magnetic array 52. The single mandrel 56 and single magnetic array 52 can extend to radially overlap with each of the stator phases 42 of the stator 32.

It is understood that each of the rotor phases 54 may contain only one annular array of interspersed permanent magnets 68 and concentrators 70. For example, the three phase motor shown contains three annular arrays of interspersed permanent magnets 68 and concentrators 70 (e.g., of the three magnet phases 58a-58c), the three annular arrays themselves disposed along the common axis CA and not radially overlapping each other. Each annular array of interspersed permanent magnets 68 and concentrators 70 only radially overlaps with one coil 46 and two annular flux rings 44, and, in some cases, only two annular laminate pieces forming the flux rings 44. Each annular magnet phase 58 radially overlaps with only one annular array of flux returns 48. While rotor 30 is shown as including multiple rotor phases 54 each having a mandrel 56, it is understood that some examples of rotor 30 can include rotor phases 54 sharing a common hub and with circumferentially offset magnet phases 58 each fixed to the common hub.

The magnet phases 58a-58c are circumferentially offset from each other about common axis CA. As shown, magnet phase 58a is misaligned with magnet phase 58b and magnet phase 58c, and magnet phase 58b is misaligned with magnet phase 58c. As shown, the permanent magnets 68 of the multiple rotor phases 54 are misaligned, or circumferentially offset, about the common axis CA with respect to each other. As such, a projection of the cross-section of any permanent magnet 68 of any magnet phase 58 taken orthogonal to common axis CA is misaligned with similar cross-sectional projections of the permanent magnets 68 of the other magnet phases 58. Likewise, the concentrators 70 of the respective magnet phases 58 are misaligned, or circumferentially offset, about the common axis CA with respect to each other. As such, a projection of the cross-section of a concentrator 70 of any magnet phase 58 taken orthogonal to common axis CA is misaligned with similar cross-sectional projections of the concentrator 70 of the other magnet phases 58. The magnet phases 58a-58c can thus be considered to be axially misaligned. The offset facilitates the phase offsets of the driving signals of the respective stator phases 42a-42c (e.g., the signals delivered 120-degrees electrically offset) to operate motor 12 at high efficiency and with improved torque output and speed control.

Each stator phase 42 includes two annular arrays of spurs 66 disposed on opposite axial sides of the coil 46 of that stator phase 42. Each stator phase 42 includes a first flux ring 44 and a second flux ring 44. The first flux ring 44 (e.g., flux ring 44a of stator phase 42a; flux ring 44c of stator phase 42b; and flux ring 44e of stator phase 42c) and its associated components and aspects can be referred to as forming an A-side of the stator phase 42. The second flux ring 44 (e.g., flux ring 44b of stator phase 42a; flux ring 44d of stator phase 42b; and flux ring 44f of stator phase 42c) and its associated components and aspects can be referred to as forming a B-side of the stator phase 42. The first flux ring 44 has a first annular array of spurs 66 and the second flux ring 44 has a second annular array of spurs 66. While rotor phases 54a-54c are axially offset, stator phases 42a-42c are axially aligned about common axis CA. Stator phases 42a-42c are axially aligned with each other along common axis CA. Stator phases 42a-42c, in particular the spurs 66 of the respective first ones of flux rings 44 of each stator phase 42 and the spurs 66 of the respective second ones of flux rings 44 of each stator phase 42, are aligned. Within each stator phase 42, the first annular array of spurs 66 is disposed on a first axial side of coil 46 (e.g., spaced in first axial direction AD1 from its coil 46) while the second annular array of spurs 66 is disposed on the second, opposite axial side of the coil 46 (e.g., spaced in second axial direction AD2 from its coil 46). Within each stator phase 42, the spurs 66 of the first annular array of spurs 66 are misaligned or offset (circumferentially and axially) relative to the spurs 66 of the second annular array of spurs 66 (e.g., spurs 66 of flux ring 44a are axially misaligned with spurs 66 of flux ring 44b). The misalignment of the A-side spurs 66 relative to the B-side spurs 66 allows flux coupling across the magnet phase 58 from oppositely polled spurs 66 of the respective A-side and B-side annular arrays of spurs 66, as discussed in more detail below.

While the spurs 66 within each stator phase 42 are offset and misaligned (circumferentially and axially), the respective A-side spurs 66 of the multiple stator phases 42 are axially aligned and the respective B-side spurs 66 of the multiple stator phases 42 are axially aligned, in the example shown. The respective A-side spurs 66 are axially aligned with each other across the multiple stator phases 42. The A-side spurs 66 can be considered to be directly axially aligned. As such, a projection of the cross-section of an A-side spur 66 of any stator phase 42 taken orthogonal to common axis CA is aligned with similar cross-sectional projections of the A-side spurs 66 of the other stator phases 42. In the example shown, spurs 66 of flux ring 44a, spurs 66 of flux ring 44c, and spurs 66 of flux ring 44e are axially aligned. Similarly, the respective B-side spurs 66 are axially aligned with each other across the multiple stator phases 42. A projection of the cross-section of a B-side spur 66 of any stator phase 42 taken orthogonal to common axis CA is aligned with similar cross-sectional projections of the B-side spurs 66 of the other stator phases 42. In the example shown, spurs 66 of flux ring 44b, spurs 66 of flux ring 44d, and spurs 66 of flux ring 44f are axially aligned. The spurs 66 of the flux rings 44a, 44c, 44e are aligned with each other but offset with respect to the spurs 66 of the flux rings 44b, 44d, 44f. Likewise, the spurs 66 of the flux rings 44b, 44d, 44f are aligned with each other but offset with respect to the spurs 66 of the flux rings 44a, 44c, 44e.

While rotor phases 54 are offset and stator phases 42 are aligned in the example shown, it is understood that in other examples the rotor phases 54 can be aligned (or formed as a single phase) and the spurs 66 of the stator phases 42 can be circumferentially offset between stator phases 42 to facilitate the phase offsets of the driving signals. For example, the A-side spurs of each stator phase 42 can be axially misaligned with the A-side spurs of each other stator phase 42. The B-side spurs 66 of each stator phase 42 can be axially misaligned with the B-side spurs of each other stator phase 42.

The AC signals routed through the coils 46 are synchronized to develop magnetic fields through the flux rings 44 in time with the rotational position of magnetic array 52 to drive rotation of rotor 30. The respective AC signals (e.g., sinusoidal or trapezoidal) delivered through the coils 46 in each stator phase 42a-42c are out of phase with respect to each other. In this way, the permanent magnets 68 forming the magnetic array 52 more frequently have flux peaks acting on them, as compared to synchronizing the sinusoidal AC signals, thereby providing a smoother torque profile acting on the rotor 30 along the axis of rotation of rotor 30. Moreover, the offset permanent magnets 68 of the multiple magnet phases 58 are positioned relative to each other to interact with the flux generated by the aligned stator phases 42a-42c. The embodiment of the electric machine 12 discussed has three phases corresponding to the three stator phases 42a, 42b, 42c and respective coils 46a, 46b, 46c therein. As such, three sinusoidal AC signals are delivered through the coils 46 120-degrees electrically offset. If there were two stator phases 42 and two coils 46, then the two sinusoidal AC signals would be 180-degrees electrically offset, or 90-degrees electrically offset for sets of four stator phases 42 and four coils 46. The magnet phases 58 are offset relative to each other about common axis CA to position magnet phases 58 at desired circumferential positions relative to the associated spurs 66 based on the offset between the driving signals.

Stator phases 42a-42c can each be of the same configuration such that a common base stator phase 42 can be used to form any one of the multiple stator phases 42 of the motor 12. Stator phases 42a-42c being aligned about common axis CA facilitates ease of assembly of motor 12 and prevents misalignment between the multiple stator phases 42. The aligned spurs 66 across the various stator phases 42a-42c facilitate the stator phases 42a-42c electromagnetically interacting with the misaligned magnet phases 58 to provide continuous smooth torquing by the electrically offset signals to thereby efficiently drive rotor 30 with a smooth torque profile.

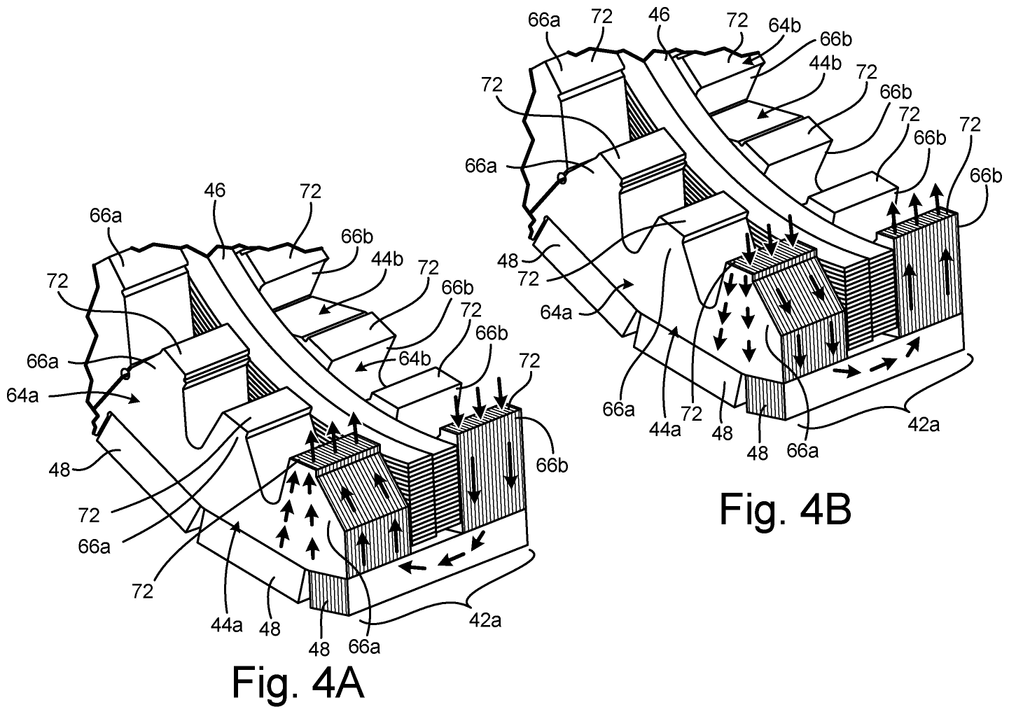

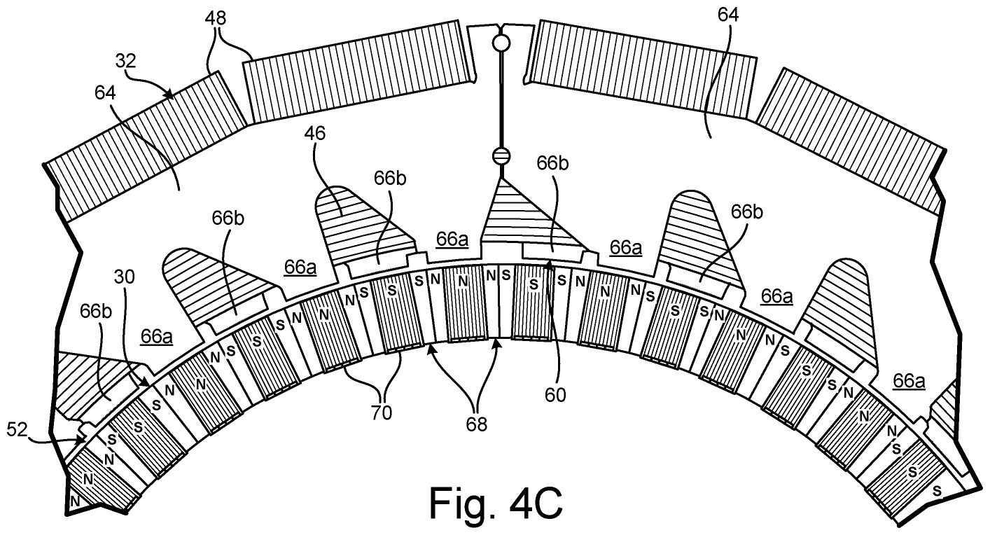

FIGS. 4A and 4B are isometric cross-sectional views of a portion of stator phase 42 that demonstrate how flux circuits are formed through flux paired spurs 66 of a stator phase 42. FIG. 4C shows a detailed view of flux paired spurs 66a, 66b of stator phase 42a interacting with concentrators 70 and permanent magnets 68 of the magnet phase 58a of rotor 30. Stator phase 42a includes flux rings 44a, 44b; coil 46a; and flux returns 48a. Flux ring 44a includes ring segment 64a having spurs 66a. Flux ring 44b includes ring segment 64b having spurs 66b.

Two opposite polarized states are shown between FIGS. 4A and 4B. As shown, the alternating flux path directions and polarizations are developed through the laminate of the ring segments 64 and flux returns 48. The alternating flux paths can be due to a sinusoidal signal delivered to each coil 46 to flux pair adjacent spurs 66 on opposite sides of the coil 46. These flux paths polarize the spurs 66a relative to spurs 66b to attract or repel the permanent magnets 68 of rotor 30 in synchrony with rotation of the rotor 30 so that flux paired ones of the spurs 66 attract a permanent magnet 68 as the permanent magnet 68 approaches and/or repel the permanent magnet 68 as the permanent magnet 68 passes.

Flux paired spurs 66 refer to respective closest pairs of spurs 66 of opposed circular spur arrays of a stator phase 42 (e.g., the spurs 66 of flux ring 44a and spurs 66 of flux ring 44b are flux paired, the spurs 66 of flux rings 44c, 44d are flux paired, the spurs 66 of flux rings 44e, 44f are flux paired). While a subset of spurs 66a, 66b are highlighted as flux paired ones of spurs in FIGS. 4A and 4B, it is understood that these are examples and all spurs 66a, 66b of flux rings 44a, 44b similarly flux pair across the circular arrays of spurs 66a, 66b.

Each spur 66a is part of a similar flux circuit with its corresponding flux pair spur 66b. The flux paired spurs 66a, 66b pair generally axially with a spur 66a, 66b of the opposing circular array of spurs 66a, 66b, and not circumferentially to the neighbor spur 66a, 66b of the same circular array of spurs 66a, 66b because all spurs 66a of the circular array of spurs 66a will have the same polarity at any given time while all spurs 66b of the opposed circular arrays of spurs 66b of the same stator phase 42a will have the opposite polarity at any given time. More specifically, each spur 66a of the circular array of spurs 66a flux pairs with the closest spurs 66b of the circular array of spurs 66b on the other axial side of the coil 46. As shown in FIGS. 4A and 4B, a flux circuit is formed through flux paired spurs 66a, 66b such that the spurs 66a, 66b are respectively polarized, north and south.

In the example shown, each spur 66 narrows circumferentially as the spur 66 extends radially away from the body of its flux ring 44. In the example shown, spurs 124 each narrow to a radial face 72 oriented towards rotor 30. The radial faces 72 can be planar and/or can be formed tangentially to a circle centered on common axis CA. The radial faces 72 provide a narrowed surface area relative to the body of the flux ring 44 and the flux returns 48. The narrowed surface area of radial face 72 can be narrowed circumferentially and/or axially. Spurs 66 narrow to concentrate flux towards rotor 30 to focus concentrated flux to a limited part of the rotor 30. Some examples of spurs 66 include portions that extend to radially overlap with a single coil 46. For example, teeth can be supported by the spurs 66 and project axially from the spurs 66 to radially overlap with the coil 46. While the example shown includes spurs that are formed from stacks of lamina, it is understood that spurs 66 can support or include portions formed from powdered metal, such as the teeth that project to radially overlap with the coil 46.

The flux is generated by coil 46. Specifically, an AC signal is run through coil 46 which rapidly builds and collapses the magnetic field due to the current reversal of the AC signal through the coil 46. As shown, flux concentrating material of the flux rings 44a, 44b and flux returns 48 is wrapped around at least three sides of the coil 46. The lamination grain of the flux concentrating material is shown in FIGS. 4A and 4B. The lamination grain of the concentrators 70 and flux returns 48 can further be seen in FIG. 4C. Generally, flux flows with the grain, along the direction of lamination, as flux will generally follow the path of highest permeability and there is significant resistance to flux jumping from one layer of lamination to another layer of lamination. The lamination grain of the ring segments 64a, 64b, including the spurs 66a, 66b, is radially orientated while the lamination grain of the flux returns 48 is axially oriented. As such, the flux flows axially through the flux returns 48 and radially through the ring segments 64a, 64b and spurs 66a, 66b in a U-shape toward the rotor 30, the base of the U on an opposite side of the coil 46 from the rotor 30 and the legs of the U oriented towards the rotor 30. FIGS. 4A and 4B represent the reversal of the AC signal and how the poles of the flux paired spurs 66a, 66b are switched.

The flux paired ones of spurs 66a, 66b are circumferentially offset from each other such that the spurs 66a are not axially aligned with spurs 66b. Being that the ends of the flux paired spurs 66a, 66b are not aligned axially because spurs 66a are offset circumferentially from spurs 66b, the flux circuit travels at least a limited distance circumferentially between the flux paired ones of spurs 66a, 66b. Therefore, a cumulative flux circuit comprised of a plurality of flux paired spurs 66a, 66b can flow in a spiral pattern circumferentially through the spurs 66a, 66b and flux returns 48. It is noted that, while most flux flows between flux paired ones of spurs 66a, 66b, the ring segments 64a, 64b permit flux flow between spurs 66a, 66b of the same ring segment 64a, 64b, such that a limited amount of flux may skip a flux paired spurs 66a, 66b to the next-over spur 66a, 66b of the same ring segment 64a, 64b.

FIG. 4C shows a detailed view of flux paired spurs 66a, 66b of the stator 32 interacting with concentrators 70 and permanent magnets 68 of the magnet phase 58a. The AC signal through the coil 46 changes the direction of the electric current rapidly and thus changes the north-south polarity of the flux paired spurs 66a, 66b rapidly. The view of FIG. 4C shows an instance in which all spurs 66a of the circular array of spurs 66a have a north polarization while all spurs 66b of the circular array of spurs 66b have a south polarization.

Also at this instance, the spurs 66a, 66b are aligned with the concentrators 70 that are disposed circumferentially between the permanent magnets 68. The laminate of the concentrators 70 does not have an inherent polarization, but due to the fixed position of concentrators 70 between magnet poles, the concentrators 70 assume an effective permanent polarization as indicated. Each concentrator 70 contacts two permanent magnets 68. Each concentrator 70 contacts the same pole of the two permanent magnets 68. For example, a concentrator 70 will be in contact with two south poles or in contact with two north poles. The concentrators 70 take on alternating north and south polarization on opposite sides of each permanent magnet 68 depending on the polarization adjacent that concentrator 70. As indicated, each permanent magnet 68 is permanently polarized north and south on opposite sides of its short axis. The interleaved arrangement of permanent magnets 68 and concentrators 70 creates circumferential regions of oppositely polarized concentrators 70 and permanent magnet 68 poles.

The concentrators 70 route the magnetic flux from the permanent magnets 68 toward the stator 32. Flux circuits are completed across the air gap 60 between the stator 32 and rotor 30. The flux from the rotor 30 (specifically the permanent magnets 68) and the flux from the coil 46 (through the spurs 66a, 66b) interact in the air gap 60, and the resulting flux shear forces rotation of the rotor 30. The flux of the present motor 12 has an orientation transverse to the axis of rotation (which axis of rotation is coaxial with common axis CA). This is different from the radial flux orientation of traditional AC and DC brushless motors.

The flux generated by the stator 32 and acting on the rotor 30 is constantly changing due to both changing position of the permanent magnets 68 and concentrators 70 due to rotation of the rotor 30 as well as the change in polarization of the spurs 66a, 66b due to the change in the AC signal through the coil 46. As such, the AC signal routed through the coil 46 is synchronized with rotation of the rotor 30 to develop magnetic fields through the spurs 66a, 66b in time to the concentrators 70 approaching and departing the spurs 66a, 66b to simultaneously push and pull the permanent magnets 68 of the rotor 30 to provide the force that rotates the rotor 30. More specifically, the N-N and S-S interfaces repel while N-S interfaces attract, on approach and departure of alignment.

At least some of the respective AC signals (e.g., sinusoidal or trapezoidal) delivered through the multiple coils 46 forming stator 32 are out of phase with respect to each other. In this way, the rotor 30 (along its axial length) more frequently has flux peaks acting on it, as compared to synchronizing the sinusoidal AC signals, for a smoother torque profile acting on the rotor 30 along the axis of rotation of the rotor 30, which is also the common axis CA. The axially offset magnet phases 58 of the rotor 30 facilitates desired positioning of each permanent magnet 68 in magnetic array 52 (e.g., each permanent magnet 68 of the multiple magnet phases 58) being aligned within its own stator phase 42 in time with the electrically offset AC signals.

Being that the permanent magnets 68 are elongate and radially overlap with only a single coil 46, in the example shown, each permanent magnet 68 is electromagnetically acted upon by only a single one of the coils 46. In the example shown, each magnet phase 58 is acted upon and electromagnetically interacts with only one coil 46 of stator 32. As such, while multiple different coils 46 can electromagnetically act on the rotor 30 simultaneously, each magnet phase 58 electromagnetically interacts with only a single coil 46 in the example shown. Each permanent magnet 68 may be electromagnetically acted upon by only the single coil 46 throughout operation, regardless of the number of phases forming the motor 12. For example, motor 12 may include three phases and thus three coils 46, but the permanent magnets 68 of a single rotor phase 54 interact with only a single one of the coils 46 throughout operation. This is unlike conventional AC induction motors in which each magnet interacts will all windings of a traditional circumferential array of windings around the axis of rotation of the rotor. The motor 12 has multiple distinct motor phases that each include a stator phase 42 and associated rotor phase 54. Each motor phase is isolated from the other motor phases in that the stator phase 42 of a motor phase only interacts with the rotor phase 54 of that motor phase and not with other rotor phases 54 of the motor 12. Similarly, the rotor phase 54 of a motor phase only interacts with the stator phase 42 of that motor phase and not with other stator phases 42. It is understood, however, that not all examples are so limited. For example, motor 12 can include permanent magnets 68 that extend to radially overlap with and be acted upon by more than one of coils 46, up to each coil 46 of the motor 12.

Traditional AC induction motors use a plurality of discrete coils that form an array of coils that extend circumferentially around the axis of rotation of the rotor. Each coil represents a potential pole for acting on a magnet. The discrete coils arrayed circumferentially around the axis of rotation in a conventional AC induction motor are out of phase with respect to each other. The discrete coils can interact with a small subset of the magnets at any given instance. The potential torque generated is proportional to the number of poles. The number of poles in such a motor is limited by the ability to fit discrete coils circumferentially around the axis of rotation within the motor. Coil windings can be made smaller, and the diameter of the stator can be made bigger, to accommodate more coils to support more poles, but this increases the size, weight, and cost of the motor and still has limits. Power can also be increased when the rotor is rotating at a relatively high rate, whereby more coil-magnet passes can be experienced per unit time. But such power increase requires the motor to operate at relatively high speed when some applications may desire low-speed output. Providing reduction gearing to reduce speed and increase torque to the desired high torque and low speed increases cost, weight, size, and friction.

Motors 12 according to the present disclosure are different from traditional AC and DC brushless motors. An aspect of the motor 12 is that it contains relatively few coils 46, only three in the illustrated embodiment. Unlike traditional AC and DC brushless motors, the coils 46 are formed from loops of wire that extend entirely around the axis of rotation of the rotor 30 (and the common axis CA). The axis of rotation of the rotor 30 (and the common axis CA) extends through each loop (e.g., the center of each loop). Each coil 46 is annular, and the loops of each coil 46 are likewise annular, and the circular planar profile of the coil 46 and loops are orthogonal to the common axis CA. The ribbon of each coil 46 forms a single hoop, which has multiple loops that overlap and contact one another to form the single hoop assembly. The coils 46 do not include loops that generate flux that rotates the rotor 30 through which the common axis CA does not extend. Instead of adding a coil for each pole as in traditional AC induction motors, the flux rings 74 and flux returns 48 surrounding a single coil 46 channel the flux to a plurality of spurs 66 that flux pair across the flux rings 74 to create a plurality of poles from the single coil 46. In the example shown, for each stator phase 42, one coil 46 supports twenty-four poles as the example flux rings 44 each include twenty-four spurs 66, although lower and higher poles can be created depending on the number of spurs 66. As such, activating one coil 46 activates many poles, whereas in some traditional AC and DC brushless motors activation of one coil activates only one pole. Multiple coils 46 are arrayed along the axis of rotation of the rotor 30 with each coil 46 interacting with a dedicated magnet phase 58 as part of the multiple motor phases, thereby multiplying the number of poles.

The high pole count eliminates or reduces the need for reduction gearing for outputs from motor 12, reducing off-center forces as well as reducing weight and friction, allowing for a more compact arrangement of motor 12 and, in some examples, of fan system 10. The motors 12 of the present disclose can generate high torque with a small package size, even at low speed. Therefore, gear reduction of a drive can be minimized or entirely excluded, providing savings on cost, size, weight, and friction.

It is noted that some aspects of the motor discussed in FIGS. ##-## below may be different as compared to the previous figures. However, all of the details, including materials, functions, structure, and relationships described in connection with one embodiment can be used with the other(s).

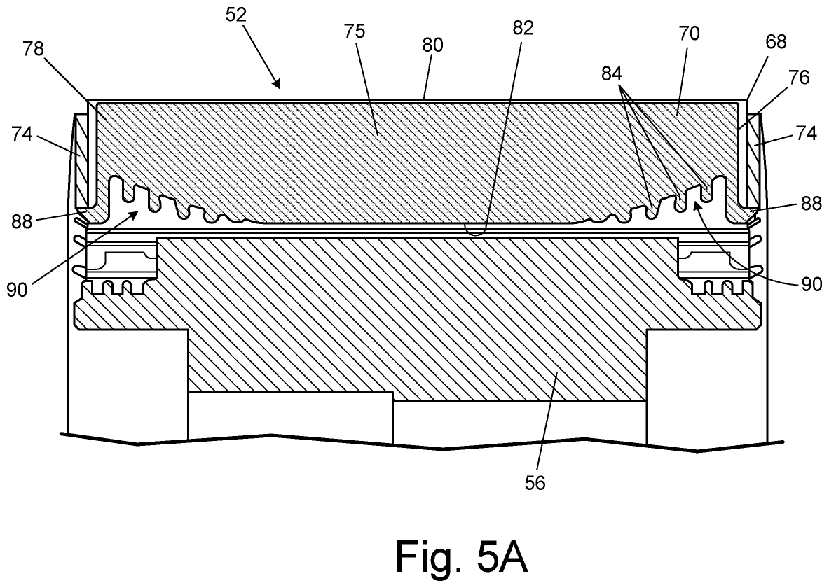

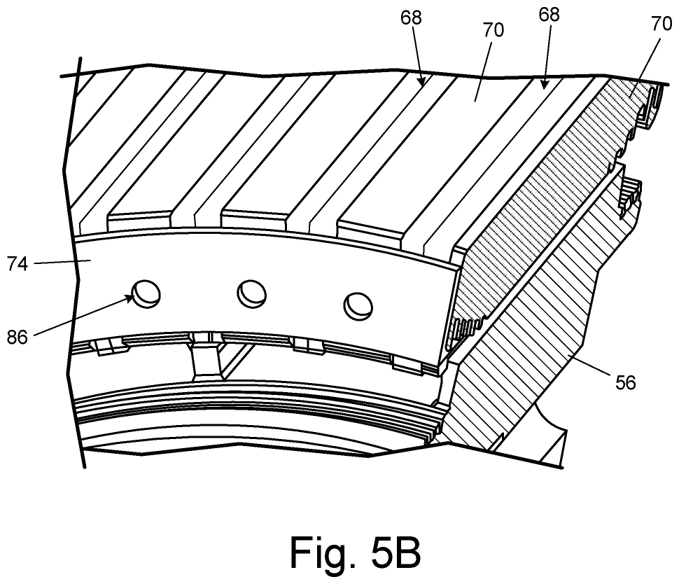

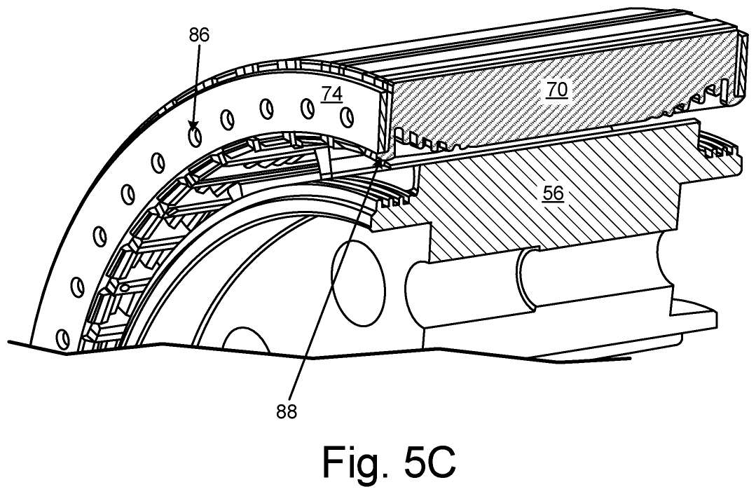

FIG. 5A is an elevational cross-sectional view showing magnetic array 52 supported on mandrel 56. FIG. 5B is a first isometric, cross-sectional view showing magnetic array 52 supported on mandrel 56. FIG. 5C is a second isometric, cross-sectional view showing magnetic array 52 supported on mandrel 56. FIGS. 5A-5C will be discussed together. Mandrel 56, magnetic array 52, and rings 74 are shown. Concentrators 70 and permanent magnets 68 of magnetic array 52 are shown. Concentrator 70 includes concentrator body 75 having first axial end 76, second axial end 78, first radial side 80, and second radial side 82 and concentrator 70 includes fingers 84. Each ring 74 includes openings 86.

Concentrators 70 and magnets 68 are mounted on the mandrel 56. It is noted that the concentrators 70 and magnets 68 may not make direct contact with the mandrel 56 but may instead be separated by a matrix of potting compound which binds components and fills in between. Concentrators 70 are mounted such that first radial side 80 is oriented towards the air gap 60 between rotor 30 and stator 32 and such that second radial side 82 is oriented towards mandrel 56. Second radial side 82 is contoured such that second radial side 82 slopes towards the air gap to narrow a radial thickness of concentrator 70 between an axial midpoint of concentrator 70 and the axial end of concentrator 70. In the example shown, second radial side 82 of concentrator 70 includes a flat central portion and sloped end portions, forming the corner cutouts 90 of concentrator 70. The end portions slope between the central portion and the first axial end 76 and between the central portion and the second axial end 78. First axial end 76 is oriented in first axial direction AD1 and second axial end 78 is oriented in second axial direction AD2.

Part of ring 74 is shown. While motor 12 is shown as including multiple rings 74, on opposite axial ends of magnetic array 52, it is understood that not all examples are so limited. For example, motor 12 could include a single ring 74. Rings 74 are configured to support each annular array of concentrators 70 and magnets 68 of the rotor 30. Ring 74 can be orientated orthogonal to the common axis CA. In the example shown, the flat face of each ring 74 is oriented axially relative to the common axis CA.

As shown, a first ring 74 can be on a first axial side of the phase (annular array of concentrators 70 and magnets 68) and a second ring 74 can be on the second axial size of the phase. The first ring 74 is disposed at first axial end 76 of concentrators 70 and the second ring 74 is disposed at second axial end 78 of concentrators 70. The annular array of concentrators 70 and permanent magnets 68 are disposed axially between the two rings 74. Concentrators 70 and magnets 68 can be sandwiched between the rings 74. The rings 74 structurally support the concentrators 70 and magnets 68. As shown, the ring 74 can include openings 86 or other three-dimensional features which can be penetrated by the potting compound to bind the ring 74 to the other components of the rotor 30. In the example shown, the openings 86 extend fully through the rings 74 such that the potting compound can extends through the ring 74. Ring 74 can be formed from nonmagnetic material, such as polymer, carbon, ceramic, or other materials. In some examples, the ring 74 may not be metal. Non-magnetic material minimizes inadvertent conduction between concentrators 70 and inductive heat rise from the stator 32.

As shown, a pair of rings 74 are on opposite ends of the annular array of concentrators 70 and magnets 68. The rings 74 are supported by ledges 88 which are formed by fingers 84 of the concentrators 70. Fingers 84 extend from second radial side 82 of concentrator 70. Rings 74 are supported on ledges 88 that are formed by the axially outermost fingers 84 of concentrator 70. Ledges 88 form an annular support ledge that interfaces with the ring 74. The annular support ledge is captured within the ring 74, which mechanically retains magnetic array 52 on mandrel 56. The ring 74 can thus be considered to form a retention lock that prevents magnetic array 52 from moving radially away from mandrel 56.

Fingers 84 represent projections into the corner cutouts 90 of the concentrators 70, which form the sloped portions discussed above. The particular corners of the concentrators 70 may not be equally important, electromagnetically, for the performance of the motor, and therefore their elimination can save weight and associated cost of laminations. The fingers 84 represent features around which the potting compound can penetrate and bind to further structurally support the annular array of concentrators 70 and magnets 68. The fingers 84 define gaps that the potting compound flows into and solidifies within during the potting process. As shown, the fingers 84 get longer outwardly from the center of the phase. The radial length of the fingers 84 can increase as closer to the axial ends of concentrator 70 than closer to the axial middle of concentrator 70. The fingers 84 increase in radial length along the corner cutouts and axially towards axial ends 76, 78 of the concentrator 70. In the example shown, the ledge 88 is formed by a portion of the axially outermost finger 84. As such, the ring 74 can be considered to rest on a finger 84 of the concentrator 70.

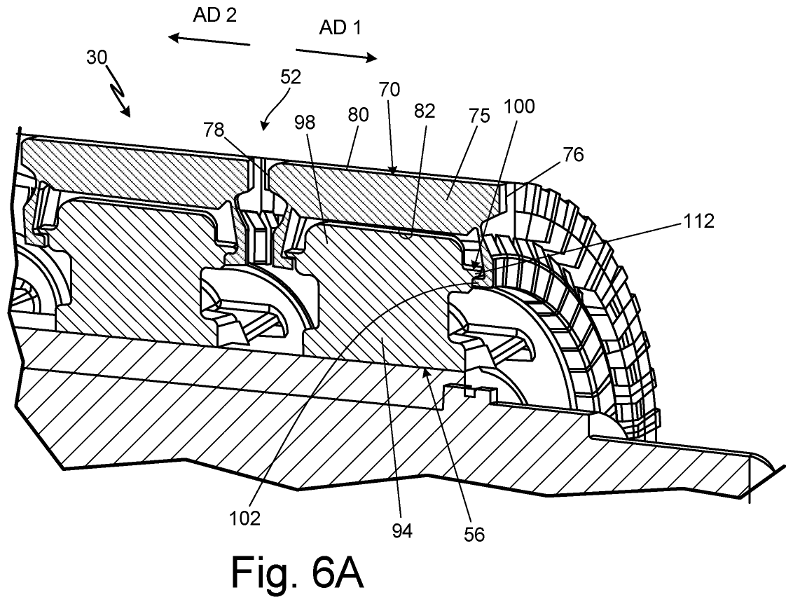

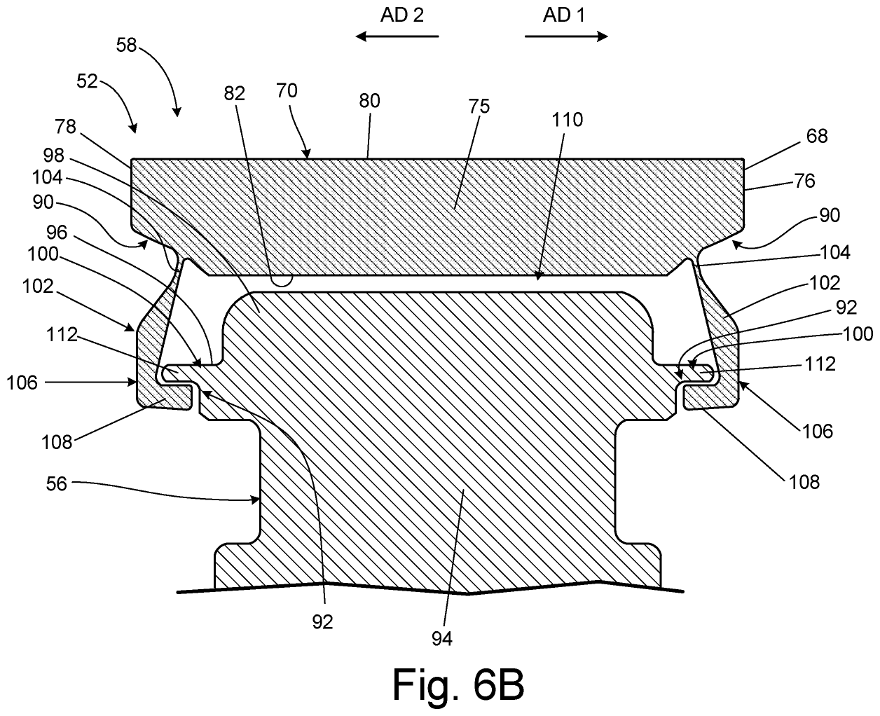

FIGS. 6A-13 discuss retention of magnetic array 52 on the rotor body 50, which can include multiple mandrels 56 forming a hub or a single mandrel 56 forming the hub. Magnetic array 52 is retained by retention locks formed between magnetic array 52 and rotor body 50. The magnetic array 52 is supported on mandrel 56 during operation. In the example shown, each rotor phase 54 includes a single mandrel 56 and a single magnetic array 52. Each magnetic array 52 is associated with a single stator phase 42. It is understood, however, that some examples include a single magnetic array 52 associated with multiple stator phases 42, and thus with multiple coils 46. The retention lock retains the magnetic array 52 on the rotor body 50, maintaining the uniform size of the air gap 60 between rotor 30 and stator 32 and providing efficient operation of motor 12. The retention lock is particularly useful for inner rotating motors as the retention lock counteracts the centrifugal forces applied to the magnetic array 52 during rotation of the rotor 30 that pull the magnetic array 52 outward towards the stator 32.

The retention lock inhibits radial movement of the magnetic array 52 off of the mandrel 56, even if there is no direct contact between the mandrel 56 and magnetic array 52. The retention lock can be formed as a mechanical retention lock or a hybrid retention lock, as discussed in more detail below. The retention lock is an interference lock that inhibits radial movement of magnetic array 52 away from mandrel 56 by physical interference supported by components of magnetic array 52 (e.g., extending from concentrators 70) and components of mandrel 56.

FIG. 6A is an isometric cross-sectional view of a portion of a rotor 30. FIG. 6B is a planar cross-sectional view showing retention lock 92 between magnetic array 52 and mandrel 56. FIGS. 6A and 6B will be discussed together. Drive shaft 20 and rotor phases 54a, 54b of rotor 30 are shown in FIG. 6B. Each rotor phase 54 includes mandrel 56 and magnetic array 52. Mandrel 56 includes mandrel body 94, body surface 96, posts 98, and receivers 100. Magnetic array 52 is formed by permanent magnets 68 interspersed with concentrators 70. Concentrator 70 includes concentrator body 75, first axial end 76, second axial end 78, first radial side 80, second radial side 82, and appendages 102. Each appendage 102 includes neck 104 and appendage body 106, and appendage body 106 includes catch 108.

Mandrel 56 is supported on drive shaft 20. Drive shaft 20 extends through a central bore in mandrel body 94. Mandrel 56 interfaces with drive shaft 20 such that mandrel 56 can exert rotational force on drive shaft 20 to cause rotation of drive shaft 20. Body surface 96 is a surface of mandrel body 94 oriented towards magnetic array 52. In the example shown, body surface 96 is an outer radial surface of mandrel 56 because rotor 30 is an inner rotator with magnetic array 52 disposed on an outer radial side of rotor 30. Posts 98 project radially from body surface 96. Posts 98 project towards magnetic array 52 from body surface 96. As discussed in more detail below, mandrel 56 can include an annular array of posts 98 disposed about mandrel body 94. Posts 98 extend into the radial gap 110 between magnetic array 52 and mandrel body 94.

Receivers 100 are formed on mandrel 56. The receivers 100 are disposed at axial ends of mandrel 56. In the example shown, mandrel 56 includes multiple receivers 100 disposed at opposite axial ends of mandrel 56. Receivers 100 from a component of the retention lock 92 between mandrel 56 and magnetic array 52. Receivers 100 receive a portion of appendage 102 to form the retention lock 92. Receivers 100 are aligned with appendages 102 of concentrator 70 to form a mechanical interference that mechanically retains magnetic array 52 on mandrel 56. Receiver 100 can be formed as a solid or broken ring extending about the rotational axis. Receivers 100 include projections 112 that extend axially outward from mandrel body 94. The projections 112 can form ledges, continuous or broken, that extend about the rotational axis and that are aligned with appendages 102 to form the retention lock 92.

Magnetic array 52 is supported by mandrel 56. Magnetic array 52 is formed by permanent magnets 68 interspersed by concentrators 70. First radial side 80 of concentrator 70 is oriented towards the air gap 60 between rotor 30 and stator 32. Second radial side 82 of concentrator 70 is oriented towards the radial gap 110 between magnetic array 52 and mandrel 56. Appendages 102 extends from concentrator 70 and mechanically interface with mandrel 56. Appendages 102 bridge the radial gap 110 between magnetic array 52 and mandrel 56. Appendages 102 form a component of the retention lock 92 between magnetic array 52 and mandrel 56.

In the example shown, a single concentrator 70 includes multiple appendages 102 that bridge the radial gap 110 between magnetic array 52 and mandrel 56. Appendages 102 extend away from the stator 32 and into the rotor 30. Appendages 102 extend away from the air gap 60 between rotor 30 and stator 32. In the example shown, appendages 102 extend radially inward towards the rotational axis, as motor 12 is formed as an inner rotator. In some examples, appendages 102 are formed from the same material as the concentrator 70. In particular, the appendages 102 can be formed by the same laminate contiguous with the concentrator body 75 of the concentrator 70.

Each concentrator 70 can include one or more appendages 102 that extend to interface with mandrel 56. Appendages 102 extend radially from the concentrator 70 to mount the concentrator 70 to the mandrel 56. In the example shown, each concentrator 70 includes two appendages 102, though it is understood that concentrator 70 can include more or less than two appendages 102 in other examples.

Appendages 102 project from second radial side 82 of concentrator 70. In the example shown, appendages 102 include neck 104 that extends between appendage body 106 and concentrator body 75. Neck 104 connects appendage body 106 to concentrator body 75. Neck 104 is thinner than other portions of appendage 102. Appendages 102 extend to and are aligned with receivers 100 to form the retention lock 92. More specifically, appendage body 106 extends to radially overlap with receiver 100. Receiver 100 physically interferes with radial movement of appendage body 106, and thus of concentrator 70, away from mandrel 56.

Neck 104 is thinner than appendage body 106 to inhibit flux flow into appendage 102 from concentrator body 75. The relatively thin neck 104, as compared to appendage body 106, improves operational efficiency of motor 12 while also facilitating mechanical retention on mandrel 56. In the example shown, appendage body 106 extends to catch 108 that is positioned relative to mandrel 56 to form the retention lock 92. Catch 108 is formed at an opposite end of appendage 102 from neck 104. Catch 108 extends axially to radially align with projection 112. In the example shown, the catch 108 of a first one of appendages 102 extends in first axial direction AD1 while the catch 108 of a second one of appendages 102 extends in second axial direction AD2. The catches 108 of the two appendages 102 extend towards each other. The catches 108 extend towards the opposite axial end of concentrator 70 than the axial end that the appendage 102 of that catch 108 is axially closest to. In the example shown, the catch 108 of the appendage 102 closest to first axial end 76 extends in an axial direction towards second axial end 78 and the catch 108 of the appendage 102 closest to second axial end 78 extends in an axial direction towards first axial end 76.

Appendages 102 are aligned with the projections 112 of receivers 100. Specifically, catches 108 are aligned with projections 112 to radially overlap with projections 112. In some examples, appendages 102 can be considered to grip the projections 112. Appendages 102 are formed as hooks that interface with the ledges formed by receivers 100. In the example shown, catch 108 hooks underneath the projection 112 to form retention lock 92. Appendages 102 are aligned with receivers 100 such that a portion of receiver 100 is disposed radially between a portion of appendage 102 and concentrator body 75. The projection 112 of receiver 100 is disposed radially between catch 108 of appendage 102 and concentrator body 75. A radial line from the rotational axis can extend through appendage 102, then receiver 100, and then concentrator body 75. Receiver 100 extending radially between appendage 102 and concentrator body 75 provides interference that prevents concentrator 70 from being pulled radially away from and off of mandrel 56.

In the example shown, concentrator 70 includes a pair of appendages 102 that are disposed on opposite axial sides of mandrel 56. Mandrel 56 is bracketed by the appendages 102. At least a portion of mandrel body 94 is disposed axially between the two appendages 102 of concentrator 70. The appendages 102 bracketing and connecting to mandrel 56 inhibits relative radial movement and relative axial movement between concentrators 70 and mandrel 56. The retention lock 92 thereby secures concentrators 70, and thus permanent magnets 68, relative to mandrel 56 both during assembly (e.g., during the potting process) and during operation.

While the retention lock 92 is described as including appendages 102 that extend from concentrator 70 and bridge the radial gap 110, it is understood that not all examples are so limited. For example, appendages 102 can be formed on mandrel 56 and receivers 100 can be formed on concentrators 70 such that appendages 102 extend towards the stator 32 to bridge the radial gap 110. The mandrel appendages can interface with the concentrator receivers to retain concentrators 70 on mandrel 56. It is further noted that mechanical retention between concentrators 70 and rotor body 50 can be implemented in inner rotating motors or outer rotating motors. For example, a concentrator 70 can have appendages 102 extending radially outward, away from the rotational axis, to connect to the rotor body for an outer rotating rotor. In the example shown, the retention lock 92 is formed between mandrel 56 and one or more concentrators 70 of the magnetic array 52. It is understood, however, that not all examples are so limited. For example, retention lock 92 could be formed between mandrel 56 and one or more permanent magnets 68.

Retention lock 92 between magnetic array 52 and rotor body 50 provides significant advantages. Concentrators 70 are aligned with mandrel 56 such that the material of mandrel 56 can physically inhibit radial movement of concentrator 70 away from mandrel 56. Permanent magnets 68 are connected to concentrators 70 by adhesive. The joint between adjacent permanent magnets 68 and concentrators 70 can form a planar joint susceptible to shearing. Retention lock 92 between concentrators 70 and mandrel 56 provides a foothold that secures concentrators 70 to mandrel 56, which improves the strength of the adhesive joint between concentrators 70 and permanent magnets 68, increasing operational life, preventing failures, and reducing maintenance costs. Without the retention lock 92, magnetic array 52 may be secured to mandrel 56 by only the matrix of potting compound disposed within the radial gap 110.

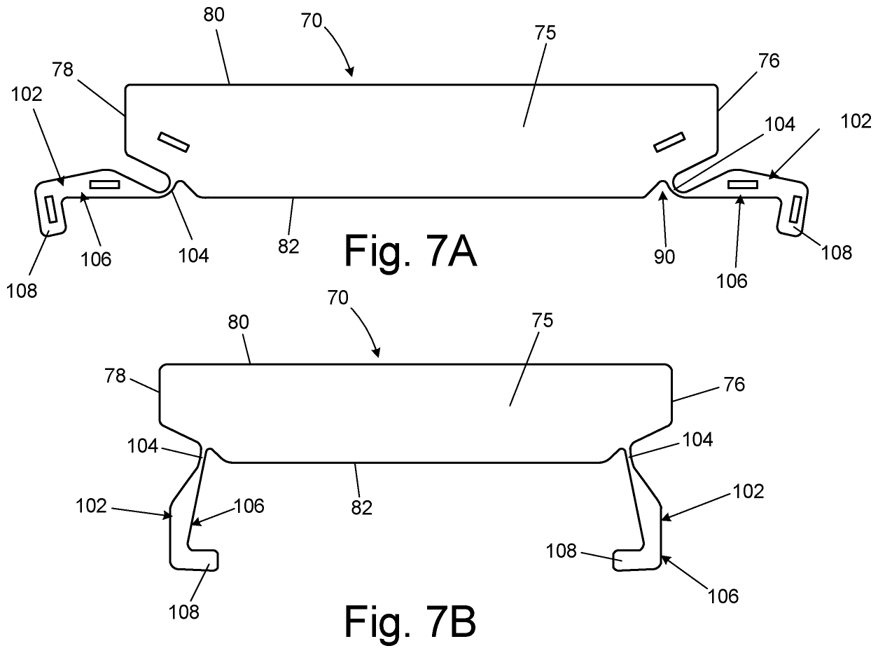

FIG. 7A is an elevational view of a concentrator 70 in a pre-assembly state. FIG. 7B is an elevational view of concentrator 70 in an assembled state. FIGS. 7A and 7B will be discussed together. Concentrator 70 includes concentrator body 75 and appendages 102. Concentrator body 75 includes first axial end 76, second axial end 78, first radial side 80, and second radial side 82. Each appendage 102 includes neck 104 and appendage body 106. Appendage body 106 includes catch 108.

Concentrator 70 is configured to mount to mandrel 56 by an interference alignment that mechanically retains concentrator 70 on mandrel 56. First radial side 80 of concentrator 70 is configured to be oriented towards stator 32 and the air gap 60 between rotor 30 and stator 32. Second radial side 82 of concentrator 70 is disposed opposite the first radial side 80. Second radial side 82 is configured to be oriented towards mandrel 56. Concentrator 70 is axially elongate relative to the rotational axis with concentrator 70 mounted to rotor body 50. Concentrator body 75 extends between first axial end 76 and second axial end 78.

Appendages 102 project from concentrator body 75. Appendages 102 extend away from concentrator body 75 and are configured to bridge the radial gap 110 disposed between concentrator 70 and mandrel 56. In the example shown, appendages 102 extend from corner cutouts 90 of concentrator 70. As such, appendages 102 connect with concentrator body 75 at locations disposed radially between the first radial side 80 and second radial side 82. Appendages 102 are also disposed at locations axially offset from first axial end 76 and second axial end 78. As such, appendages 102 connect with concentrator body 75 at locations disposed axially between first axial end 76 and second axial end 78. Appendages 102 extending from such locations along concentrator 70 prevents damage to appendages 102 prior to rotor assembly because the intersection between appendage 102 and concentrator body 75 is recessed radially and axially from the radial sides 80, 82 and axial ends 76, 78 of concentrator body 75. Appendages 102 interfacing with concentrator body 75 at such locations strengthens the mechanical retention of concentrators 70 on mandrel 56. The force transmission between appendage 102 and concentrator body 75 is axially and radially recessed from radial sides 80, 82 and axial ends 76, 78, strengthening the connection and distributing load. The location at which neck 104 interfaces with concentrator body 75 is axially bracketed by potting compound with rotor 30 fully assembled. Such potting compound is radially overlapped by concentrator body 75. The potting compound provides backing support to further strengthen the joint at neck 104.

FIG. 7A shows a concentrator 70 before it is mounted. In this case, the appendages 102 extend axially from the concentrator 70 prior to mounting. For example, the laminas of concentrator 70 can initially be formed with the axially-extending appendages 102 (e.g., by stamping, among other options). FIG. 7B shows the appendages 102 having been bent to grip features on which the concentrator 70 is mounted (e.g., the projections 112 of receivers 100). Neck 104 is formed as a thin bend portion to facilitate bending at the particular location of neck 104. Appendages 102 are manipulable between the pre-assembly state and the assembled state to facilitate assembly of concentrators 70 on mandrel 56 prior to fixing with the potting compound. Concentrators 70 can be embedded in potting mixture to fix the appendages 102 in the assembled state with the appendages 102 hooked on to the mandrel 56.

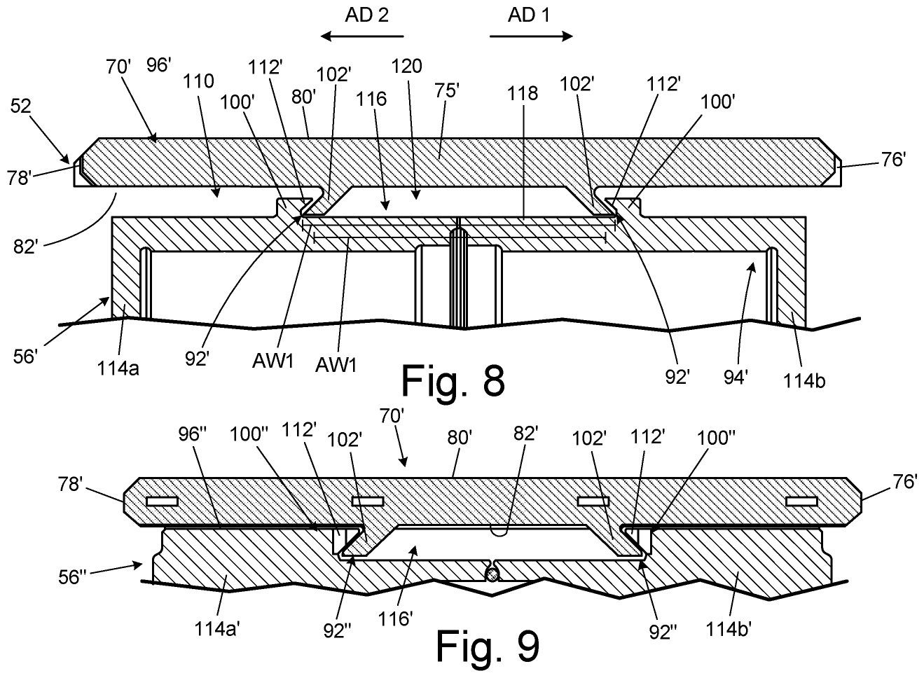

FIG. 8 is a cross-sectional view showing retention lock 92′ between magnetic array 52 and mandrel 56′. Concentrator 70′ of magnetic array 52 is shown. Concentrator 70′ includes concentrator body 75′ and appendages 102′. Concentrator body 75′ includes first axial end 76′, second axial end 78′, first radial side 80′, and second radial side 82′. Mandrel 56′ includes mandrel body 94′, body surface 96′, and receivers 100′. Mandrel body 94′ includes body portions 114a, 114b. Retention lock 92′ is substantively similar to retention lock 92 (FIGS. 6A and 6B) and is configured to physically inhibit radial movement of magnetic array 52 relative to mandrel 56′.

Body surface 96′ is a surface of mandrel body 94′ spaced radially from magnetic array 52. In the example shown, body surface 96′ is an outer radial surface of mandrel 56′ because mandrel 56′ is configured for use in an inner rotator with magnetic array 52 disposed on an outer radial side of the rotor. It is understood, however, that retention lock 92′ between concentrator 70′ and mandrel 56′ can be applied to an outer rotating motor.

Mandrel 56′ is formed by opposed body portions 114a, 114b. Body portions 114a, 114b are separately formed and assembled together to form mandrel 56′. A seal can be disposed between body portion 114a and body portion 114b. For example, an annular o-ring can be disposed axially between body portion 114a and body portion 114b. Receivers 100′ are formed on mandrel body 94′. Receivers 100′ project from mandrel body 94′. In the example shown, receivers 100′ project radially relative to body surface 96′ of mandrel body 94′. Receivers 100′ extend radially into the radial gap 110 to at least partially bridge the radial gap 110 between magnetic array 52 and mandrel body 94′. In the example shown, receivers 100′ extend only partially across the radial gap 110 such that receivers 100′ are spaced radially from magnetic array 52. Receivers 100′ include projections 112′ that extend axially and at least partially define retaining groove 116. Receivers 100′ can be integrally formed with mandrel body 94′ or formed separately from mandrel body 94′ and assembled thereto.

A first one of the receivers 100′ is disposed on the body portion 114a and a second one of the receivers 100′ is disposed on body portion 114b. Receivers 100′ are disposed to define retaining groove 116. Retaining groove 116 is disposed axially between the receivers 100′. In the example shown, retaining groove 116 has a first axial width AW1 at groove base 118 of the retaining groove 116, formed along the body surface 96′, and retaining groove 116 has a second axial width AW2 at the groove opening 120 through which appendages 102′ extend. The second axial width AW2 is smaller than the first axial width AW1 to prevent appendages 102′ from moving out of retaining groove 116. Retaining groove 116 can also be referred to as a dovetail groove. Receivers 100′ are shaped to form the differing widths at groove base 118 and groove opening 120. Each receiver 100′ extends from mandrel body 94′ and includes projection 112′. Projection 112′ extends axially relative to a body of the receiver 100′. Groove opening 120 is defined axially between projections 112′. In the example shown, projections 112′ extend axially towards each other to form the narrower width of groove opening 120 relative to the width of groove base 118.

First radial side 80′ of concentrator 70′ is oriented towards the air gap 60 between rotor 30 and stator 32. Second radial side 82′ of concentrator 70′ is oriented towards the radial gap 110 between magnetic array 52 and mandrel 56′. Appendages 102′ project from concentrator 70′ and interface with a portion of mandrel 56′ to form retention lock 92′. In the example shown, appendages 102′ extend away from the air gap 60 between rotor 30 and stator 32 and towards mandrel 56′. Appendages 102′ extend from concentrator 70′ and bridge the radial gap 110 between magnetic array 52 and mandrel 56′. Appendages 102′ form a component of the retention lock 92′ between magnetic array 52 and mandrel 56′. In the example shown, appendages 102′ have a greater radial extent than receivers 100′ such that appendages 102′ fully bridge the radial gap 110 while receivers 100′ partially bridge the radial gap 110. Such a configuration spaces the material forming the mandrel 56′ from the magnetic array 52. Spacing the material of the mandrel from the magnetic array 52 inhibits inductive heating to the mandrel 56′.

Concentrator 70′ includes multiple appendages 102′ that bridge the radial gap 110 between magnetic array 52 and mandrel 56′. Appendages 102′ extend inward towards the rotational axis in the example shown, as motor 12 is formed as an inner rotator. It is understood, however, that some examples include appendages 102′ that extend outward and away from the rotational axis, in examples in which motor 12 is formed as an outer rotator. In some examples, appendages 102′ are formed from the same material as the concentrator 70′. In particular, the appendages 102′ can be formed by the same metal contiguous with the concentrator body 75′ of the concentrator 70′. For example, the appendages 102′ can be formed from the same laminate sheets as the concentrator body 75′.

Appendages 102′ extend to and interface with receivers 100′ to form the retention lock 92′ between magnetic array 52 and mandrel 56′. In the example shown, each concentrator 70′ includes two appendages 102′, though it is understood that concentrator 70′ can include more or less than two appendages 102′ in other examples. Appendages 102′ project from second radial side 82′ of concentrator 70′. In the example shown, appendages are canted to extend both axially and radially from a base of the appendage 102′, which interfaces with concentrator body 75′, to a distal end of the appendage 102′, which is disposed opposite the base of the appendage 102′. Specifically, a first one of appendages 102′ extends in first axial direction AD1 relative to the rotational axis while a second one of the appendages 102′ extends in second axial direction AD2 opposite first axial direction AD1. In the example shown, the appendages 102′ extend away from each other such that the bases of the appendages 102′ are axially closer together than the distal ends of the appendages 102′. Such a configuration is unlike that shown in FIGS. 6A and 6B, in which appendages 102 project axially towards each other to form the retention locks 92′. It is understood, however, that not all examples are so limited. For example, the multiple appendages 102′ can extend in the same direction (e.g., both appendages 102′ can extend in the first axial direction AD1 or second axial direction AD2) or the multiple appendages 102′ can extend towards each other.

Appendages 102′ extend into retaining groove 116 formed axially between receivers 100′. Appendages 102′ extend to radially overlap with projections 112′ of receivers 100′. The projections 112′ of receivers 100′ extend to be disposed radially between portions of appendages 102′ and concentrator body 75′. As such, the receivers 100′ are positioned to interfere with radial movement of appendages 102′, and thus of concentrators 70′, away from mandrel 56′. Such an interference mechanically retains concentrators 70′ on mandrel 56′. In some examples, appendages 102′ mechanically interface with receivers 100′ to form the retention lock 92′.

Receivers 100′ are formed as hooks that interface with the canted appendages 102′. Appendages 102′ extend to interface with receivers 100′ such that a portion of receiver 100′ is disposed radially between a portion of appendage 102′ and concentrator body 75′. Retention lock 92′ retains concentrators 70′ on mandrel 56′ by the radial overlap between receivers 100′ and appendages 102′. Retention lock 92′ is formed such that a radial line from the rotational axis extends through mandrel body 94′, then appendage 102′, then receiver 100′, and then concentrator body 75′. Receiver 100′ extending to be radially between appendage 102′ and concentrator body 75′ provides interference that prevents concentrator 70′ from being pulled radially away from mandrel 56′.

In the example shown, receivers 100′ interface with opposite axial sides of appendages 102′. The appendages 102′ are axially bracketed by receivers 100′. At least a portion of concentrator 70′ (i.e., the portion of appendages 102′ in retaining groove 116) is disposed directly axially between the two receivers 100′ of the mandrel 56′. The receivers 100′ axially bracketing appendages 102′ inhibits relative axial movement between concentrators 70′ and mandrel 56′. The retention lock 92′ thereby secures concentrators 70′, and thus permanent magnets 68, relative to mandrel 56′ both during assembly (e.g., during the potting process) and during operation.

In the example shown, mandrel 56′ is formed as a multi-part component to facilitate formation of retaining groove 116 and retention of concentrators 70′. Body portion 114a is initially separate from body portion 114b. During assembly, concentrators 70′ are positioned relative to body portion 114a such that a first one of appendages 102′ is disposed underneath the receiver 100′ of body portion 114a to prevent radial movement of the concentrator 70′ away from body portion 114a. Body portion 114b is shifted towards body portion 114b such that the second one of the appendages 102′ is captured underneath the receiver 100′ of the body portion 114b. Assembling body portion 114b to body portion 114a forms retaining groove 116 and captures appendages 102′ within the retaining groove 116. Capturing appendages 102′ in retaining groove 116 mechanically retains concentrators 70′ on mandrel 56′.

Retention lock 92′ between magnetic array 52 and mandrel body 94′ provides significant advantages. Concentrators 70′ are mechanically retained on mandrel 56′ by radial overlap between components of concentrator 70′ and components of mandrel 56′, inhibiting radial movement of concentrators 70′ away from mandrel 56′. Permanent magnets 68 are connected to concentrators 70′ by adhesive. The joint between adjacent permanent magnets 68 and concentrators 70′ can form a planar joint susceptible to shearing. Retention lock 92′ provides a foothold that secures concentrators 70′ to mandrel 56′, which also improves the strength of the adhesive joint between concentrators 70′ and permanent magnets 68, increasing operational life, preventing failures, and reducing maintenance costs.

FIG. 9 is a cross-sectional view showing retention lock 92″ between magnetic array 52 and mandrel 56″. Concentrator 70′ of magnetic array 52 is shown. Concentrator 70′ includes concentrator body 75′ and appendages 102′. Concentrator body 75′ includes first axial end 76′, second axial end 78′, first radial side 80′, and second radial side 82′. Mandrel 56″ includes mandrel body 94″, body surface 96″, and receivers 100″. Mandrel body 94″ includes body portions 114a′, 114b′.

Retention lock 92″ is configured to physically inhibit radial movement of magnetic array 52 relative to mandrel 56″. Retention lock 92″ is substantively similar to retention lock 92 (FIGS. 6A and 6B) and retention lock 92′ (FIG. 8). Retention lock 92″ is substantively similar to retention lock 92′, except that retaining groove 116′ of retention lock 92″ extends into mandrel body 94″, whereas retaining groove 116 is disposed radially outside of mandrel body 94′. Retaining groove 116′ is recessed relative to body surface 96″. Receivers 100″ are do not project radially beyond mandrel body 94″ in this example. Receivers 100″ can be formed by mandrel body 94″ or separately from mandrel body 94″.

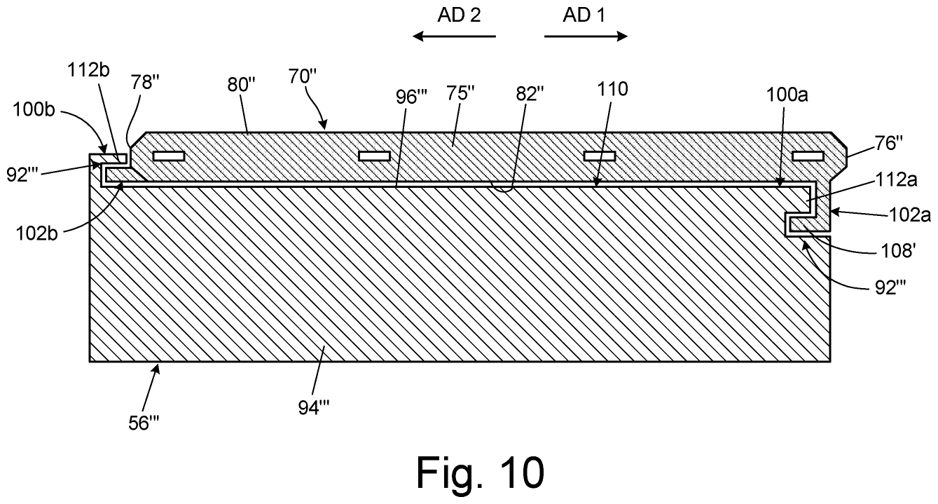

FIG. 10 is a cross-sectional view showing retention lock 92′″ between concentrator 70″ and mandrel 56′″. Concentrator 70″ includes concentrator body 75″ and appendages 102a, 102b. Concentrator body 75″ includes first axial end 76″, second axial end 78″, first radial side 80″, and second radial side 82″. Mandrel 56′″ includes mandrel body 94′″, body surface 96′″, and receivers 100a, 100b.

Retention lock 92′″ is configured to physically inhibit radial movement of magnetic array 52 relative to mandrel 56″. Retention lock 92′″ is substantively similar to retention lock 92 (FIGS. 6A and 6B), retention lock 92′ (FIG. 8), and retention lock 92″ (FIG. 9).

Body surface 96′″ is a surface of mandrel body 94′″ facing magnetic array 52. In the example shown, body surface 96′″ is an outer radial surface of mandrel 56′″ because mandrel 56′″ is configured for use in an outer rotator. It is understood, however, that the retention locks 92′″ between concentrator 70″ and mandrel 56′″ can be applied equally to an outer rotating motor.

Receivers 100a, 100b are formed on mandrel 56′″. Receivers 100a, 100b are configured to receive appendages 102a, 102b, respectively, to retain concentrator 70″ on mandrel 56′″. Receiver 100a is disposed at a first axial end of mandrel body 94′″. Receiver 100a includes projection 112a that at least partially defines a receiving area into which appendage 102a of concentrator 70″. In the example shown, the receiving area is formed as a groove in mandrel 56′″. The annular groove can extend fully, 360-degrees, about the rotational axis. Receiver 100a is open in first axial direction AD1.

Receiver 100b is disposed at a second axial end of mandrel body 94′″, opposite the first axial end of mandrel body 94′″. Receiver 100b includes projection 112b that at least partially defines a receiving area into which appendage 102b of concentrator 70″ extends. In the example shown, the receiving area is formed as a groove in mandrel 56′″. The annular groove can extend fully, 360-degrees, about the rotational axis. Receiver 100b is open in first axial direction AD1. Receiver 100a and receiver 100b are open in the same axial direction to facilitate assembly of the rotor and mounting of concentrators 70″ on mandrel 56′″.

First radial side 80″ of concentrator 70″ is oriented towards the air gap 60 between the rotor and the stator. Second radial side 82″ of concentrator 70″ is oriented towards the radial gap 110 between concentrator 70″ and mandrel 56″″. Appendages 102a, 102b project from concentrator 70″ and interface with mandrel 56′″ to form retention lock 92′″ between concentrator 70″ and mandrel 56′″.

Appendage 102a is disposed proximate first axial end 76″ of concentrator 70″. Other examples can include an appendage 102a disposed at first axial end 76″. Appendage 102b projects radially from first axial end 76″ and includes catch 108′ that extends axially into the receiving groove of receiver 100a. Appendage 102a extends away from the air gap 60 between the rotor and stator. Appendage 102a extends from concentrator 70″ to bridge the radial gap 110 between concentrator 70′″ and mandrel 56″. Catch 108′ extends axially from a body of appendage 102b.

Appendage 102b is spaced axially from appendage 102a. In the example shown, appendage 102b is disposed at second axial end 78″ of concentrator 70″. Appendage 102b extends axially beyond second axial end 78″ of concentrator 70″. Appendage 102b is spaced radially from first radial side 80″. Appendage 102b is disposed radially between first radial side 80″ and second radial side 82″.

Appendages 102a, 102b extend to radially overlap with receivers 100a, 100b, respectively, to form the retention locks 92′″ between concentrator 70″ and mandrel 56′″. Appendages 102a, 102b extend in the same radial direction such that concentrators 70″ can be mounted to mandrel 56′″ by axial movement of concentrator 70″ relative to mandrel 56′″. In the example shown, appendages 102a, 102b extend in second axial direction AD2 such that appendages 102a, 102b can enter into receivers 100a, 100b through the openings oriented in the first axial direction AD1. In the example shown, the catch 108′ of appendage 102a is spaced radially from appendage 102b. Such radial offset facilitates axial mounting of concentrator 70″ on mandrel 56′″.

Appendage 102a is disposed in the slot of receiver 100a. Appendage 102a is disposed such that receiver 100a radially overlaps with appendage 102a. Receiver 100a extends over appendage 102a to inhibit radial movement of concentrator 70″ away from mandrel 56′″. More specifically, projection 112 of receiver 100a extends to radially overlap with appendage 102a. Appendage 102b is disposed in slot of receiver 100b. Appendage 102b is disposed such that receiver 100b radially overlaps with appendage 102b. Receiver 100b extends over appendage 102b to inhibit radial movement of concentrator 70′″ away from mandrel 56′″. More specifically, projection 112 of receiver 100b extends to radially overlap with appendage 102b. Retention locks 92′″ are formed by the radial overlaps between receivers 100a, 100b and appendages 102a, 102b to radially retain concentrator 70″ on mandrel 56′″.

Concentrator 70″ is configured to mount to mandrel 56′″ by axial movement of concentrator 70″ relative to mandrel 56″. Appendages 102a, 102b both extend in second axial direction AD2. Appendages 102a, 102b extends in second axial direction AD2 relative to the locations that appendages 102a, 102b interface with concentrator body 75″. Appendages 102a, 102b are oriented to enter into the openings of receivers 100a, 100b that are oriented in first axial direction AD1. During mounting, concentrator 70″ is aligned with mandrel 56′″ by aligning appendages 102a, 102b with the slots of receivers 100a, 100b. Concentrator 70″ is shifted in second axial direction AD2 to cause appendages 102a, 102b to enter into the slots of receivers 100a, 100b. Appendage 102a passes through the opening of receiver 100a to form a first retention lock 92′″ between concentrator 70″ and mandrel 56″. Appendage 102b passes through the opening of receiver 100b to form a second retention lock between concentrator 70″ and mandrel 56′″. In some examples appendages 102a, 102b can simultaneously pass through the openings of receivers 100a, 100b, respectively, to form the mechanical interfaces.

Potting compound can then be applied to axially fix concentrator 70″ relative to mandrel 56′″. Concentrator 70″ is mounted such that retention locks 92′″ physically inhibit radial movement of concentrator 70″ relative to mandrel 56′″. The retention locks 92′″ also prevent axial movement of concentrator 70″ relative to mandrel 56′″ in second axial direction AD2. Adhesive prevents axial movement of concentrator 70″ relative to mandrel 56′″ in first axial direction AD1. Concentrator 70″ can thus be considered to be retained in three directions by overlap between concentrator 70″ and mandrel 56′″ and in a fourth direction by the adhesive of the potting compound.

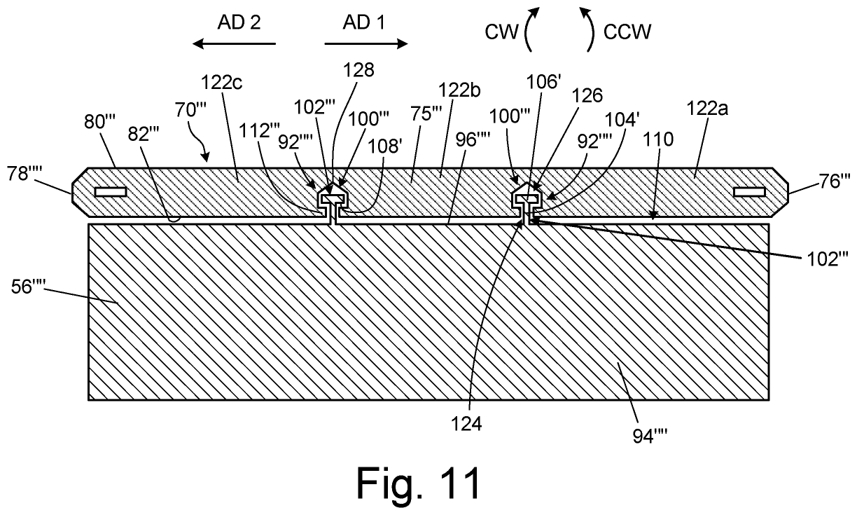

FIG. 11 is a cross-sectional view showing retention lock 92″″ between concentrators 70′″ and mandrel 56″″. Concentrator 70′″ includes concentrator body 75′″ and receivers 100′″. Concentrator body 75′″ includes first axial end 76′″, second axial end 78′″, first radial side 80′″, and second radial side 82′″. Receivers 100′″ include projections 112′″. Mandrel 56″ includes mandrel body 94″″, body surface 96″″, and appendages 102′″. Appendages 102′″ each include neck 104′ and appendage body 106′.

The retention lock 92″″ between magnetic array 52 and mandrel 56″″ is substantively similar to the examples shown in FIGS. 6A-10, except that appendages 102′″ of retention lock 92″″ extend from mandrel 56″″ and receivers 100′″ of retention lock 92″″ are formed in concentrators 70′″.

Appendages 102′″ project from body surface 96″″ of mandrel 56″″. Appendages 102′″ extend radially away from body surface 96″″. Appendages 102′″ extend away from mandrel 56″″ and towards the air gap between the rotor and the stator. Appendages 102′″ bridge the radial gap 110 disposed between concentrators 70′″ and mandrel 56″″. Appendages 102′″ radially overlap with receivers 100′″ to prevent radial movement of concentrator 70′″ away from mandrel 56″″. More specifically, appendages 102″″ and receivers 100′″ are aligned such that appendages 102′″ interfere with and prevent radial movement of receivers 100′″, and thus of concentrators 70′″, away from appendages 102′″.

In the example shown, mandrel 56″″ includes two appendages 102′″, though it is understood that mandrel 56″″ can include more or fewer than two appendages 102′″, such as one, three, four, or more appendages 102′″. Appendages 102′″ can be formed as discrete projections from mandrel 56″″ or as arcuate or annular projections. In one example, an array of appendages 102′″ can be disposed circumferentially around mandrel 56″″. Each array of appendages 102′″ can include a discrete appendage 102′″ for each concentrator 70′″ of the magnetic array 52. In such an example the appendages 102′″ interface with concentrators 70′″ and circumferential gaps are formed between appendages 102′″. The circumferential gaps are aligned with permanent magnets 68 such that the permanent magnets 68 can extend to circumferentially overlap with appendages 102′″. In another example, appendages 102′″ can be formed as arcuate projections that extend at least partially circumferentially around the mandrel 56″″. In another example, appendages 102′″ can be formed as annular rings that extend up to fully around the mandrel 56″″.

In the example shown, each appendage 102′″ includes neck 104′ that interfaces with mandrel body 94″″. Neck 104′ extends radially away from mandrel body 94″″. Appendage body 106′ is disposed at an end of neck 104′ opposite mandrel body 94″″. Catch 108′ is formed by appendage body 106′. Catch 108′ is oriented to face towards mandrel 56″. Appendage body 106′ is thicker than neck 104′ to form catch 108′ that projects outward from neck 104′. In the example shown, appendage body 106′ is axially thicker than neck 104′. Catch 108′ is formed by the surfaces of appendage body 106′ that extend axially outward from neck 104′. In the example shown, catch 108′ projects in both first axial direction AD1 and second axial direction AD2 from neck 104′, though it is understood that not all examples are so limited. For example, appendage 102′″ can include catch 108′ projecting in a single direction outward from neck 104′.

Concentrator 70′″ is supported relative to mandrel 56″″. Receivers 100′″ are formed within concentrator 70″. Receivers 100′″ are disposed within concentrator body 75′″. In some examples, receivers 100′″ extend fully through concentrator body 75″ through the circumferential sides of concentrator body 75′″, which circumferential sides abut the permanent magnets adjacent that concentrator 70′″. Each receiver 100′″ includes at least one projection 112′″ that is configured to interface with appendage 102′″. In the example shown, receivers 100′″ each include two projections 112″ that extend to define receiver opening 124 through which neck 104′ extends. The projections 112′″ of a single receiver 100′″ extend axially towards each other such that receiver opening 124 has a narrower axial width than receiving cavity 126. It is understood, however, that not all examples are so limited. For example, receiver 100′″ can include a single projection 112′″. Projections 112′″ extend to radially overlap with catch 108′ to form the retention lock 92″″ between concentrator 70′″ and mandrel 56″″.

Receivers 100′″ extend into concentrator 70′″ from second radial side 82′″. Receiver openings 124 are formed through second radial side 82′″. In the example shown, receivers 100′″ are spaced inward from first axial end 76′″ and second axial end 78′″.

Appendages 102′″ extend into receivers 100′″ and are aligned with receivers 100′″ such that receivers 100′″ radially retain concentrators 70′″ on mandrel 56″″. At least a portion of the appendage 102′″ extends into and axially overlaps with the concentrator body 75′″. The portion of the appendage 102′″ axially overlaps with the metal forming the concentrator body 75′″. The portion of the appendage 102′″ can axially overlap with one or more, up to all, of the laminas of concentrator body 75′″. The portion of the appendage 102′″ can also radially overlap with one or more, up to all, of the laminas of concentrator body 75′″.

Receiver 100′″ is formed such that concentrator 70′″ can be reconfigured between a pre-assembly state and an assembled state, similar to concentrator 70 (best seen in FIGS. 7A and 7B). In the example shown, receiver 100′″ includes apex 128 that is formed on an opposite radial side of receiving cavity 126 from receiver opening 124. Apex 128 forms a portion of receiving cavity 126 that extends furthest radially into concentrator body 75′″ and towards the stator. Concentrator body 75′″ is radially thinnest at the location of apex 128.

Apex 128 facilitates bending of concentrator body 75′″ at apex 128 to mount concentrator 70′″ to mandrel 56″″. For example, in the pre-assembly position, concentrator body portion 122a is rotated (in direction CW) relative to concentrator body portion 122b at the apex 128 of the receiver 100′″ between concentrator body portions 122a, 122b, and concentrator body portion 122b can be rotated clockwise relative to concentrator body portion 122c at the apex 128 of the receiver 100′″ between concentrator body portions 122b, 122c. The relative bent positions of the concentrator body portions 122a-122c widens the receiver openings 124. With concentrator 70′″ In the pre-assembly state, the receiver openings 124 are wide enough that appendage body 106′ can pass into receiving cavity 126 through receiver opening 124.

During assembly of the rotor, concentrator 70′″ can be bent back to the assembled position to capture appendages 102′″ in receivers 100′″. For example, concentrator 70′″ can initially be positioned such that a first appendage 102′″ is at least partially disposed in the receiving cavity 126 between concentrator body portions 122b, 122c. Concentrator body portion 122b can then be bent counterclockwise (in direction CCW) relative to concentrator body portion 122c. Such bending narrows the width of the receiver opening 124 between concentrator body portions 122b, 122c such that the appendage body 106′ cannot pass radially through receiver opening 124 due to interference by projections 112′″. The neck 104′ of that appendage 102′″ projects through the receiver opening 124. Concentrator body portion 122a is bent counterclockwise (in direction CCW) relative to concentrator body portion 122b. Such bending narrows the width of the receiver opening 124 between concentrator body portions 122a, 122b such that the appendage body 106′ cannot pass radially through receiver opening 124 due to interference by projections 112′″. In another example, concentrator body portion 122b is positioned such that each appendage 102′″ is in a receiving cavity 126 and then concentrator body portions 122a, 122c are bent to the assembled positions.

Retention lock 92″″ provides significant advantages. Concentrators 70′″ are mechanically retained on mandrel 56″″ by radial overlap between components of concentrator 70′″ and components of mandrel 56″″, inhibiting radial movement of concentrators 70′″ away from mandrel 56″″. Retention lock 92″″ provides a foothold that secures concentrators 70′″ to mandrel 56″″, which also improves the strength of the adhesive joint between concentrators 70′″ and permanent magnets 68, increasing operational life, preventing failures, and reducing maintenance costs. Retention lock 92″″ prevents radial movement of concentrators 70′″ away from mandrel 56″″, maintaining the size of the air gap 60 between the stator and the rotor and facilitating the formation of a smaller air gap, increasing motor efficiency, without worry of movement of elements of magnetic array 52 radially into the air gap 60.

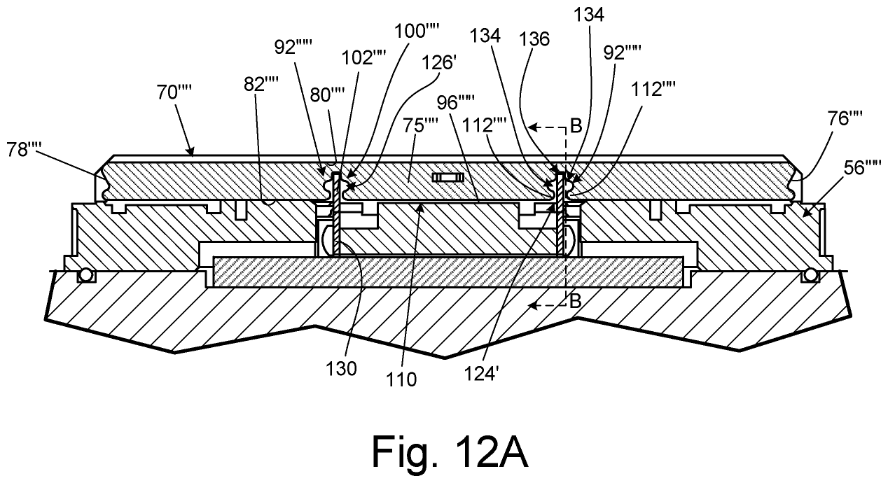

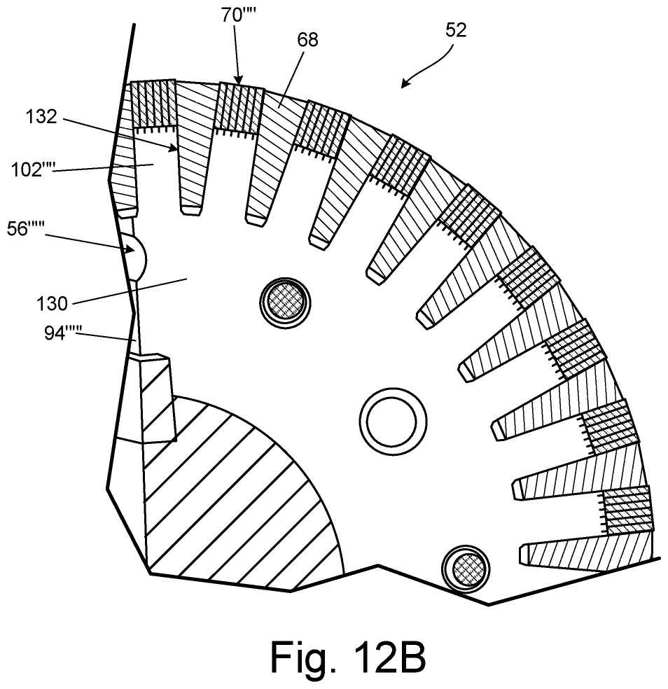

FIG. 12A is a cross-sectional view showing a hybrid retention lock 92″″ between concentrator 70″″ and mandrel 56′″″. FIG. 12B is a cross-sectional view taken along line B-B in FIG. 12A. Concentrator 70″″ includes concentrator body 75″″ and receivers 100″″. Concentrator body 75″″ includes first axial end 76″″, second axial end 78″″, first radial side 80″″, and second radial side 82″″. Receivers 100″″ include projections 112″″. Mandrel 56″″ includes mandrel body 94″″, body surface 96′″″, and appendages 102″″.

The retention lock 92″″ between magnetic array 52 and mandrel 56″″ is substantively similar to the examples shown in FIGS. 6A-11, except that retention lock 92″″ is a hybrid interface in which concentrator 70″″ is radially retained by adhesive (e.g., potting compound) with mechanical support. The examples shown in FIGS. 6A-11 are mechanical retention locks that include radial overlap between the material of an appendage and the material of a receiver to radially retain the concentrator on the mandrel. The hybrid interface does not include direct mechanical interference (e.g., between material forming the concentrator and material forming the mandrel) inhibiting radial separation; instead, the hybrid interface includes adhesive that bonds to the axially overlapping appendage 102″″ and receiver 100″″ and which adhesive radially overlaps with receiver 100″″ to inhibit radial separation between concentrator 70″″ and mandrel 56″″.

In the illustrated example, appendages 102″″ extend from mandrel 56″″′ and into concentrator 70″″. It is understood, however, that the hybrid retention interface can be formed by appendages 102″″ extending from concentrator 70″″ into mandrel 56″″′. In other examples, the hybrid retention interface can be formed by appendages 102″″ on both concentrator 70″″ and mandrel 56″″ extending into receivers 100″″ formed on both mandrel 56″″′ and concentrator 70″″.

Receivers 100″″ are formed within concentrator 70″″. The receiving cavity 126′ of receivers 100″″ extends into concentrator body 75″″ from second radial side 82″″. The receiving cavity 126′ does not extend fully through concentrator body 75″″ to first radial side 80″″. Receiver 100″″ includes receiver opening 124′ that is open towards radial gap 110 between concentrator 70″″ and mandrel 56″″′. Receiver 100″″ does not include any opening oriented towards or open into the air gap 60 between the rotor and stator.

Projections 112″″ define receiver opening 124′. For each receiver 100″″, projections 112″″ extend axially towards each other such that receiver opening 124′ is axially narrower than receiving cavity 126′. Recesses 134 are formed within concentrator body 75″″. Recesses 134 provide enlarged portions of receiving cavity 126′. Recesses 134 extend axially outward relative to projections 112″″ such that receiving cavity 126′ is axially larger than receiver opening 124′. Locating slot 136 is disposed at an opposite radial side of receiver 100″″ from receiver opening 124′. Locating slot 136 extends radially towards first radial side 80″″ from receiving cavity 126′.

Appendages 102″″ extend from mandrel 56″″′. Appendages 102″″ extend radially away from body surface 96″″′ of mandrel 56″″. In the example shown, appendages 102″″ are formed separately from mandrel body 94″″′ and connected to mandrel body 94″″′ (e.g., by fasteners (e.g., bolts, rivets, etc.), by adhesive, by welding, etc.). Mandrel body 94″″′ is formed from multiple body portions in the example shown, though it is understood that not all examples are so limited. Appendages 102″″ project radially outward from support plate 130. Support plate 130 is mounted to mandrel 56″″′. As shown in FIG. 12B, notches 132 are disposed circumferentially between appendages 102″″. Notches 132 provide negative spaces into which the permanent magnets 68 can project. Permanent magnets 68 circumferentially overlap with appendages 102″″ in the example shown. In the example shown, each appendage 102″″ is formed as a flat plate that projects radially towards the stator.

Appendage 102″″ extends across and bridges radial gap 110. Appendages 102″″ extend into receivers 100″″. Appendages 102″″ extend into receivers 100″″ through receiver openings 124′. In the example shown, the distal radial end of appendage 102″″, which is oriented towards the air gap between the rotor and stator, extends into locating slot 136. Appendage 102″″ extending into locating slot 136 provides a mechanical interference between mandrel 56″″′ and concentrator 70″″ that prevents relative axial movement therebetween. It is understood, however, that not all examples are so limited. For example, some hybrid retention locks 92″″′ may not include locating slots 136.

Appendage 102″″ extends into receiving cavity 126′ but does not radially overlap with projections 112″″ in the example shown. In the hybrid interface shown, appendages 102″″ being located within receivers 100″″ does not prevent concentrator 70″″ from being pulled radially off of mandrel 56″″′ prior to applying the potting compound. Appendages 102″″ do not radially overlap with portions of the receiver 100″″ in such a way that receiver 100″″ physically inhibits appendage 102″″ from moving radially relative to receiver 100″″. Instead, appendages 102″″ provide mechanical backing support to the adhesive potting compound. The appendages 102″″ provide reinforcement to the adhesive potting compound to provide a stronger and more durable connection than potting compound alone.

During assembly, concentrator 70″″ is placed relative to mandrel 56″″′ by moving the concentrator 70″″ radially towards mandrel 56″″′. Appendages 102″″ enter into receivers 100″″ through receiver openings 124′. With concentrators 70″″ positioned relative to mandrel 56″″′, potting compound is applied. The potting compound fills into receiver 100″″ and adheres to both receiver 100″″ and appendage 102″″. More specifically, the potting compound flows through receiver opening 124′ and into receiving cavity 126′. The potting compound fills into recesses 134. The potting compound curing within recesses 134 creates bulbs of potting compound within the receiving cavity 126′. The bulbs of potting compound are axially larger than the receiver opening 124′ and radially overlap with projections 112″, physically inhibiting concentrator 70″″ from being pulled radially off of mandrel 56″″′. Appendages 102″″ axially overlap with and are disposed within the bulbs of potting compound, providing reinforcement to the potting compound and increasing the tensile strength of the potting compound to assist in radially retaining concentrators 70″″ on mandrel 56″″′.

The hybrid retention lock 92″″′ provides significant advantages. An appendage 102″″ bridges the radial gap 110 and extends into a receiver 100″″. The appendage 102″″ extends to axially overlap with the material of the receiver 100″″ to provide axial retention. The appendage 102″″ and receiver 100″″ do not mechanically interfere with each other to inhibit radial movement such that concentrator 70″″ does not require physical reconfiguration during assembly (e.g., by bending components of concentrator 70″″). Potting compound adheres to appendage 102″″ and within receiver 100″″ to lock concentrator 70″″ to mandrel 56″″′. The potting compound fills into the receiver 100″″ such that the potting compound interfaces with the interior of the receiver 100″″ and interfaces with the portion of the appendage 102″″ disposed within the receiver 100″″. The appendage 102″″ strengthens the potting compound, increasing the strength of the retention lock 92″″′ relative to a configuration utilizing only potting compound to retain the magnetic array 52 on mandrel 56″″′.

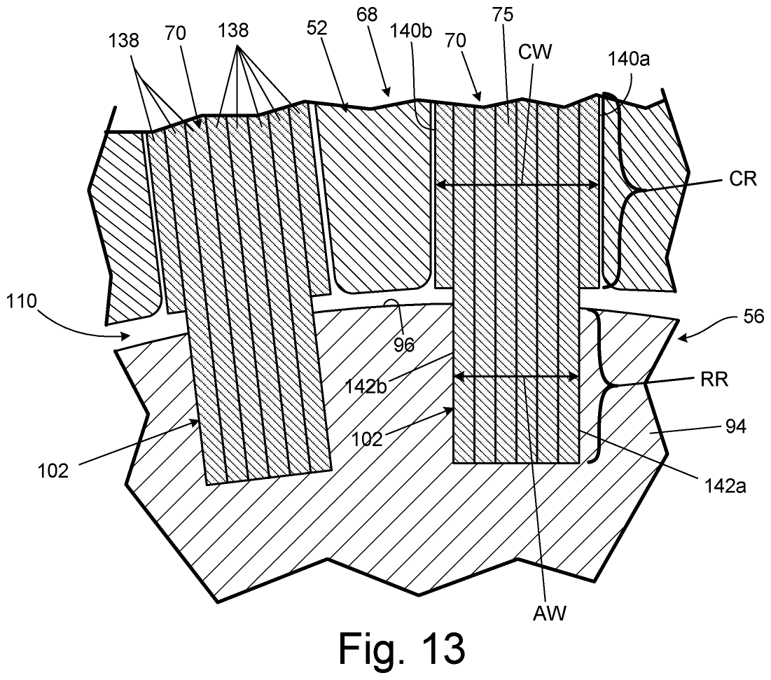

FIG. 13 is an enlarged cross-sectional view showing magnetic array 52 disposed relative to mandrel 56. Concentrators 70 and permanent magnets 68 are shown. Concentrator body 75, appendages 102, and laminas 138 of concentrator 70 are shown. Concentrator body 75 includes body circumferential sides 140a, 140b. Appendages 102 includes appendage circumferential sides 142a, 142b.

Concentrator 70 is formed by stacked sheets of lamina 138, in the example shown. Though it is understood that not all examples are so limited. Appendages 102 project radially from concentrator body 75. Appendages 102 are substantially similar to appendages 102′ (FIGS. 8 and 9) and appendage 102b (FIG. 10). It is understood that the following discussion can apply equally to any appendage that extends from a concentrator to bridge the radial gap 110 between magnetic array 52 and mandrel 56 to form a retention lock therebetween, regardless of whether the retention lock is mechanical or hybrid.

In inner rotating motors, appendages 102 converge towards each other as appendages 102 get closer to the axis of rotation. It is desirable to space the material forming the concentrators 70 circumferentially away from the material forming other concentrators 70 to prevent flux jumping between concentrators 70. Concentrator body 75 is disposed in a concentration region CR circumferentially between permanent magnets 68. Appendage 102 is disposed, at least partially, outside of the concentration region CR. Appendage 102 extends into a retention region RR that is not circumferentially between permanent magnets 68. The retention region RR is disposed radially within mandrel body 94.

Concentrator body 75 has a body width BW taken between the body circumferential sides 140. Appendage 102 has an appendage width AW taken between the appendage circumferential sides 142. Body width BW and appendage width AW can also be referred to as circumferential widths of the concentrator body 75 and appendage 102, respectively. Body width BW and appendage width AW can be taken tangential to a circle centered on the axis of rotation of the rotor. As shown, body width BW is larger than appendage width AW. Appendage width AW is smaller than body width BW to increase the circumferential distance between appendages 102 of adjacent concentrators 70.

In the example shown, appendage 102 includes fewer lamina 138 than concentrator body 75. One or both of the circumferentially outer lamina 138 of concentrator body 75 can be removed from appendage 102 to provide the reduced appendage width AW. For example, the circumferentially outer lamina 138 can be formed without the portion associated with appendage 102 prior to assembly of concentrator 70. The lamina 138 missing the portion associated with the appendage 102 are assembled as the circumferentially outer lamina 138 of the concentrator 70.

The circumferentially outer lamina 138 of appendage 102 can be formed by intermediate lamina 138 of the concentrator body 75, the intermediate lamina being any lamina 138 between the circumferentially outermost lamina 138. The circumferentially outer lamina 138 of appendage 102 can be formed by the circumferentially outermost intermediate lamina 138 of the concentrator body 75, which is the first lamina 138 circumferentially inboard from the circumferentially outermost lamina 138.

As shown, both circumferentially outer lamina 138 of the concentrator body 75 are removed from appendage 102. As such, both appendage circumferential sides 142 are recessed relative to the body circumferential sides 140. In such an example, appendage 102 is two lamina 138 thinner than concentrator body 75. It is understood, however, that not all examples are so limited. For example, concentrator 70 can be formed such that appendage 102 is missing less than two lamina 138 or more than two lamina 138, such as three, four, or more, relative to the number of lamina 138 forming concentrator body 75.

In one example, appendages 102 are missing a single lamina 138 relative to concentrator body 75. The single lamina 138 can be removed from the same circumferential side of each appendage 102. For example, each appendage circumferential side 142a can be formed by an intermediate lamina 138 of concentrator body 75 while each appendage circumferential side 142b can be formed by circumferentially outer lamina 138 of concentrator body 75.

Reducing the width of appendage 102 relative to concentrator body 75 provides significant advantages. Concentrator bodies 75 are disposed in the concentration region CR adjacent to permanent magnets 68. Appendages 102 are disposed in the retention region RR where the metallic material of circumferentially adjacent concentrators 70 is not shielded by the permanent magnets 68. The reduced width of appendages 102 relative to concentrator body 75 increases the circumferential distance between appendages 102 within the retention region RR. The increased gap distance between appendages 102 inhibits flux from jumping between concentrators 70, increasing motor efficiency.

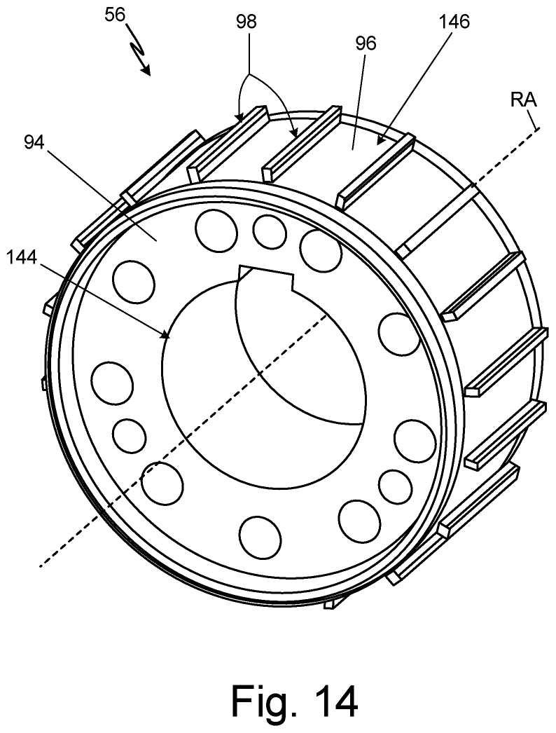

FIG. 14 is an isometric view of mandrel 56. Mandrel 56 includes mandrel body 94, body surface 96, posts 98, and shaft bore 144. Mandrel 56 is configured to support a magnetic array of an electric motor. Mandrel 56 forms at least a portion of a rotor hub of the rotor of the electric motor. Mandrel 56 is configured to mount to a drive shaft that extends through shaft bore 144.

Mandrel body 94 is disposed about rotational axis RA of the rotor. Mandrel body 94 supports other components of rotor 30, such as magnetic array 52, and is configured to transmit driving rotational force to the drive shaft 20. Posts 98 extend from mandrel 56. Posts 98 extend radially away from body surface 96. Posts 98 are configured to project away from body surface 96 and towards the magnetic array 52, as discussed in more detail below. In the example shown, posts 98 are axially elongate and extend along the body surface 96.

Posts 98 are configured to add mechanical support outward from the mandrel body 94 while minimizing the amount of material of the mandrel 56 close to the annular array of concentrators 70 and magnets 68. Circumferential gaps 146 are formed circumferentially between adjacent ones of the posts 98. Posts 98 project radially between fixed ends 148 at body surface 96 and free ends 150 that are spaced radially from body surface 96. The circumferential gaps 146 are disposed circumferentially between adjacent posts 98 and radially between body surface 96 and the free ends 150 of posts 98. Posts 98 form an annular array that extends about mandrel body 94. In some examples, posts 98 are evenly arrayed about mandrel 56 such that the circumferential gaps 146 are equally sized. It is understood, however, that some examples may include posts 98 that are unevenly arrayed about mandrel 56. In the example shown, a single circumferential gap 146 extends further circumferentially around mandrel body 94 than a single post 98 extends circumferentially around mandrel body 94. As such, circumferential gaps 146 can be considered to be circumferentially wider than posts 98.

It is noted that the stator 32 generates electromagnetic flux around the rotor 30 which will cause heat generation via induction to conductive materials of motor 12 while operating in the field, such as structural metal elements. The metal of the mandrel 56 can generate heat due to inductive heating from the electromagnetic fields. To inhibit such heating, the mandrel body 94 is separated from the annular array of concentrators 70 and magnets 68 by radial gap 110. Spacing mandrel 56 from magnetic array 52 inhibits inductive heating of mandrel body 94. Posts 98 project away from mandrel body 94 and towards the annular array of concentrators 70 and magnets 68 (radially outward in the example shown). Posts 98 extend at least partially across radial gap 110.

Posts 98 provide fixation points for potting compound. The potting compound fills into the circumferential gaps 146 between the posts 98. Posts 98 capturing blocks of potting compound therebetween facilitates torque transfer between the magnetic array 52 and mandrel 56, increasing operational efficiency. The blocks of potting compound are circumferentially bracketed by posts 98 and circumferentially overlap with posts 98. The circumferential overlap facilitates the improved torque transfer through the potting compound and material forming the posts 98, as compared to toque transfer along a joint without circumferential overlap.

Posts 98 capturing blocks of potting compound further inhibits delamination of the potting compound from body surface 96. Posts 98 project radially to form irregularities along body surface 96. As such, the joint between the potting compound and body surface 96 is not smoothly curved around body surface 96; instead, the posts 98 periodically break the smooth curvature. If cracks appear in potting compound, such cracks typically propagate along a surface joint that can lead to shearing and delamination. The irregularities formed by posts 98 inhibit crack propagation and strengthen the adhesion between the potting compound and mandrel 56.

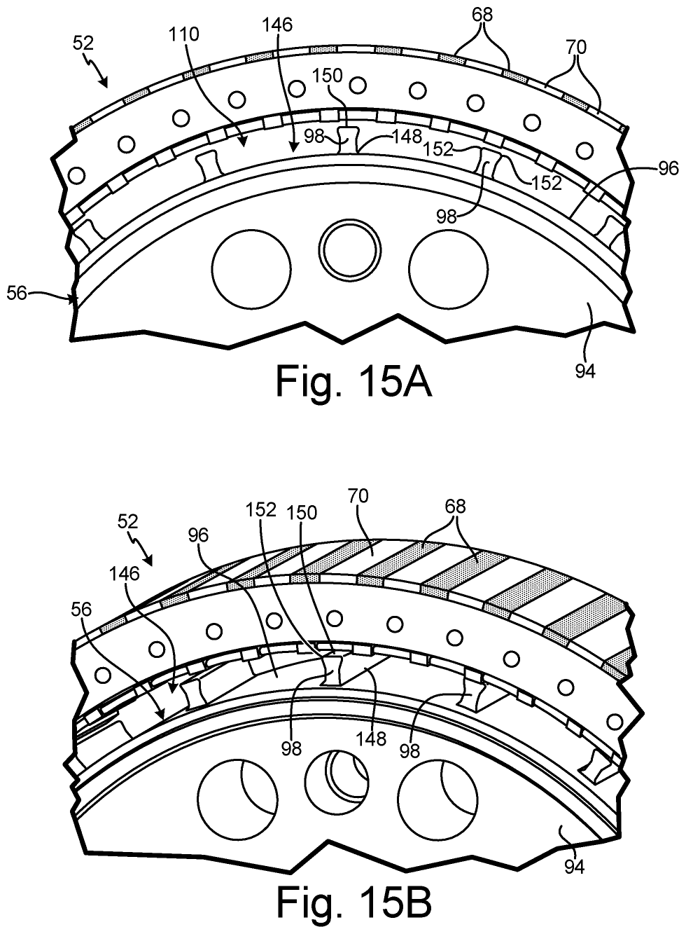

FIG. 15A is a partial planar axial end view showing magnetic array 52 relative to mandrel 56. FIG. 15B is a partial isometric view showing magnetic array 52 relative to mandrel 56. FIGS. 15A and 15B will be discussed together. Magnetic array 52 includes concentrators 70 and permanent magnets 68. Mandrel 56 includes mandrel body 94, body surface 96, and posts 98. Posts 98 includes fixed end 148, free end 150, and shoulder 152.

Posts 98 extend away from mandrel body 94 and towards magnetic array 52. In the example shown, posts 98 extend radially outward, away from the rotational axis, as the example shown is an inner rotator. It is understood, however, that mandrel 56 with posts 98 can be configured for use in an outer rotator. In such an example, posts 98 extend radially inward towards the rotational axis.

In the example shown, mandrel 56 includes fewer posts 98 than magnetic array 52 includes concentrators 70. As such, a post count of the mandrel 56, which is the number of posts 98 of mandrel 56, is less than a concentrator count of the magnetic array 52, which is the number of concentrators 70 of the magnetic array 52. It is understood, however, that not all examples are so limited. For example, the post count can be the same as or greater than the concentrator count.

Posts 98 extend between fixed end 148 at mandrel body 94 and free end 150 spaced radially away from mandrel body 94. In some examples, posts 98 are formed integrally with mandrel body 94. For example, posts 98 and mandrel body 94 can be formed as a monolithic structure. Posts 98 extend to the free ends 150 that are spaced from mandrel body 94. Shoulders 152 are formed at free end 150. In the example shown, posts 98 include two shoulders 152 that project in opposite circumferential directions from post 98. Shoulders 152 are formed as circumferentially enlarged portions of posts 98. Shoulders 152 project away from the body of post 98 to project over the circumferential gap 146 disposed between posts 98. Shoulders 152 are thus disposed radially between the magnetic array 52 and circumferential gap 146. At least a portion of the shoulder 152 is disposed radially between the block of potting compound in the circumferential gap 146 and the magnetic array 52. Shoulder 152 is thereby positioned to physically inhibit the block of potting compound from shifting radially away from and off of mandrel body 94. Shoulder 152 assists in maintaining the potting compound on the mandrel body 94.

Posts 98 extend towards magnetic array 52. In the example shown, posts 98 extend towards magnetic array 52 but do not extend to circumferentially overlap with components of magnetic array 52. Free ends 150 of posts 98 are spaced radially from magnetic array 52. Posts 98 extending towards magnetic array 52 allows body surface 96 to be spaced further from magnetic array 52, inhibiting heating of mandrel 56, than if posts 98 were not present. Spacing mandrel body 94 from magnetic array 52 discourages inductive heating of mandrel 56. Extending posts 98 towards magnetic array 52 can assist in cooling of the motor by utilizing mandrel 56 as a thermal sink. Posts 98 project towards magnetic array 52 such that posts 98 are disposed to absorb heat generated during operation while also spacing mandrel body 94 from magnetic array 52 to inhibit inductive heating. The heat can be transferred through posts 98 to mandrel body 94, and from mandrel body 94 to dissipate the heat outside of motor 12.

As discussed above with regard to FIGS. 3A and 3B, a motor can include rotor phases 54 that each include a mandrel 56 and an associated magnet phase 58. The magnet phases 58 of the multiple rotor phases 54 can be axially misaligned and circumferentially offset relative to each other. The mandrels 56 of the multiple rotor phases 54 can be aligned with each other or circumferentially offset relative to each other. For example, the posts 98 of a first mandrel 56 can be axially aligned with the posts 98 of a second mandrel 56. The posts of the second mandrel 56 can be axially aligned with the posts 98 of a third mandrel 56, etc. A projection of the cross-section of a post 98 of one mandrel 56 taken orthogonal to common axis CA can be aligned with a similar cross-sectional projection of a post 98 of another mandrel 56. In other examples, the posts 98 of one or more of the mandrels 56 can be partially or fully axially misaligned with posts 98 of one or more of the other mandrels 56. For example, a projection of the cross-section of a post 98 of a mandrel 56 taken orthogonal to common axis CA can be misaligned with a similar cross-sectional projection of a post 98 of other mandrels 56 of other rotor phases 54.

Mandrel 56 including posts 98 provides significant advantages. The projecting posts 98 represent a balance between minimizing the amount of metal that can be inductively heated while still providing metal to structurally support the annular array of concentrators 70 and magnets 68. Posts 98 form irregularities along body surface 96 that inhibit propagation of cracks in the potting compound and prevent delamination between the potting compound and mandrel 56. Posts 98 capturing potting compound in circumferential gaps 146 assists in torque transfer.

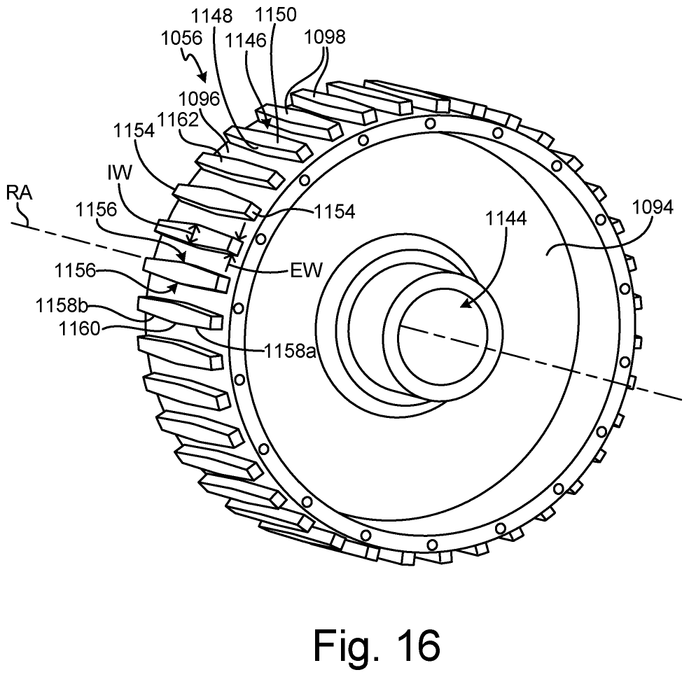

FIG. 16 is an isometric view of mandrel 1056. Mandrel 1056 includes mandrel body 1094, body surface 1096, and posts 1098. Posts 1098 include axial ends 1154 and vertices 1160. Mandrel 1056 is configured to support a magnetic array of an electric motor. Mandrel 1056 forms at least a portion of a rotor hub of the rotor of the electric motor. Mandrel 1056 is configured to mount to a drive shaft that extends through shaft bore 1144.

Mandrel 1056 is substantially similar to mandrel 56 (best seen in FIG. 14) in that posts project radially away from the mandrel body of both mandrel 1056 and mandrel 56. Components of mandrel 1056 are labeled similar to components of mandrel 56, except the reference number is increased by “1000” (e.g., post 98 for mandrel 56 and post 1098 for mandrel 1056).

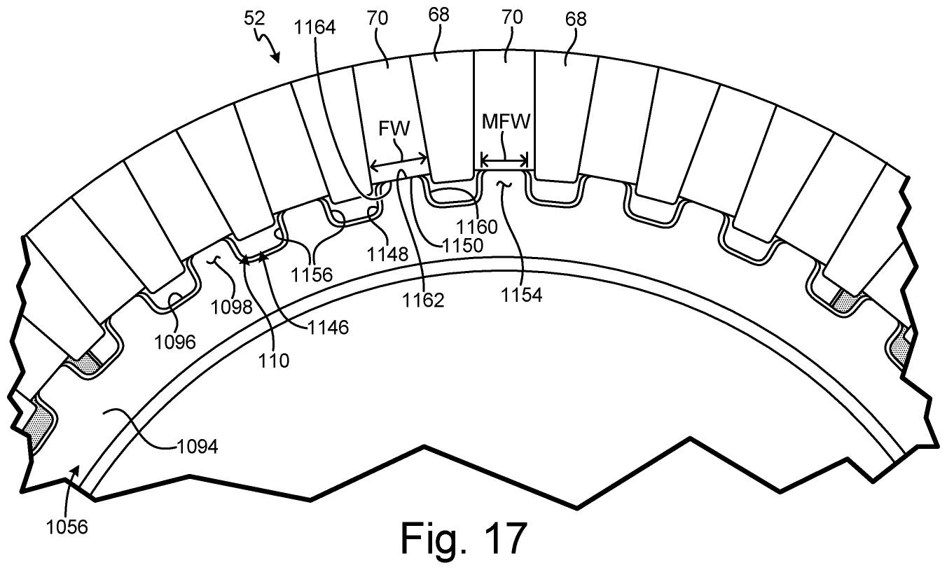

Mandrel body 1094 is disposed about rotational axis RA of the rotor. Mandrel body 1094 supports other components of the rotor, such as magnetic array 52, and is configured to transmit driving rotational force to the drive shaft 20. Posts 1098 extend from mandrel 1056. Posts 1098 extend radially away from body surface 1096. Posts 1098 extend from fixed end 1148 at body surface 1096 to free end 1150 spaced radially from body surface 1096. Posts 1098 are configured to project away from body surface 1096 and towards the magnetic array 52, as discussed in more detail below in FIGS. 17A and 17B. In the example shown, posts 1098 are axially elongate and extend along the body surface 1096.

Posts 1098 are configured to add mechanical support outward from the mandrel body 1094 while minimizing the amount of material of the mandrel 1056 close to the annular array of concentrators 70 and magnets 68. Circumferential gaps 1146 are formed circumferentially between adjacent ones of the posts 1098. The circumferential gaps 1146 are disposed circumferentially between adjacent posts 1098 and radially between body surface 1096 and the free ends 1150 of posts 1098. Posts 1098 form an annular array that extends about mandrel body 1094.

As noted above, electromagnetic flux can cause heat generation via induction to thermally conductive materials of motor 12, such as structural metal elements. The metal of the mandrel 1056 can generate heat due to inductive heating from the electromagnetic fields. To inhibit such heating, the mandrel body 1094 is separated from the annular array of concentrators 70 and magnets 68 by radial gap 110. Spacing mandrel 1056 from magnetic array 52 inhibits inductive heating of mandrel body 1094. Posts 1098 project away from mandrel body 1094 and towards the annular array of concentrators 70 and magnets 68 (radially outward in the example shown). Posts 1098 extend at least partially across radial gap 110.

Posts 1098 provide fixation points for the potting compound. The potting compound fills into the circumferential gaps 1146 between the posts 1098. Posts 1098 capturing blocks of potting compound therebetween facilitates efficient torque transfer between the magnetic array 52 and mandrel 1056, increasing operational efficiency. The blocks of potting compound are circumferentially bracketed by posts 1098 and circumferentially overlap with posts 1098. The circumferential overlap facilitates the improved torque transfer through the potting compound and material forming the posts 1098, as compared to toque transfer along a joint without circumferential overlap,

Posts 1098 capturing blocks of potting compound further inhibits delamination of the potting compound from body surface 1096. Posts 1098 project radially and provide irregularities along body surface 1096 such that the joint between the potting compound and body surface 1096 is not smoothly curved around body surface 1096 but is instead broken up by the irregularities formed by posts 1098. If cracks appear in potting compound, such cracks typically propagate along a surface joint that can lead to shearing and delamination. The irregularities formed by posts 1098 inhibit crack propagation and strengthen the adhesion between the potting compound and mandrel 1056.

Posts 1098 are axially elongate along body surface 1096. Posts 1098 extend between the axial ends of mandrel 1056. In the example shown, axial ends 1154 of posts 1098 are recessed from the axial ends of mandrel 1056 such that a portion of body surface 1096 is disposed axially between the axial end 1154 of post 1098 and the axial end of mandrel 1056. It is understood, however, that not all examples are so limited. For example, one of both of axial ends 1154 of posts 1098 can extend to the axial end of mandrel 1056.

In the example shown, posts 1098 are configured such that the posts 1098 do not have a uniform width between the post circumferential sides 1156 along the full axial length of post 1098. Each post circumferential side 1156 include two wall portions 1158a, 1158b on either axial side of a vertex 1160. The two wall portions 1158a, 1158b are canted circumferentially to form the variable widths of the post 1098. The first wall portion 1158a extends from an axial end 1154 of post 1098 to vertex 1160. The second wall portion 1158b extends from the other axial end 1154 of post 1098 to vertex 1160. The wall portions 1158a, 1158b are canted such that the wall portions 1158a, 1158b extend away from the opposite circumferential side 1156 of the post 1098 as the wall portions 1158a, 1158b extend towards the vertex 1160. The canted wall portions 1158a, 1158b expand the width of post 1098 between circumferential sides 1156 between axial ends 1154 and vertices 1160.

In the example shown, post 1098 has an end width EW at axial ends 1154 and has an intermediate width IW at a location intermediate the axial ends 1154. Intermediate width IW is greater than end width EW. Intermediate width IW is a largest width of post 1098 between circumferential sides 1156. In the example shown, the intermediate width IW is taken at vertices 1160. Vertices 1160 are located at the axial midpoint of post 1098. It is understood, however, that not all examples are so limited. For example, vertices 1160 can be located at any desired location between axial ends 1154. In some examples, the end width EW of one or both axial ends 1154 can be the largest width portion of post. In one example, post 1098 can widen along its full axial length such that one end width EW is the largest width of post 1098. In another example, canted wall portions 1158a, 1158b can converge towards each other such that the intermediate width IW at vertices 1160 is a smallest width portion of post 1098.

The variable width of posts 1098 enhances bonding of potting compound on mandrel 1056. The variable widths of posts 1098 creates variable width circumferential gaps 1146, which inhibits axial delamination of potting compound from mandrel 1056.

Mandrel 1056 including posts 1098 provides significant advantages. The projecting posts 1098 represent a balance between minimizing the amount of metal that can be inductively heated by spacing mandrel body 1094 away from magnetic array 52 while still providing metal to structurally support the annular array of concentrators 70 and magnets 68. Posts 1098 form irregularities along body surface 1096 that inhibit propagation of cracks in the potting compound and prevent delamination between the potting compound and mandrel 1056. Posts 1098 capturing potting compound in circumferential gaps 1146 assists in torque transfer.

FIG. 17 is a partial elevational end view showing magnetic array 52 mounted relative to mandrel 1056. Magnetic array 52 includes permanent magnets 68 and concentrators 70. Mandrel 1056 includes mandrel body 1094, body surface 1096, and posts 1098.

Posts 1098 project from mandrel body 1094 towards magnetic array 52. In the example shown, posts 1098 are radially aligned with concentrators 70. Posts 1098 are not radially aligned with permanent magnets 68. Posts 1098 may not radially overlap with permanent magnets 68. Posts 1098 can be formed integrally with mandrel body 1094 or formed separately from mandrel body 1094 and assembled to mandrel body 1094. In some examples, posts 1098 and mandrel body 1094 are formed as a monolithic structure.

Posts 1098 extend away from mandrel body 1094 and towards magnetic array 52. As such, mandrel 1056 can be considered to have a gear-tooth configuration in which the posts 1098 form the gear teeth extending away from mandrel body 1094. In some examples, posts 1098 extend to contact concentrators 70. In other examples, posts 1098 are spaced radially away from concentrators 70 but are still disposed closer to concentrators 70 than mandrel body 1094. Radial post face 1162 of the post 1098 is oriented towards and faces the radial concentrator face 1164 that is oriented towards mandrel 1056. Radial post face 1162 can be in contact with radial concentrator face 1164. In the example shown, radial post face 1162 has a maximum width MFW at the vertices (FIG. 16) of the post 1098. In the example shown, the maximum width of radial post face 1162 can be the same as or slightly less than the intermediate width IW of post 1098. Radial concentrator face 1164 has a face width FW between the circumferential sides of the concentrator 70. The face width FW is larger than the maximum width MFW of radial post face 1162. The larger width of concentrator 70 as compared to post 1098 spaces posts 1098 circumferentially relative to the permanent magnets 68 bracketing the concentrator 70.

Posts 1098 are aligned with concentrators 70 to provide thermal pathways for wicking heat from magnetic array 52. As discussed above, concentrators 70 can be formed from stacked laminate sheets, which laminate material is susceptible to inductive heating. Posts 1098 extend close to, or into contact with, concentrators 70. The posts 1098 are positioned to absorb heat generated by concentrators 70 and wick the heat away from concentrators 70 to mandrel body 1094. Mandrel body 1094 is spaced from magnetic array 52 to inhibit inductive heating of mandrel body 1094, facilitating use of mandrel body 1094 as a portion of the cooling circuit. The intermediate width IW being the largest circumferential width of post 1098 positions that largest width portion of post 1098 between the axial ends of the concentrator 70 aligned with that post. The larger surface area of post 1098 in that intermediate region further enhances cooling in that intermediate area, which is a portion of magnetic array 52 more susceptible to heating than the axial end portions.

As shown, permanent magnets 68 extend radially beyond concentrators 70 and towards mandrel 1056, though it is understood that not all examples are so limited. Permanent magnets 68 are thus radially larger than concentrators 70. The permanent magnets 68 extend such that at least a portion of the permanent magnet 68 circumferentially overlaps with one or more posts 1098. The portion of the permanent magnet circumferentially overlapping with posts 1098 does not radially overlap with post 1098 and does not axially overlap with post 1098.

The permanent magnets 68 extend radially into the circumferential gaps 1146 disposed between adjacent ones of the posts 1098. Circumferential gaps 1146 are radially aligned with permanent magnets 68. Circumferential gaps 1146 have a variable width along the radial extent of the circumferential gap 1146. The circumferential width of the circumferential gaps 1146 increases from body surface 1096 towards magnetic array 52.

In the example shown, the rotor 30 includes one post 1098 for each concentrator 70. As such, a post count of the mandrel 1056, which is the number of posts 1098 of mandrel 1056, is the same as a concentrator count of the magnetic array 52, which is the number of concentrators 70 of the magnetic array 52. It is understood, however, that not all examples are so limited. For example, the post count can be less than or greater than the concentrator count.

Posts 1098 space mandrel body 1094 away from magnetic array 52 to inhibit inductive heating of mandrel body 1094. Blocks of potting compound are captured in circumferential gaps 1146 between adjacent ones of the posts 1098. The blocks of potting compound assist in torque transfer from magnetic array 52 to mandrel 1056, increasing motor efficiency. In addition, if cracks appear in potting compound, such cracks typically propagate along a surface joint that can lead to shearing and delamination. The irregularities along body surface 1096 formed by the projecting posts 1098 inhibit crack propagation and strengthen the adhesion between the potting compound and mandrel 1056.

Spacing mandrel body 1094 from magnetic array 52 forms one or more blocks of potting compound radially therebetween. The metallic mandrel 1056 is a better thermal conductor than potting compound. Posts 1098 extend towards magnetic array 52 and provide thermal pathways for heat to move away from magnetic array 52 and towards mandrel 1056. The heat can be transferred through posts 1098 to mandrel body 1094, and from mandrel body 1094 to dissipate the heat outside of motor 12. Mandrel 1056 can thus form a portion of the thermal pathway for cooling the motor while minimizing undesirable inductive heating of mandrel 1056.

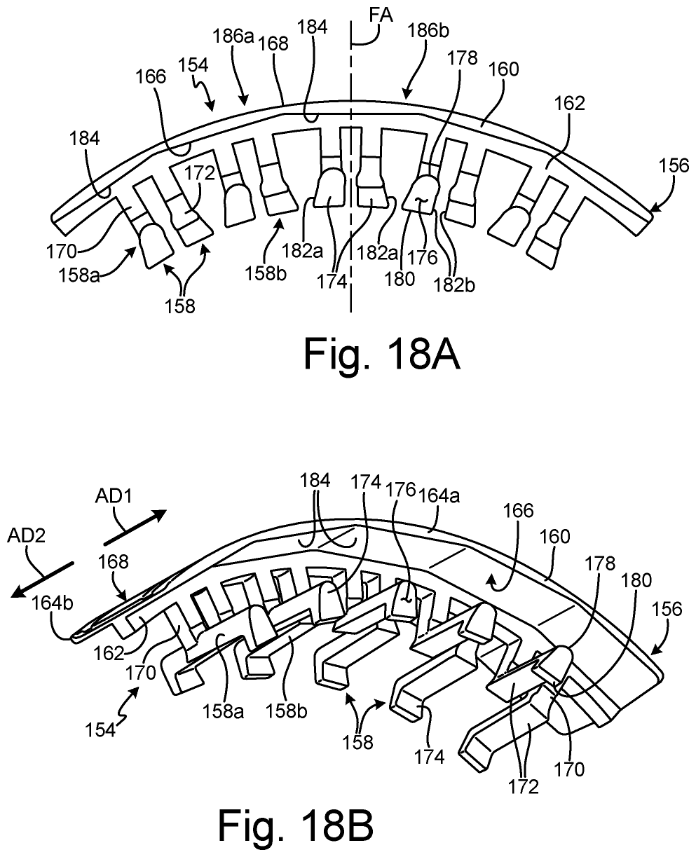

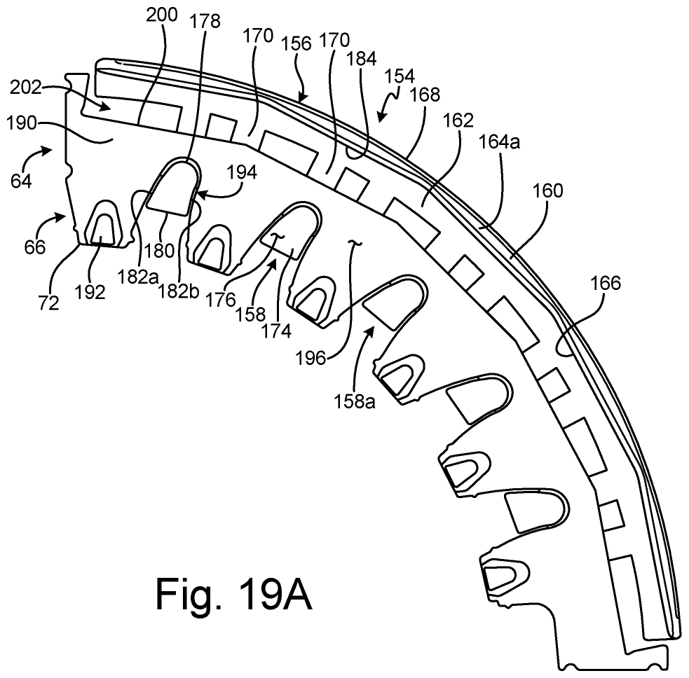

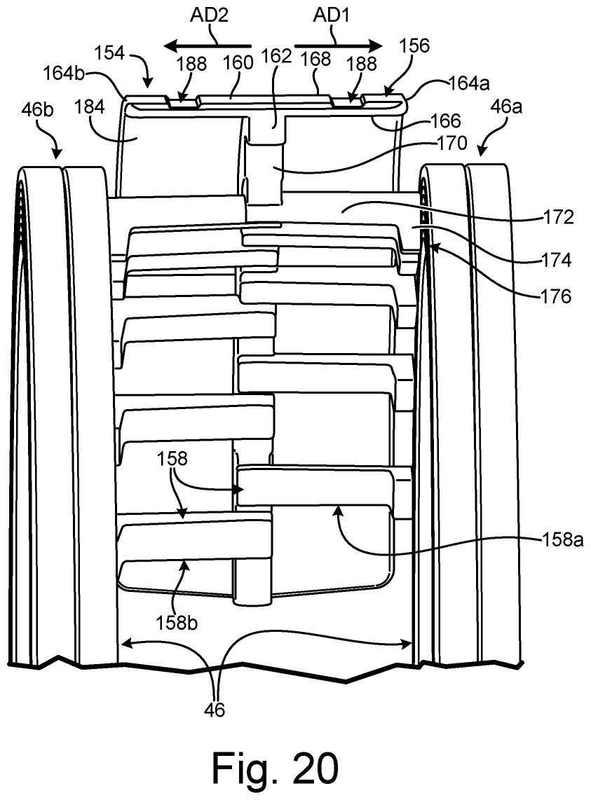

As previously mentioned, heat can be generated and collect within the motor, which risks damaging the internal components. One source of heat generation is resistance in the coils 46 (best seen in FIG. 20). FIGS. 18A-22 discuss thermal cooling of motor 12.

FIG. 18A is an axial end view of heat sink 154. FIG. 18B is an isometric view of heat sink 154. FIGS. 18A and 18B will be discussed together. Heat sink 154 includes dissipator 156 and collectors 158a, 158b (collectively herein “collector 158” or “collectors 158”). Dissipator 156 includes bracket 160 and rail 162. Bracket 160 includes flanges 164a, 164b (collectively herein “flange 164” or “flanges 164”) and has support side 166 and dissipation side 168. Each collector 158 includes support leg 170, free leg 172, and foot 174.

Heat sink 154 is configured to conduct heat away from heat generating components of motor 12 and dissipate the heat to a cooling fluid medium (e.g., liquid or gas (e.g., air in environment that motor 12 is disposed within)). Heat sink 154 can be formed from a thermally conductive material. For example, heat sink 154 can be formed from a metal. For example, the metal can be aluminum, among other options. Heat sink 154 is formed as an arcuate component in the example shown. It is understood that heat sink 154 can be formed to extend annularly about the rotational axis. In some examples, multiple of the heat sinks 154 are circumferentially aligned to form an annular cooling assembly for the motor 12, as discussed in more detail below. Heat sink 154 can be configured as a solid structure and/or with vapor chambers and/or heat pipes. In some examples, heat sink 154 is formed as a monolithic structure. Heat sink 154 can also be referred to as a cooler.

Dissipator 156 is configured to be exposed to the cooling fluid medium. Dissipator 156 can be formed as solid structure or with an internal vapor chamber to facilitate cooling. Dissipator 156 can be exposed on an external surface of the motor 12 to expose dissipator 156 to cooling air. In some examples, dissipator 156 can be disposed within motor housing 16 to transfer heat to motor housing 16. Motor housing 16 is exposed to the cooling air to dissipate heat to the cooling air. Bracket 160 extends circumferentially. Bracket 160 also extends axially away from rail 162. Bracket 160 is configured to be exposed to the cooling fluid medium. Specifically, dissipation side 168 of bracket 160 is configured to be exposed to the cooling fluid medium or to another component that is exposed to a cooling fluid medium. In the example show, dissipation side 168 is an outer radial side of bracket 160, oriented away from the rotor 30, because heat sink 154 is configured for use in an inner rotating motor. It is understood, however, that not all examples are so limited. Support side 166 of bracket 160 is formed as a radially inner side of bracket 160 in the example shown. Flange 164a forms a portion of bracket 160 and extends in first axial direction AD1 relative to rail 162. Flange 164b forms a portion of bracket 160 and extends in second axial direction AD2 relative to rail 162. Flanges 164a, 164b form the portions of bracket 160 that extend axially away from rail 162.

Rail 162 is disposed on support side 166 of bracket 160. Rail 162 extends radially away from bracket 160. Rail 162 extends circumferentially relative to the rotational axis of the rotor. In the example shown, rail 162 extends between the two circumferential ends of bracket 160. Rail 162 extends circumferentially beyond the arcuate array of collectors 158a and circumferentially beyond the arcuate array of collectors 158b. Rail 162 provides structural support to dissipator 156, preventing twisting of bracket 160, and provides a common connector for the collectors 158 to extend from. While heat sink 154 is shown as including rail 162, it is understood that not all examples are so limited. For example, collectors 158 can extend to connect directly to bracket 160.

In the example shown, bracket 160 includes flats 184 formed on support side 166. Flats 184 are formed on each flange 164. Flats 184 are formed in a circumferential array disposed along support side 166. Flats 184 provide locations for flux returns 48 to interface with heat sink 154, as discussed in more detail below. Flats 184 facilitate a more compact motor 12 configuration as the flux returns 48 can be mounted closer to bracket 160 than if support side 166 is rounded.

Collectors 158 extend from dissipator 156. Collectors 158 extend both radially and axially. Collectors 158 can be formed as solid structures that conduct heat away from structure of the stator and towards dissipator 156. Additionally or alternatively, collectors 158 can be formed as heat pipes that conduct heat away from structure of the stator and towards dissipator 156 by phase transition to transfer the heat. For example, one or both of free leg 172 and support leg 170 can be formed as solid structure or as hollow heat pipes.

In the example shown, collectors 158 include support leg 170 that is connected to rail 162 and extends away from rail 162. Support leg 170 extends radially away from rail 162. Support leg 170 is formed as a radial portion of collector 158. It is understood that support leg 170 can extend purely radially or can be canted to extend radially and axially. Support leg 170 is connected to rail 162 such that heat can transfer to rail 162 and then to bracket 160 from support leg 170. Free leg 172 extends from support leg 170. Free leg 172 is formed as an axial portion of collector 158. Free leg 172 extends between a proximal end at the support leg 170 and a terminal end opposite the support leg 170. Foot 174 is formed at the distal end of collector 158 opposite dissipator 156. Foot 174 is formed at the terminal end of free leg 172, opposite the proximal end of free leg 172 interfacing with support leg 170. Foot 174 includes foot face 176 that is oriented axially.

Foot 174 is configured to be disposed adjacent to a heat generating component of motor 12 (e.g., adjacent coil 46). Free leg 172 is configured to route heat axially away from foot 174. Support leg 170 is configured to route the heat radially outwards towards the exterior surface of motor 12. In the example shown, collectors 158 include a 90-degree bend between support leg 170 and free leg 172 that redirects the heat transfer from axial to radial, though it is understood that other interface angles are possible. Rail 162 is configured to receive the heat from the collectors 158 and route the heat to bracket 160. Bracket 160 is configured to dissipate the heat outside of the stator 32 of the motor 12.

Foot 174 projects relative to the body of free leg 172. In the example shown, foot 174 extends radially relative to the body of free leg 172. Specifically, foot 174 extends radially between a heel 178 and a toe 180. The toe 180 is oriented away from bracket 160 and the heel 178 is oriented towards bracket 160. Toe 180 forms a distal end of foot 174 that is spaced radially away from the body of free leg 172.

In the example shown, foot 174 extends circumferentially between foot circumferential sides 182a, 182b. Circumferential side 182a is canted to extend away from circumferential side 182b as foot 174 extends away from the body of free leg 172. The circumferential width of foot 174 increases as foot 174 extends away from the body of free leg 172. In the example shown, circumferential side 182b extends straight, though it is understood that not all examples are so limited. The width between circumferential foot sides 182a, 182b at toe 180 is larger than the width between circumferential foot sides 182a, 182b at heel 178. The increasing width of foot 174 from heel 178 to toe 180 enlarges the surface area of foot face 176, enhancing heat transfer efficiency.

Feet 174 of collectors 158a are canted opposite feet 174 of collectors 158b. Feet 174 of collector 158a are canted in the opposite circumferential direction from feet 174 of collector 158b. The opposite cant configuration of the feet 174 of collectors 158a, 158b facilitates mounting of a single heat sink 154 to dissipate heat from multiple coils 46 of the motor, as discussed in more detail below.

Collectors 158a extend in first axial direction AD1 relative to rail 162. Collectors 158b extend in second axial direction AD2 relative to rail 162. While heat sink 154 is shown as including collectors 158a, 158b that extend in both axial directions AD1, AD2, it is understood that not all examples are so limited. For example, a heat sink 154 can be configured with a single set of collectors 158 (e.g., only collectors 158a or only collectors 158b) that extend in a single axial direction.

Collectors 158a are interspersed with collectors 158b. Collectors 158a, 158b are alternatingly disposed circumferentially along the rail 162. Collectors 158a are axially aligned with circumferential gaps disposed between adjacent ones of collectors 158b. Similarly, collectors 158b are axially aligned with circumferential gaps disposed between adjacent ones of the collectors 158a. In the example shown, collectors 158 are configured such that collectors 158a do not axially overlap with collectors 158b.

Heat sink 154 is rotationally symmetric about flip axis FA. The flip axis FA can be disposed orthogonal to the common axis CA, among other options. Flip axis FA divides heat sink 154 into a first lateral portion 186a and a second lateral portion 186b. Heat sink 154 has two-fold rotational symmetry because rotating heat sink 154 180-degrees about the flip axis FA will place collectors 158b in the positions of collectors 158a shown in FIG. 18A and place collectors 158a in the positions of collectors 158b shown in FIG. 18A. Heat sink 154 can also be referred to as flip aligned because rotating heat sink 154 180-degrees about flip axis will place collectors 158b in the positions of collectors 158a and place collectors 158a in the positions of collectors 158b. The flip aligned configuration of heat sink 154 allows heat sink 154 to be mounted to the motor with collectors 158a facing in either axial direction. The flip aligned configuration thus provides mistake proofing in that heat sink 154 can be mounted with collectors 158a extending in either axial direction.

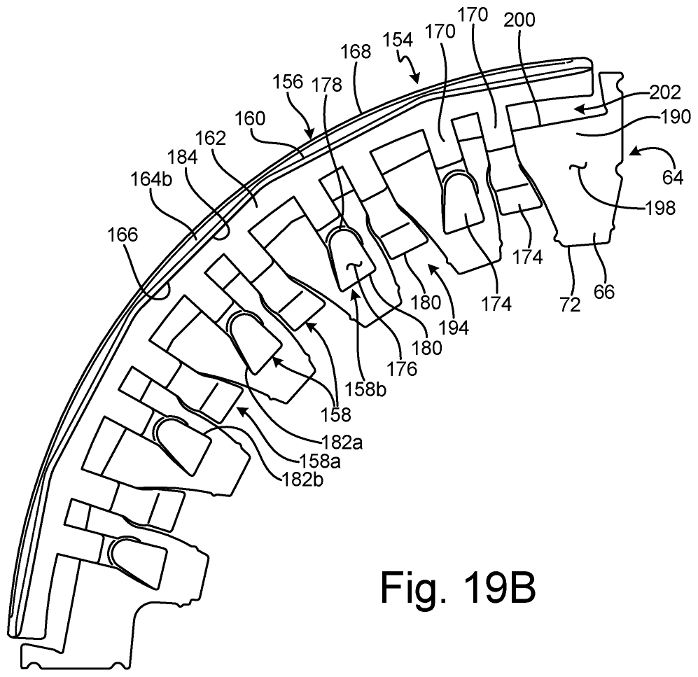

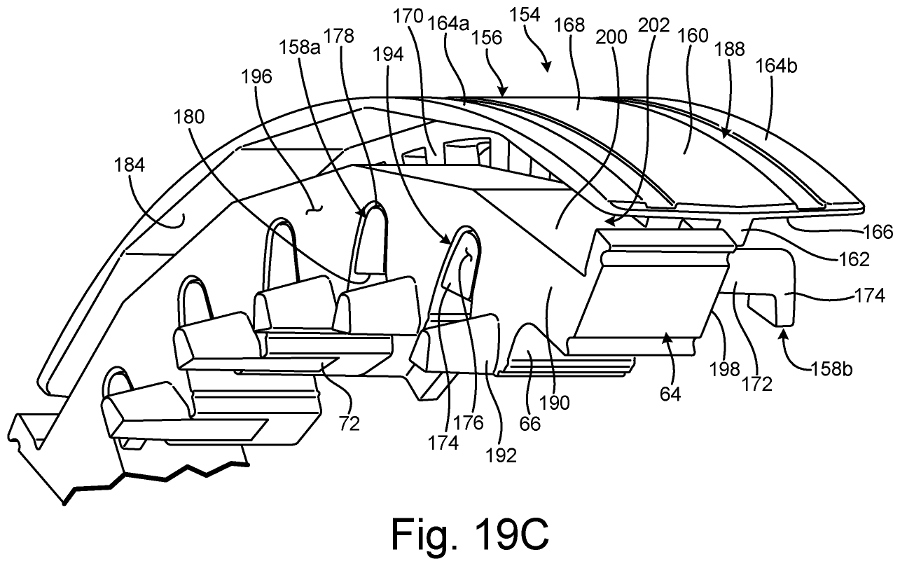

FIG. 19A is a first axial end view showing heat sink 154 disposed relative to a ring segment 64 of a flux ring 44. FIG. 19B is a second axial end view, taken opposite the first axial end view in FIG. 19A, showing heat sink 154 disposed relative to the ring segment 64 of the flux ring 44. FIG. 19C is an isometric view showing heat sink 154 disposed relative to the ring segment 64 of the flux ring 44. FIGS. 19A-19C will be discussed together. Heat sink 154 includes dissipator 156 and collectors 158a, 158b (collectively herein “collector 158” or “collectors 158”). Dissipator 156 includes bracket 160 and rail 162. Bracket 160 includes flanges 164a, 164b (collectively herein “flange 164” or “flanges 164”) and has support side 166 and dissipation side 168. Each collector 158 includes support leg 170, free leg 172, and foot 174. Ring segment 64 includes spurs 66, segment body 190, teeth 192, and troughs 194.

Ring segment 64 forms a portion of a flux ring 44. Multiple of the arcuate ring segments 64 are configured to form the flux ring 44. Spurs 66 extend away from segment body 190. Spurs 66 extend away from segment body 190 and towards the rotor 30. Troughs 194 are disposed circumferentially between adjacent ones of the spurs 66. Teeth 192 are supported by spurs 66. Teeth 192 project axially from spurs 66. Teeth 192 are configured to project to radially overlap with a coil 46. Segment body 190 extends between an axially oriented facing side 196 and an axially oriented away side 198. The facing side 196 is configured to face the coil 46 of the stator phase 42 that the ring segment 64 forms a portion of. The away side 198 is oriented axially away from the coil 46 of the stator phase 42 that the ring segment 64 forms a portion of. While heat sink 154 is shown disposed relative to a ring segment 64 of a flux ring 44, it is understood that heat sink 154 can be utilized with a flux ring 44 of any configuration, whether formed from arcuate ring segments 64 or as an annular ring structure. Further, while flux ring 44 is described as including projecting teeth 192, it is understood that flux ring 44 can be configured with spurs 66 that do not include axially extending teeth 192.

Heat sink 154 is disposed relative to ring segment 64. Heat sink 154 is configured to be fixed relative to ring segment 64 by potting compound. Heat sink 154 is a static component of motor 12 disposed within the stator 32. Dissipator 156 is spaced radially away from ring segment 64. Dissipator 156 is disposed on an opposite radial side of ring segment 64 from spurs 66. Dissipator 156 is thus disposed on an opposite radial side of the flux ring 44 from the rotor 30.

Bracket 160 of dissipator 156 extends axially outward from rail 162. Bracket 160 extends to radially overlap with at least a portion of ring segment 64. Bracket 160 is positioned such that at least some, up to all, of the lamina forming ring segment 64 are disposed to radially overlap with bracket 160. The laminas of ring segment 64 are disposed to radially overlap with bracket 160 and the air gap between rotor 30 and stator 32 and are disposed radially between bracket 160 and the air gap 60. Dissipator grooves 188 are formed on dissipation side 168 of bracket 160 in the example shown. Dissipator grooves 188 increase a surface area of dissipation side 168, enhancing thermal transfer and cooling. Dissipator grooves 188 can, in some examples, interfaces with other components of motor 12, such as projections from the motor housing 16, to axially locate heat sink 154 relative to motor housing 16, such as for during the potting process.

Flats 184 on bracket 160 are aligned with return faces 200 formed on the outer radial side of ring segment 64. In the example shown, each flat 184 opposes a single return face 200. The opposed ones of flats 184 and return faces 200 form return slots 202 that are configured to receive a portion of a flux return 48 of the stator phase 42. Each return slot 202 is configured to receive a single flux return 48, in the example shown, though it is understood that not all examples are so limited. With a flux return 48 disposed in the return slot 202, the dissipator 156 is disposed to radially overlap with the laminas of the flux return 48 and the laminas of the ring segment 64. Dissipator 156 is disposed to radially overlap with the axially oriented laminas of the flux return 48 and to radially overlap with the radially oriented laminas of the ring segment 64. Rail 162 can provide axial backing support to the flux returns 48 in the return slots 202. Rail 162 prevents axial movement of flux returns 48, positioning flux returns 48 in desired locations for the potting process.

Collectors 158 are configured to extend into troughs 194. In the example shown, collectors 158a extend into the troughs 194. Collectors 158b can extend into the troughs 194 of another flux ring 44 of a different stator phase 42, as discussed in more detail below. Collectors 158a extend to radially overlap with flux ring 44. Collectors 158a extend to radially overlap with the laminas forming the flux ring 44. More specifically, the free legs 172 of collectors 158a extend into the troughs 194. Free legs 172 extend axially into the troughs 194 through the opening of the trough 194 that is formed in the away side 198 of flux ring 44. Collectors 158 are recessed radially away from the radial faces 72. No portion of heat sink 154 extends into the air gap between rotor 30 and stator 32. Recessing heat sink 154 from radial faces 72 inhibits formation of eddy currents in the magnetic flux.

With free legs 172 disposed in troughs 194, at least a portion of ring segment 64 is radially bracketed between portions of heat sink 154. In the example shown, portions of ring segment 64 are disposed radially between and radially overlap with collectors 158a and dissipator 156. The portions of ring segment 64 radially overlap with collector 158a and flange 164a of bracket 160. In the inner rotator example shown, a radial line extending from the rotational axis passes through rotor 30 and magnetic array 52, then through collector 158a, then through the flux ring 44, and then through bracket 160. The lamina material of ring segment 64 is disposed radially between the thermally conductive collector 158 and the thermally conductive dissipator 156. Heat sink 154 thereby provides a thermal path between the two radial sides of flux ring 44. In the example shown, heat sink 154 provides a thermal path from a radially inner side of flux ring 44 to a radially outer side of flux ring 44.

Feet 174 of collectors 158a are at least partially disposed within troughs 194. Feet 174 are disposed within troughs 194 such that feet 174 do not axially overlap with the ring segment 64. Foot face 176 is oriented axially out of trough 194. Foot face 176 of collector 158a does not axially overlap with the material forming the flux ring 44. Foot face 176 is configured to be oriented towards a coil 46. In the example shown, feet 174 of collector 158a are recessed within trough 194. Feet 174 are recessed from facing side 196 such that a gap is formed axially between facing side 196 and foot face 176. Recessing feet faces 176 relative to facing side 196 allows flux ring 44 to be disposed as close to the coil 46 as possible, providing efficient motor 12 operation. It is understood, however, that not all examples include recessed feet 174. In some examples, the foot face 176 is aligned with facing side 196 such that foot face 176 is not recessed within trough 194 and does not extend axially outside of trough 194.

The toe 180 of foot 174 is disposed within trough 194 and spaced radially from the radial faces 72 of the spurs 66. As such, foot 174 can be considered to be radially recessed within trough 194. Foot 174 being radially recessed within trough 194 spaces foot 174 from the magnetic array 52 and the air gap 60 in which the magnetic flux interacts. Spacing foot 174 away from air gap 60 inhibits inductive heating of heat sink 154, providing more efficient cooling to the heat generating components of motor 12.

While collectors 158a extend to radially overlap with the flux ring 44 shown, collectors 158b extend axially away from the flux ring 44 that collectors 158a radially overlap with. Collectors 158b are configured to extend into the troughs of a flux ring of a phase assembly adjacent to the phase assembly that collectors 158a are associated with.

Collectors 158b are axially aligned with the material forming the flux ring 44 that collectors 158a radially overlap with. Collectors 158b axially overlap with the laminas of the flux ring 44 that collectors 158a radially overlap with. In the example shown, feet 174 of collectors 158b are fully axially covered by ring segment 64 such that no portion of the feet 174 of collectors 158b extends outward beyond the material of ring segment 64. Feet 174 of collectors 158b axially overlap with spurs 66. Free legs 172 of collectors 158b axially overlap with the spurs 66.

Heat sink 154 is configured to transmit the heat generated by one or more coils 46 to outside of the stator 32 for dissipation to the cooling medium. Heat sink 154 wraps around the metallic structure of flux ring 44 such that heat sink 154 can absorb heat from the metallic flux ring 44 in addition to absorbing heat generated by coil 46. The portion of free leg 172 disposed within trough 194 is surrounded on three sides by the metallic structure of flux ring 44. Spurs 66 are disposed on both circumferential sides of the free legs 172. Segment body 190 is disposed on one radial side of free leg 172 while the other radial side of free leg 172 is oriented towards rotor 30. The radial side of free leg 172 oriented towards rotor 30 may be uncovered by any material of the flux ring 44, though it is understood that not all examples are so limited.

FIG. 20 is an isometric view showing heat sink 154 disposed relative to coils 46a, 46b (collectively herein “coil 46” or “coils 46”). As shown, heat sink 154 is formed as an arcuate structure that extends partially about the rotational axis. While a single arcuate heat sink 154 is shown, it is understood that multiple arcuate heat sinks 154 can be disposed relative to a single coil 46 to provide cooling to that coil 46. For examples, two, three, four, five, or more arcuate heat sinks 154 can form an annular array of collectors 158 associated with a coil 46.

As shown, collectors 158a extend in first axial direction AD1 towards coil 46a while collectors 158b extend in second axial direction AD2 towards coil 46b. Collectors 158a extend further in first axial direction AD1 than dissipator 156 extends in first axial direction AD1. Collectors 158b extend further in second axial direction AD2 than dissipator 156 extends in second axial direction AD2. In the example shown, no portion of heat sink 154 extends to radially overlap with either coil 46a, 46b, though it is understood that not all examples are so limited. For example, bracket 160 could extend axially further than collectors 158a, 158b such that bracket 160 radially overlap with one or both of coils 46a, 46bb.

Collectors 158a, 158b extend from rail 162. Specifically, support legs 170 extend radially away from rail 162 and radially away from dissipator 156. Support legs 170 extend to axially overlap with coils 46a, 46bb. Free legs 172 project axially from support legs 170. Free legs 172 of collectors 158a extend axially towards coil 46a and axially away from coil 46b. Feet 174 of collectors 158a are disposed proximate coil 46a. Free legs 172 of collectors 158b extend axially towards coil 46b and axially away from coil 46a. Feet 174 of collectors 158b are disposed proximate coil 46b. Feet 174 are spaced axially from the conductive material of coils 46a, 46bb. It is understood that, in some examples, feet 174 can be in contact with non-conductive material of coils 46a, 46bb, (e.g., in contact with insulating material of coil 46 that surrounds the conductive material of coil 46). In some examples, feet 174 can be spaced from and not in contact with any material of coil 46.

Feet 174 are disposed such that foot faces 176 (best seen in FIGS. 19A-19C) directly oppose coils 46a, 46b. More specifically, foot faces 176 of collectors 158a directly oppose coil 46a and foot faces 176 of collectors 158b directly oppose coil 46b. Foot faces 176 directly oppose the coil 46 by axially overlapping with the coil 46 and being positioned such that no other components of motor 12, other than potting compound, are disposed between the foot faces 176 and coil 46a, 46bb. no metallic structure of motor 12 is disposed directly between the directly opposed foot 174 and coil 46. Foot faces 176 directly opposing the coil 46 facilitates efficient heat transfer to heat sink 154 by exposing the enlarged surface area of foot face 176 directly to coil 46 without intervening structure.

Heat sink 154 is disposed axially between the two coils 46, in the example shown. In the example shown, the entirety of heat sink 154 is disposed axially between the coils 46, while only a portion of heat sink 154 axially overlaps with the coils 46. As discussed above, coils 46 of a transverse flux electric machine extend annularly around the rotational axis of the rotor 30. Foot faces 176 of collector 158a form an arcuate array of heat collection zones adjacent to the coil 46a. Heat generated by coil 46a is transferred to foot faces 176 of collectors 158a, transmitted through free legs 172 and support arms 170 of collectors 158a to dissipator 156 for dissipation outside of the stator 32. Foot faces 176 of collector 158b form an arcuate array of heat collection zones adjacent to the coil 46b. Heat generated by coil 46b is transferred to foot faces 176 of collectors 158b, transmitted through free legs 172 and support arms 170 of collectors 158b to dissipator 156 for dissipation outside of the motor. More specifically, support arms 170 of both collectors 158a and collectors 158b extend to and are connected to the rail 162, which then transmits heat to the bracket 160. As shown, support arms 170 of collectors 158a circumferentially overlap with support arms 170 of collectors 158b. It is understood, however, that not all examples are so limited. The arrays of heat collection zones formed by collectors 158a, 158b have a smaller surface area than the surface area of bracket 160. The larger surface area of bracket 160 relative to the heat collection zones facilitates efficient heat dissipation from heat sink 154.

Foot faces 176 are radially enlarged relative to the radial height of the free leg 172 that the foot 174 extends from. The foot faces 176 axially overlap with multiple of the loops forming the coil 46 that directly opposes that foot face 176. In some examples, the foot faces 176 can axially overlap with each loop of the coil 46. Configuring foot faces 176 to axially overlap with multiple, up to all, of the loops of the coil 46 positions foot 174 to directly opposite the multiple loops and provides a short pathway for heat to enter into foot 174, facilitating efficient cooling by heat sink 154.

While a single heat sink 154 is shown as operatively associated with multiple coils 46a, 46bb, it is understood that not all examples are so configured. For example, a single heat sink 154 can be associated with a single coil 46. In such an example, the heat sink 154 may include only a single array of collectors 158 that extends in a single axial direction towards the associated coil 46 (e.g., only collectors 158a extending towards coil 46a). It is understood that such a heat sink 154 can include a bracket 160 extending in one or both axial directions.

Heat sink 154 provides significant advantages. Feet 174 directly oppose the coil 46a, 46bb that that foot 174 is operatively associated with. The feet 174 are disposed proximate to the coil 46a, 46bb and axially overlap with the coil 46a, 46bb, providing efficient heat transfer to heat sink 154, thus efficiently cooling motor 12. Heat sink 154 can be positioned between multiple coils 46a, 46bb such that a single heat sink 154 provides cooling to multiple of the coils 46a, 46bb of a motor. Foot faces 176 provide an array of heat collection zones for the coil 46a, 46bb to absorb heat from circumferentially around the coil 46a, 46bb. The foot faces 176 can axially overlap with multiple of the loops forming the coil 46a, 46bb that directly opposes that foot face 176 to provide short thermal pathways to heat sink 154 from coil 46a, 46bb, facilitating efficient cooling.

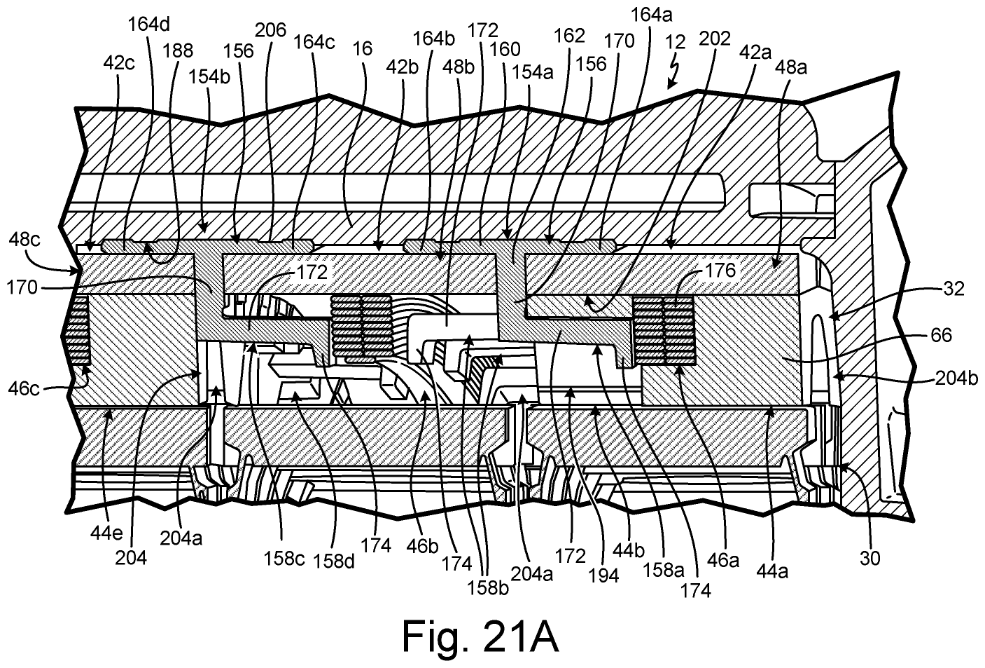

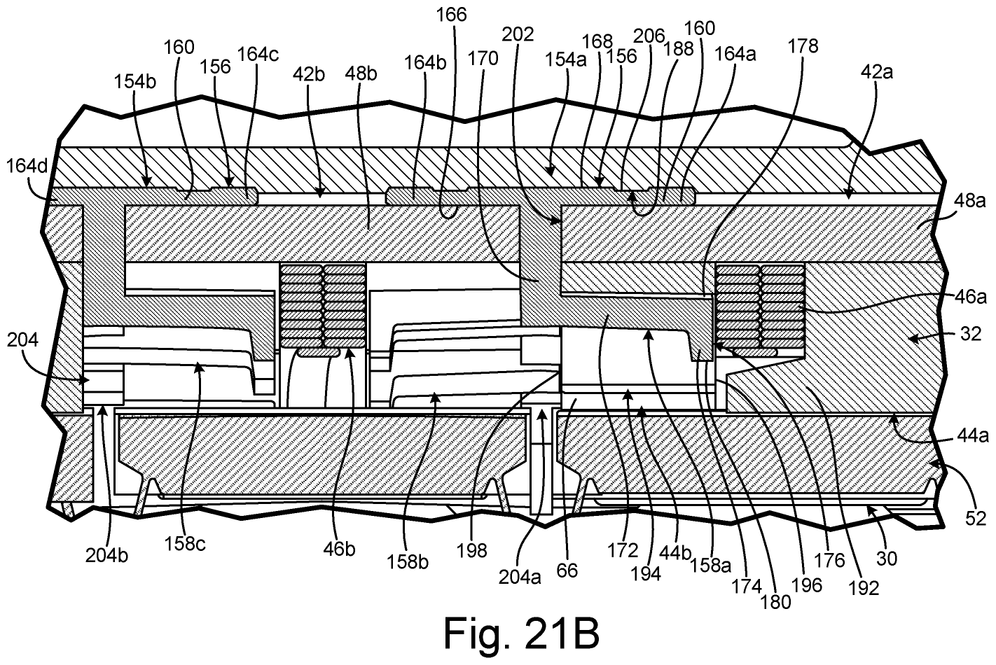

FIG. 21A is a partial isometric cross-sectional view of a motor 12. FIG. 21B is a partial elevational cross-sectional view of the motor 12. FIGS. 21A and 21B will be discussed together. Motor housing 16; rotor 30; stator 32; and heat sinks 154a, 154b (collectively herein “heat sink 154” or “heat sinks 154”) of motor 12 are shown. Stator 32 includes stator phases 42a-42c (collectively herein “stator phase 42” or “stator phases 42”). Flux rings 44a, 44b, coil 46a, and flux returns 48a of stator phase 42a are shown. Coil 46b and flux returns 48b of stator phase 42b are shown. Flux ring 44e, coil 46c, and flux returns 48c of stator phase 42c are shown. Flux rings 44a-44f are referred to collectively herein as “flux ring 44” or “flux rings 44”. Coils 46a-46c are referred to collectively herein as “coil 46” or “coils 46.” Flux returns 48a-48c are referred to collectively herein as “flux return 48” or “flux returns 48.”

Heat sink 154a includes collectors 158a, 158b (collectively herein “collector 158 of heat sink 154a” or “collectors 158 of heat sink 154a”) and dissipator 156. Dissipator 156 includes bracket 160 and rail 162. Bracket 160 of heat sink 154a includes flanges 164a, 164b and has support side 166 and dissipation side 168.

Heat sink 154b includes collectors 158c, 158d (collectively herein “collector 158 of heat sink 154b” or “collectors 158 of heat sink 154b”) and dissipator 156. Dissipator 156 includes bracket 160 and rail 162. Bracket 160 of heat sink 154b includes flanges 164c, 164d and has support side 166 and dissipation side 168.

Collectors 158a-158d can be collectively referred to herein as “collectors 158” or “collector 158”. Each collector 158a-158d includes support leg 170, free leg 172, and foot 174.

Heat sinks 154 are disposed at least partially within stator 32 of motor 12. Heat sink 154a can be configured identically to heat sink 154b. Heat sinks 154 extend from locations within stator 32 to an exterior of stator 32. Heat sinks 154 are configured to conduct heat to the exterior of stator 32 for dissipation, providing cooling to motor 12. In the example shown, heat sinks 154 extend to locations radially between stator and motor housing 16. Motor housing 16 can be formed form a thermally conductive material (e.g., metal (e.g., aluminum)). Heat sinks 154 can be in contact with or close proximity to motor housing 16 to transfer heat to the cooling fluid medium through motor housing 16, such as to the air surrounding motor housing 16. It is understood that, in some examples, heat sinks 154 are directly exposed to the cooling fluid medium. For example, bracket 160a of heat sink 154a can form a portion of the motor housing 16 that is exposed to cooling air.

As discussed in more detail above, stator 32 includes multiple stator phases 42 that are arrayed along the common axis CA of the motor 12. The stator phases 42 are spaced axially along the common axis CA. The coils 46 of each stator phase 42 are arrayed along the axis. The coils 46 extend circumferentially about the axis CA and not radially or axially. The flux rings 44 are arrayed along the axis. Each coil 46 is disposed between a pair of flux rings 44. The coils 46 extend entirely around the axis of rotation of the rotor 30 (and the common axis CA). Each coil 46 is a circular loop of electrically conductive material. The axis of rotation of the rotor 30 (and the common axis CA) extends through each loop (e.g., the center of each loop). Each coil 46 is annular, and the loops of each coil 46 are likewise annular, and the circular planar profile of the coil 46 and loops are orthogonal to the common axis CA.

Flux returns 48 extend between the opposed flux rings 44 of a single stator phase 42. The flux returns 48 bridge between the flux rings 44 and extend over the coil 46 of the stator phase 42 such that the flux returns 48 radially overlap with the coil 46 of that stator phase 42. Flux returns 48 are disposed on an opposite radial side of the coil 46 from rotor 30.

Stator phases 42 are arrayed along the axis such that phase gaps 204 are disposed axially adjacent to each stator phase 42. The phase gaps 204 can be formed as interphase gaps 204a that are disposed axially between adjacent stator phases 42. The phase gaps 204 can be formed as end phase gaps 204b that are disposed adjacent to a single stator phase 42. In the example shown, stator 32 includes two interphase gaps 204a formed between the stator phases 42. The first interphase gap 204a is formed between stator phase 42a and stator phase 42b. More specifically, the first interphase gap 204a is formed between flux ring 44b of stator phase 42a and flux ring 44c (FIG. 2) of stator phase 42b. The second interphase gap 204a is formed between stator phase 42c and stator phase 42b. More specifically, the second interphase gap 204a is formed between flux ring 44d (FIG. 2) of stator phase 42b and flux ring 44e of stator phase 42c. Stator 32 includes one less interphase gap 204a than number of stator phases 42, regardless of the number of stator phases 42. Stator 32 can include two end phase gaps 204b. End phase gaps 204b are disposed adjacent to the axially outermost stator phases 42.

Interphase gaps 204a axially separate the stator phases 42 from each other. Interphase gaps 204a are not bridged by any laminate structure of stator 32. Interphase gaps 204a are not bridged by any coil 46 of stator 32. No coil 46 extends to radially overlap with any phase gap 204 of stator 32.

Heat sinks 154 are disposed to route heat from the interior of stator 32 to the exterior of stator 32. In the example shown, stator 32 includes heat sinks 154 disposed in interphase gaps 204a. No heat sinks 154 are disposed in the end phase gaps 204b, though it is understood that not all examples are so limited. Heat sinks 154 extend between locations radially outside of the laminate structure of stator 32 and locations radially within the laminate structure of stator 32. Specifically, heat sinks 154 extend from radially beyond flux returns 48, into interphase gap 204a, and to radially inward of the metallic structure of a flux ring 44.

Heat sinks 154 include dissipators 156 disposed on an opposite radial side of stator 32 from rotor 30. Bracket 160 of dissipator 156 projects axially over flux returns 48. Bracket 160 extends such that bracket 160 radially overlaps with flux returns 48. A single bracket 160 can radially overlap with multiple flux returns 48 of the array of flux returns 48. A single bracket 160 can interface with flux returns 48 of multiple arrays of flux returns 48. In the example shown, bracket 160a of heat sink 154a radially overlaps flux returns 48a and flux returns 48b. Support side 166 of bracket 160 is oriented radially towards rotor 30. Flux returns 48 can interface with support side 166. Flux returns 48 are at least partially disposed within return slots 202 formed radially between bracket 160 and flux rings 44.

For each heat sink 154, bracket 160 is disposed radially beyond stator phases 42. Bracket 160 extends over at least one stator phase 42 such that each laminate portion of that stator phase 42 is disposed on one radial side of bracket 160. In the example shown, bracket 160 is disposed radially between motor housing 16 and stator phases 42. In the example shown, bracket 160 is formed within motor housing 16 and interfaces with an inner radial side of motor housing 16. Bracket 160 can directly interface with motor housing 16. The dissipation side 168 of bracket 160 is oriented towards motor housing 16 and can interface with motor housing 16. Heat can be transferred from dissipator 156 to motor housing 16 to be dissipated to the cooling fluid medium from motor housing 16. It is understood that, in some examples, dissipation side 168 can be exposed directly to the cooling fluid medium. For example, the dissipation side 168 can from a portion of the exterior of motor 12, among other options.

In the example shown, dissipator grooves 188 are formed in the surface forming dissipation side 168 of bracket 160. Dissipator grooves 188 extend circumferentially along the dissipation side 168. Dissipator grooves 188 are configured to receive housing projections 206 extending from motor housing 16. The housing projections 206 extending into dissipator grooves 188 axially fixes heat sinks 154 relative to motor housing 16. Fixing heat sink 154 relative to motor housing 16 ensures proper alignment during the potting process, preventing misalignment, decreasing costs, and decreasing manufacturing defect. In addition, the interface between dissipator grooves 188 and housing projections 206 increases the surface area interfacing between heat sink 154 and motor housing 16, further enhancing heat transfer.

Flange 164a projects in first axial direction AD1 to radially overlap with flux returns 48a of a first stator phase 42a. Flange 164b projects in second axial direction AD2 to radially overlap with flux returns 48b of a second stator phase 42b. As such, heat sink 154a radially overlaps with laminate structure of multiple stator phases 42a, 42b of stator 32. In the example shown, flanges 164a, 164b do not radially overlap with any coil 46 of stator 32. The distal axial end of flange 164a is disposed at a location spaced axially from coil 46a and axially between coil 46a and coil 46b. The distal axial end of flange 164b is disposed at a location spaced axially from coil 46b and axially between coil 46a and coil 46b.

Similar to flanges 164a, 164b of heat sink 154a, flanges 164c, 164d of heat sink 154b project to radially overlap with multiple stator phases 42b, 42c. Flange 164c projects in first axial direction AD1 to radially overlap with flux returns 48b of a first stator phase 42b. Flange 164c projects in second axial direction AD2 to radially overlap with flux returns 48c of a second stator phase 42c. As such, heat sink 154b radially overlaps with laminate structure of multiple stator phases 42b, 42c of stator 32. In the example shown, flanges 164c, 164d do not radially overlap with any coil 46 of stator 32. The distal axial end of flange 164c is disposed at a location spaced axially from coil 46b and axially between coil 46b and coil 46c. The distal axial end of flange 164d is disposed at a location spaced axially from coil 46c and axially between coil 46c and coil 46b.

Rails 162 of heat sinks 154a, 154b extend into interphase gaps 204a. Rails 162 are disposed axially between flux returns 48 of adjacent ones of the stator phases 42. In the example shown, rail 162a extends into the interphase gap 204a between stator phases 42a, 42b. Rail 162a is disposed axially between flux returns 48a and flux returns 48b. Rail 162a is disposed to axially overlap with both flux returns 48a and flux returns 48b. With flux returns 48a, 48b in the return slots 202 of heat sink 154a, rail 162a is axially bracketed between flux returns 48a and flux returns 48b. Rail 162b extends into the interphase gap 204a between stator phases 42b, 42c. Rail 162b is disposed axially between flux returns 48b and flux returns 48c. Rail 162b is disposed to axially overlap with both flux returns 48b and flux returns 48c. With flux returns 48b, 48c in the return slots 202 of heat sink 154b, rail 162b is axially bracketed between flux returns 48b and flux returns 48c.

For each heat sink 154, support legs 170 extends from dissipator 156 and radially within interphase gap 204a. Support legs 170 extend to locations radially between flux returns 48 and rotor 30. Support legs 170 extend to axially overlap with flux rings 44. Support legs 170 are disposed axially between a flux ring 44 of a first stator phase 42 and a flux ring 44 of the adjacent second stator phase 42. Support legs 170 do not radially overlap with the laminas of a stator phase 42. In the example shown, support legs 170 of heat sink 154a extend such that the support legs 170 are disposed axially between flux ring 44b and flux ring 44c. In the example shown, support legs 170 of heat sink 154b extend such that the support legs 170 are disposed axially between flux ring 44d and flux ring 44e.

For each heat sink 154, the free legs 172 extend from support legs 170. Free legs 172 extend axially from support legs 170. In the example shown, free legs 172 are disposed orthogonal to support legs 170. Collectors 158 can thus include a 90-degree bend that redirects the heat from being routed axially within stator 32 to being routed radially out of stator 32. It is understood, however, that free legs 172 can extend at any desired angle from support legs 170 such that free legs 172 extend towards a coil 46.

Free legs 172 extend from the interphase gap 204a and into the troughs 194 formed between adjacent spurs 66 of a flux ring 44. Free legs 172 are disposed within the troughs 194 such that each of free leg 172, flux ring 44, flux return 48, and bracket 160 radially overlap each other. As shown, laminas of a flux ring 44 and a flux return 48 can be radially bracketed between a free leg 172 and bracket 160.

As shown, heat sinks 154 include free legs 172 that extend in opposite axial directions relative to each other. Free legs 172 of collectors 158a extend in first axial direction AD1 into the troughs 194 of flux ring 44b. Free legs 172 of collectors 158b extend in second axial direction AD2 into the troughs 194 of flux ring 44c. The troughs 194 of flux ring 44b are circumferentially offset from troughs 194 of flux ring 44c. Free legs 172 of collector 158a are circumferentially offset from free legs 172 of collector 158b to facilitate those free legs 172 extending into the offset troughs 194. Similarly, free legs 172 of collectors 158c extend in first axial direction AD1 into the troughs 194 of flux ring 44d. Free legs 172 of collectors 158d extend in second axial direction AD2 into the troughs 194 of flux ring 44e. In the example shown, stator phases 42 are axially aligned to facilitate driving offset magnet phases 58. The free legs 172 of heat sink 154a are axially aligned with the free legs 172 of heat sink 154b that extend in the same axial direction. In the example shown, free legs 172 of collectors 158a are axially aligned and axially overlap with free legs 172 of collectors 158c. Similarly, free legs 172b of collectors 158b are axially aligned with and axially overlap with free legs 172 of collectors 158d.

Free legs 172 extending into troughs 194 positions the portion of free leg 172 disposed within trough 194 is surrounded on three sides by the metallic structure of flux ring 44. That portion of the collector 158 is thus positioned to absorb heat from the flux ring 44 itself, further enhancing cooling of motor 12.

Free legs 172 extending into troughs 194 facilitates alignment between stator phases 42 during assembly of stator 32. Collectors 158a extend into the troughs 194 of flux ring 44b and collectors 158b extend into the troughs 194 of flux ring 44c. Collectors 158a, 158b are fixed relative to each other by both being part of the same unitary structure of heat sink 154. Collectors 158a, 158b can thereby circumferentially fix flux ring 44b relative to flux ring 44c, which fixes stator phase 42a circumferentially relative to stator phase 42b, providing the desired alignment for potting the stator 32.

Bracket 160 also facilitates alignment between stator phases 42 during assembly of motor 12. Bracket 160 of heat sink 154a interfaces with flux returns 48a and flux returns 48b. The flux returns 48a, 48b extend into return slots 202 at least partially defined by the bracket 160. The flux returns 48a, 48b interface with the flats 184 formed on the support side 166, which prevents relative circumferential movement between flux returns 48 and bracket 160 during the potting process, ensuring desired alignment.

Feet 174 are disposed at the end of free legs 172 opposite support legs 170. Feet 174 can be considered to be disposed at the terminal ends of the free legs 172, opposite the proximal ends of the free legs 172 that are connected to support legs 170. Feet 174 are radially enlarged relative to the body of free legs 172. Feet 174 directly oppose the coil 46 that is adjacent to that foot 174. The foot 174 and coil 46 can be considered to be directly opposing each other when there is no structure, other than potting compound, disposed between the two directly opposed components. In the example shown, no structure, other than potting compound, is disposed in the axial gap formed between foot 174 and coil 46. No metallic structure of stator 32 is disposed axially between foot face 176 and the directly opposed coil 46. Foot 174 directly opposing coil 46 facilitates efficient heat transfer to heat sink 154 from coil 46 as the heat is not routed through or absorbed by other components disposed between heat sink 154 and coil 46.

Each foot 174 includes a foot face 176 that is oriented axially towards a coil 46. Foot face 176 can be formed as a planar surface oriented axially towards the coil 46. Foot face 176 axially overlaps with the directly opposed coil 46. Foot face 176 can axially overlaps with a majority of the radial height of the coil 46, which provides efficient cooling by providing a short thermal path between coil 46 and foot face 176.

Some of the heat generated by coil 46 can be absorbed by the metallic structure of flux rings 44 and flux returns 48. Free legs 172 are disposed within troughs 194 such that free legs 172 circumferentially and radially overlap with the metallic structure of flux ring 44. Such a configuration facilities heat transfer from flux ring 44 to heat sink 154. Support leg 170 is disposed adjacent to flux ring 44 within interphase gap 204a, further facilitating heat transfer to heat sink 154 from flux ring 44. Support leg 170, rail 162, and bracket 160 are each disposed adjacent to the metallic structure of flux return 48, facilitating efficient heat transfer from flux return 48 to heat sink 154. Bracket 160 can interface with flux returns 48 to provide direct thermal transfer pathway from flux return 48 to bracket 160.

Each stator phase 42 is operatively associated with at least one heat sink 154. In the example shown, stator phases 42a, 42c are operatively associated with a single one of heat sinks 154. Specifically, stator phase 42a is operatively associated with heat sink 154a and stator phase 42c is operatively associated with heat sink 154b. Stator phase 42b is operatively associated with both heat sink 154a and heat sink 154b. As such, both heat sinks 154a, 154b work to dissipate heat generated by stator phase 42b. Each heat sink 154 is operatively associated with at least one stator phase 42. In the example shown, both of heat sinks 154a, 154b are operatively associated with multiple (two in the example shown) stator phases 42.

Heat sink 154a is at least partially disposed in the interphase gap 204a between stator phase 42a and stator phase 42b. Collectors 158a of heat sink 154a extend radially within the interphase gap 204a and then into the troughs 194 of flux ring 44b. Collectors 158a of heat sink 154a extend axially from the interphase gap 204a between stator phases 42a, 42b to directly oppose coil 46a of stator phase 42a. Collectors 158b of heat sink 154a extend radially within the interphase gap 204a between stator phases 42a, 42b and then into the troughs 194 of flux ring 44c. Collectors 158b of heat sink 154a extend axially from the interphase gap 204a between stator phases 42a, 42b to directly oppose coil 46b of stator phase 42b.

Similar to heat sink 154a, heat sink 154b is at least partially disposed in an interphase gap 204a. Heat sink 154b is at least partially disposed in the interphase gap 204a between stator phase 42a and stator phase 42b. Collectors 158c of heat sink 154b extend radially within the interphase gap 204a and then into the troughs 194 of flux ring 44d. Collectors 158c of heat sink 154b extend axially from the interphase gap 204a between stator phases 42c, 42b to directly oppose coil 46b of stator phase 42b. Collectors 158d of heat sink 154b extend radially within the interphase gap 204a between stator phases 42b, 42c and then into the troughs 194 of flux ring 44e. Collectors 158d of heat sink 154b extend axially from the interphase gap 204a between stator phases 42c, 42b to directly oppose coil 46c of stator phase 42c.

Stator phase 42b is an intermediate phase of the stator 32. A greater among of heat is experienced proximate stator phase 42b than stator phases 42a, 42c, which form end phases of the stator 32. Stator phase 42b is operatively associated with multiple heat sinks 154 disposed on opposite axial sides of stator phase 42b. Each of the multiple heat sinks 154 wicks heat from stator phase 42b to provide enhanced cooling at the intermediate phase of stator 32.

In the example shown, coil 46b is axially bracketed by free legs 172 of collectors 158b and collectors 158c. Free legs 172 of collectors 158b are circumferentially offset from free legs 172 of collectors 158c. Collectors 158b are circumferentially offset from collectors 158c such that collectors 158b and collectors 158c are not axially aligned. It is understood that, in some examples, collectors 158b can be partially axially aligned with collectors 158c. It is further understood that, in some examples, collectors 158b can be fully axially aligned with and not circumferentially offset from collectors 158c.

Circumferentially offsetting the collectors 158 directly opposing one axial sides of a coil 46 from the collectors 158 directly opposing the other axial side of the coil 46 enhances cooling and inhibits development of hot spots. The heat collection zones formed by one of the collectors 158 (e.g., collectors 158b) is circumferentially offset from the heat collection zones formed by the other collector 158 (e.g., collector 158c). As such, a circumferential extent of the coil 46 is axially covered by at least one collector 158 than if the collectors 158 were axially aligned. Covering a greater proportion of the coil 46 enhances cooling of the coil 46 and facilitates efficient heat transfer out of the intermediate area of stator 32.

Heat sinks 154 provide significant advantages. Heat sinks 154 wrap around laminate structure of a stator phase 42, from radially within the stator 32 to radially outside of the stator 32. Heat sinks 154 are formed from a material that has greater thermal conductivity than the metallic structure of flux rings 44 to provide cooling to those components. For example, heat sinks 154 can be formed from aluminum, copper, etc., while flux rings 44 are formed from iron or an alloy of iron. Heat sinks 154 radially bracket metallic structure of the stator phase 42 such that the metallic structure radially overlaps with and is disposed radially between the portions of the heat sink 154. Heat sink 154 can thereby effectively cool laminate structure of the stator phase 42.

Free legs 172 are circumferentially and radially overlapped by metallic structure of a stator phase 42 such that free legs 172 are positioned to absorb heat from the metallic structure of that stator phase 42. Feet 174 are disposed to directly oppose the coil 46 of the stator phase 42 and absorb heat generated by the coil 46. Feet 174 are radially enlarged to cover a majority of the radial height of coil 46, enhancing heat transfer to heat sink 154 from coil 46. Feet 174 are recessed from the air gap between rotor 30 and stator 32 to inhibit the formation of eddy currents.

A single heat sink 154 can include collectors 158 extending in both first axial direction AD1 and second axial direction AD2. The oppositely extending collectors 158 extend to thermally interface with coils 46 of different ones of the stator phases 42. As such, a single heat sink 154 can provide cooling to multiple coils 46 of the motor 12.

Heat sinks 154 provide alignment between stator phases 42 during assembly of stator 32. Free legs 172 of a single heat sink 154 extend into troughs 194 of different stator phases 42, which circumferentially and radially locates the flux rings 44 of the different stator phases 42 relative to each other. In addition, the bracket 160 interfaces with flux returns 48 of the different stator phases 42. The support side 166 of bracket 160 includes flats 184 that interface with the flux returns 48 to circumferentially and radially fix the flux returns 48 relative to heat sink 154. The bracket 160 thereby further facilitates desired alignment during assembly of stator 32.

The intermediate stator phase 42b is bracketed between feet 174 of multiple heat sinks 154a, 154b, providing enhanced cooling to that intermediate stator phase 42b, which is the stator phase 42 most susceptible to undesired heating. Bracketing the coil 46b between heat sinks 154 moves heat away from coil 46 in both axial directions and then radially outward to different locations along the exterior of stator 32. Such a configuration enhances heat transfer from that intermediate stator phase 42b by having additional cooling structure associated with the intermediate stator phase 42. The collectors 158 on the opposite axial sides of the coil 46b of the intermediate stator phase 42b are axially misaligned with each other, further enhancing cooling of that intermediate stator phase 42b.

Heat sinks 154 can be associated with multiple stator phases 42, providing cooling to each of the multiple stator phases 42. Each heat sink 154 can thereby provide effective cooling to multiple axially aligned and axially spaced coils 46 of the motor 12. Heat sinks 154 extend into negative spaces within the stator 32 such that heat sinks 154 occupy areas of stator 32 that otherwise were filled with potting compound. Heat sinks 154 can thereby provide effectively cooling without increasing the footprint of motor 12. Heat sinks 154 extend into interphase gaps 204a such that heat sinks 154 do not increase the axial length of motor 12.

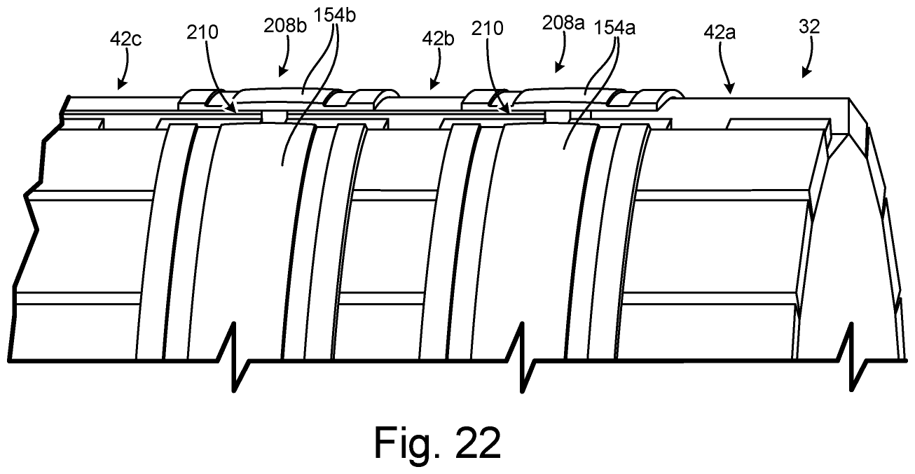

FIG. 22 is a partial isometric view of motor 12 with motor housing 16 removed. Stator 32 and heat sinks 154a, 154b are shown.

Heat sinks 154a form an annular cooling array 208a around stator 32, around the common axis CA. In the example shown, the annular cooling array 208a is formed from multiple of the arcuate heat sinks 154a positioned relative to each other, such as two, three, four or more. It is understood that, in some examples, a single heat sink 154a can form the annular cooling array 208a. Spacing gap 210 is formed circumferentially between circumferentially adjacent ones of the heat sinks 154a. Spacing gaps 210 physically space the heat sinks 154a from each other, which inhibits resistive heating and prevents the formation of eddy currents.

Heat sinks 154b form an annular cooling array 208b around stator 32, around the common axis CA. In the example shown, the annular cooling array 208b is formed from multiple of the arcuate heat sinks 154b positioned relative to each other, such as two, three, four or more. It is understood that, in some examples, a single heat sink 154b can form the annular cooling array 208b. Spacing gap 210 is formed circumferentially between circumferentially adjacent ones of the heat sinks 154b. Spacing gaps 210 physically space the heat sinks 154b from each other, which inhibits resistive heating and prevents the formation of eddy currents.

The annular cooling arrays 208a, 208b are disposed around the common axis CA and extend from within stator 32 to outside of stator 32. Dissipators 156 of heat sinks 154a, 154b are disposed radially outside of the laminate material of stator phase 42a-42c.

While the electric machines of this disclosure are discussed in the context of a fan system, it is understood that electric machines and controls can be utilized in a variety of contexts and systems and are not limited to those discussed. As such, while a fan embodiment is shown herein, it is understood that the features of this disclosure could be applied to an electric motor of any application, including non-fan applications. Any one or more of the electric machines discussed can be utilized alone or in unison with one or more additional electric machines to provide mechanical output from an electric signal input for any desired purpose. Further, while electric machine 12 is generally discussed as being an electric motor, electric machine 12 can be of any desired form, such as a generator. Any aspect discussed herein may be mixed between the different embodiments and features discussed herein.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1.-139. (canceled)

140. An electric motor, comprising:
a stator, the stator comprising at least one coil; and
a rotor spaced radially from the stator by an air gap and configured to rotate on an axis, the rotor comprising:
a mandrel; and
a magnetic array disposed around the axis and supported by the mandrel;
wherein an appendage extends from one of the mandrel and the concentrator into a receiver formed on the other one of the mandrel and the concentrator to radially retain the concentrator on the mandrel.

141. The electric motor of claim 140, wherein the receiver radially overlaps with the appendage.

142. The electric motor of claim 141, wherein the receiver includes an axial projection that radially overlaps with the appendage.

143. The electric motor of claim 142, wherein the projection is disposed radially between the stator and the appendage.

144. The electric motor of claim 142, wherein the projection is disposed radially between the magnetic array and the axis.

145. The electric motor of claim 142, wherein the projection radially overlaps with a body of the concentrator and the appendage and the projection is disposed radially between the body of the concentrator and the appendage.

146. The electric motor of claim 140, wherein the appendage extends from the concentrator.

147. The electric motor of claim 146, wherein:
the concentrator comprises a body extending between a first axial end and a second axial end, the body having a first radial side oriented towards the stator and a second radial side oriented towards the mandrel; and
the appendage extends from the second radial side.

148. The electric motor of claim 147, wherein the second radial side includes a corner cutout extending from the first axial end, wherein a radial height of the concentrator varies along the corner cutout, and wherein the appendage extends from within the corner cutout.

149. The electric motor of claim 146, wherein:
the appendage forms a first appendage extending from the concentrator and the concentrator includes a second appendage that extends from the concentrator.

150. The electric motor of claim 149, wherein:
the first appendage includes a first base end and a first distal end, the first base end connected to a body of the concentrator, and the first distal end offset axially from the first base end; and
the second appendage includes a second base end and a second distal end, the second base end connected to the body of the concentrator, and the second distal end offset axially from the second base end.

151. The electric motor of claim 150, wherein:
the first distal end is offset in a first axial direction from the first base end; and
the second distal end is offset in the first axial direction from the second base end.

152. The electric motor of claim 150, wherein:
the first distal end is offset in a first axial direction from the first base end; and
the second distal end is offset in a second axial direction from the second base end, the second axial direction opposite the first axial direction.

153. The electric motor of claim 150, wherein the first distal end is spaced from the second distal end by a first axial distance, the first base end is spaced from the second base end by a second axial distance, and the first axial distance differs from the second axial distance.

154. The electric motor of claim 146, wherein the appendage includes a neck connected to the concentrator and an appendage body extending from the neck, the appendage body being thicker than the neck.

155. The electric motor of claim 146, the concentrator is formed by a first plurality of laminas and the appendage is formed by a second plurality of laminas.

156. The electric motor of claim 155, wherein the second plurality of laminas are contiguous with the first plurality of laminas.

157. The electric motor of claim 155, wherein the first plurality of laminas includes a first lamina count, the second plurality of laminas includes a second lamina count, and the second lamina count is less than the first lamina count.

158. An electric motor, comprising:
a stator, the stator comprising at least one coil; and
a rotor comprising a magnetic array disposed around an axis of rotation of the rotor, the rotor including at least one phase, each phase of the at least one phase comprising an annular array of magnets and concentrators;
wherein the concentrators include a plurality of fingers that are embedded in potting compound.

159. An electric motor comprising:
a rotor configured to rotate on a rotational axis to generate a mechanical output, the rotor comprising a rotor body and a magnetic array;
a stator spaced radially relative to the rotor and disposed about the rotational axis, the stator comprising:
a first stator phase including a first pair of flux rings and a first coil, the first coil disposed axially between the first pair of flux rings; and
a second stator phase including a second pair of flux rings and a second coil disposed axially between a second pair of flux rings, the second stator phase spaced axially from the first stator phase by an interphase gap; and
a heat sink extending from an opposite radial side of the first coil from the rotor into the interphase gap and extending towards the first coil from the interphase gap, such that the heat sink is disposed radially between metal of a first flux ring of the first pair of flux rings and the rotor, the heat sink configured to route heat away from the first coil and towards an exterior of the stator.
